(19) United States
(12) Patent Application Publication
(10) Pub. No.: US 2026/0074214 A1
(43) Pub. Date: Mar. 12, 2026

(54) BATTERY, ELECTRONIC DEVICE, AND VEHICLE

(71) Applicant: SEMICONDUCTOR ENERGY LABORATORY CO., LTD., Atsugi-shi, Kanagawa-ken (JP)

(72) Inventors: Jo SAITO, Atsugi, Kanagawa (JP); Atsushi KAWATSUKI, Yokohama, Kanagawa (JP); Kunihiro FUKUSHIMA, Isehara, Kanagawa (JP); Shunpei YAMAZAKI, Setagaya, Tokyo (JP)

(21) Appl. No.: 19/106,301

(22) PCT Filed: Sep. 4, 2023
(86) PCT No.: PCT/IB2023/058715

§ 371 Date: Feb. 25, 2025

(30) Foreign Application Priority Data
Sep. 9, 2022 (JP) 2022-143791

(51) Int. Cl. H01M 4/525; H01M 4/02; H01M 4/62

(52) U.S. Cl. CPC H01M 4/525; H01M 4/625; H01M 2004/021; H01M 2220/20

(57) ABSTRACT

A secondary battery with high capacity and a high level of safety is provided. The battery includes a positive electrode including a positive electrode active material and a conductive material. The positive electrode active material contains cobalt, oxygen, magnesium, and nickel. A median diameter of the positive electrode active material is greater than or equal to 1 μm and less than or equal to 12 μm. In EDX line analysis in a depth direction on a region of the positive electrode active material having a plane other than a (001) plane, a distribution of the magnesium partly overlaps with a distribution of the nickel. The conductive material adheres to part of the plane other than the (001) plane of the positive electrode active material.

### TECHNICAL FIELD

One embodiment of the present invention relates to a battery and specifically, relates to a secondary battery. The present invention is not limited to the above field and relates to a semiconductor device, a display device, a light-emitting device, a power storage device, a lighting device, an electronic device, a vehicle, and manufacturing methods thereof. The secondary battery of one embodiment of the present invention can be used as a power supply necessary for the above semiconductor device, display device, light-emitting device, power storage device, lighting device, electronic device, and vehicle. Examples of the above electronic device include an information terminal device provided with the secondary battery. Furthermore, examples of the above power storage device include a stationary power storage device.

### BACKGROUND ART

In recent years, demand for secondary batteries with high output and high capacity has rapidly grown and the secondary batteries are essential as repeatedly-usable energy sources in modern society.

It is said that secondary batteries can hardly be safe when having high capacity. A positive electrode active material with a layered rock-salt crystal structure, where a diffusion path of lithium ions moves two-dimensionally in the crystal structure, for example, is expected to enable high capacity. However, the positive electrode active material having a layered rock-salt crystal structure has been disadvantageous in terms of safety because the crystal structure will be collapsed by excessive extraction of lithium ions at the time of charging, easily resulting in thermal runaway. Note that lithium-ion secondary batteries are known to enter thermal runaway after passing through several states (Non-Patent Document 1).

Lithium-ion secondary batteries including lithium cobalt oxide (LiCoO₂) and the like as positive electrode active materials having a layered rock-salt crystal structure are known. In lithium cobalt oxide, which has a layered rock-salt crystal structure, lithium ions can move two-dimensionally between layers composed of CoO₆ octahedrons, leading to favorable cycle performance. However, in lithium cobalt oxide, a phase change occurs due to charging and discharging. For example, a phase change from the hexagonal phase to the monoclinic phase occurs in lithium cobalt oxide when lithium ions are extracted to some extent at the time of charging. Thus, to use lithium cobalt oxide such that it enables favorable cycle performance, the amount of lithium ions to be extracted has been limited. Patent Document 1 proposes a structure for solving these problems, in which an additive element is added to lithium cobalt oxide, as an attempt to increase capacity.

As an example of methods used for analysis of the crystal structure of a positive electrode active material, XRD (X-ray diffraction) is given. With the use of ICSD (Inorganic Crystal Structure Database) introduced in Non-Patent Document 2, XRD data can be analyzed. For example, the ICSD can be referred to for the lattice constant of the lithium cobalt oxide described in Non-Patent Document 3. For Rietveld analysis, the analysis program RIETAN-FP (Non-Patent Document 4) can be used, for example. As software for drawing crystal structures, VESTA (Non-Patent Document 5) can be used.

A fluoride such as fluorite (calcium fluoride) has been used as a fusing agent in iron manufacture or the like for a long time, and the physical properties have been studied (see Non-Patent Document 6, for example).

### REFERENCES

### Patent Document

[Patent Document 1] International Publication WO 2020/026078

### Non-Patent Documents

[Non-Patent Document 1] Nobuo Eda, “2-4: Mechanism of Heat Generation” in “Learning Charging and Discharging Techniques of Li-Ion Batteries from Data” [Translated from Japanese.], CQ Publishing Co., Ltd., published on Apr. 4, 2020, P. 68-72.
[Non-Patent Document 2] Belsky, A. et al., “New developments in the Inorganic Crystal Structure Database (ICSD): accessibility in support of materials research and design”, Acta Cryst., (2002) B58 364-369.
[Non-Patent Document 3] Akimoto, J.; Gotoh, Y.; Oosawa, Y. “Synthesis and structure refinement of LiCoO₂ single crystals” Journal of Solid State Chemistry (1998) 141, p. 298-302.
[Non-Patent Document 4] F. Izumi and K. Momma, Solid State Phenom., 130, 15-20 (2007)
[Non-Patent Document 5] K. Momma and F. Izumi, J. Appl. Cryst. (2011). 44, 1272-1276
[Non-Patent Document 6] W. E. Counts, R. Roy, and E. F. Osborn, “Fluoride Model Systems: II, The Binary Systems CaF₂—BeF₂, MgF₂—BeF₂, and LiF—MgF₂”, Journal of the American Ceramic Society, 36 [1] 12-17 (1953).

### SUMMARY OF THE INVENTION

### Problems to be Solved by the Invention

When an internal short circuit or the like occurs in a secondary battery, oxygen is released from lithium cobalt oxide (LiCoO₂, sometimes referred to as LCO), which is a layered rock-salt positive electrode active material, leading to thermal runaway in some cases. Considering this, an object of one embodiment of the present invention is to provide a positive electrode active material, a secondary battery, and the like achieving high capacity and a high level of safety. Note that the description of these objects does not preclude the existence of other objects. One embodiment of the present invention does not necessarily achieve all these objects. Other objects can be derived from the description of the specification, the drawings, and the claims.

### Means for Solving the Problems

One embodiment of the present invention is a battery including a positive electrode including a positive electrode active material and a conductive material. The positive electrode active material contains cobalt, oxygen, magnesium, and nickel. A median diameter of the positive electrode active material is greater than or equal to 1 μm and less than or equal to 12 μm. In EDX line analysis in a depth direction on a region of the positive electrode active material having a plane other than a (001) plane, a distribution of the magnesium partly overlaps with a distribution of the nickel. The conductive material adheres to part of the plane other than the (001) plane of the positive electrode active material.

Another embodiment of the present invention is a battery including a positive electrode including a positive electrode active material and a conductive material. The positive electrode active material contains cobalt, oxygen, magnesium, and nickel. A median diameter of the positive electrode active material is greater than or equal to 1 μm and less than or equal to 12 μm. In EDX line analysis in a depth direction on a region of the positive electrode active material having a plane other than a (001) plane, a concentration of the magnesium is higher than or equal to 0.3 atomic % and lower than or equal to 7 atomic %. The conductive material adheres to part of the plane other than the (001) plane of the positive electrode active material.

Another embodiment of the present invention is a battery including a positive electrode including a positive electrode active material and a conductive material. The positive electrode active material contains cobalt, oxygen, magnesium, nickel, and aluminum. A median diameter of the positive electrode active material is greater than or equal to 1 μm and less than or equal to 12 μm. In EDX line analysis in a depth direction on a region of the positive electrode active material having a plane other than a (001) plane, a distribution of the magnesium partly overlaps with a distribution of the nickel and a peak of a concentration of the magnesium is located closer to a surface of the positive electrode active material than a peak of a concentration of the aluminum is. The conductive material adheres to part of the plane other than the (001) plane of the positive electrode active material.

Another embodiment of the present invention is a battery including a positive electrode including a positive electrode active material and a conductive material. The positive electrode active material contains cobalt, oxygen, magnesium, nickel, and aluminum. A median diameter of the positive electrode active material is greater than or equal to 1 μm and less than or equal to 12 μm. In EDX line analysis in a depth direction on a region of the positive electrode active material having a plane other than a (001) plane, a concentration of the magnesium is higher than or equal to 0.3 atomic % and lower than or equal to 7 atomic % and a concentration of the aluminum is higher than or equal to 0.1 atomic % and lower than or equal to 3 atomic %. The conductive material adheres to part of the plane other than the (001) plane of the positive electrode active material.

In the present invention, a volume resistivity of a powder of the positive electrode active material is preferably higher than or equal to 1.5×10⁸Ω·cm under a pressure of 64 MPa.

In the present invention, the conductive material preferably includes carbon fiber, graphene, or a graphene compound.

In the present invention, the carbon fiber preferably includes a carbon nanotube.

In the present invention, the carbon nanotube is preferably in a tangled state.

### Effect of the Invention

According to one embodiment of the present invention, a battery with a high level of safety can be provided. Moreover, according to one embodiment of the present invention, a battery with high capacity and a high level of safety can be provided.

Note that the description of these effects does not preclude the existence of other effects. One embodiment of the present invention does not necessarily have all these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1 is a cross-sectional view illustrating a secondary battery.

FIG. 2A and FIG. 2B are cross-sectional views illustrating a positive electrode active material.

FIG. 3A to FIG. 3D are plan views of a positive electrode including a positive electrode active material and a conductive material.

FIG. 4 is a diagram illustrating the eutectic point of LiF and MgF₂.

FIG. 5 is a diagram illustrating results of DSC measurement on a fluorine compound and a mixture.

FIG. 6A to FIG. 6C are diagrams illustrating concentration distributions of additive elements.

FIG. 7A and FIG. 7B are diagrams illustrating concentration distributions of additive elements.

FIG. 8 is a diagram illustrating crystal structures of a positive electrode active material.

FIG. 9 is a diagram showing XRD patterns.

FIG. 10 is a diagram showing XRD patterns.

FIGS. 11A and 11B are diagrams each showing XRD patterns.

FIG. 12A and FIG. 12B are diagrams illustrating a nail penetration test.

FIG. 13A and FIG. 13B are diagrams illustrating a secondary battery in a nail penetration test.

FIG. 14 is a diagram showing a temperature change in a secondary battery in which an internal short circuit has occurred.

FIG. 15 is a diagram showing a temperature change in a secondary battery in which thermal runaway has occurred.

FIG. 16A to FIG. 16D are diagrams showing methods for forming a positive electrode active material.

FIG. 17 is a diagram showing a method for forming a positive electrode active material.

FIG. 18A to FIG. 18C are diagrams showing methods for forming a positive electrode active material.

FIG. 19A to FIG. 19D are cross-sectional views illustrating a positive electrode.

FIG. 20A is an exploded perspective view of a coin-type secondary battery, FIG. 20B is a perspective view of the coin-type secondary battery, and FIG. 20C is a cross-sectional perspective view thereof.

FIG. 21A shows an example of a cylindrical secondary battery. FIG. 21B shows an example of the cylindrical secondary battery. FIG. 21C shows an example of a plurality of cylindrical secondary batteries. FIG. 21D shows an example of a power storage system including a plurality of cylindrical secondary batteries.

FIG. 22A and FIG. 22B are diagrams illustrating examples of a secondary battery, and FIG. 22C is a diagram illustrating the internal state of a secondary battery.

FIG. 23A to FIG. 23C are diagrams showing an example of a secondary battery.

FIG. 24A and FIG. 24B are diagrams each illustrating the appearance of a secondary battery.

FIG. 25A to FIG. 25C are diagrams illustrating a method for fabricating a secondary battery.

FIG. 26A shows a structure example of a battery pack, FIG. 26B shows a structure example of the battery pack, and FIG. 26C shows a structure example of the battery pack.

FIG. 27A is a perspective view of a battery pack of one embodiment of the present invention, FIG. 27B is a block diagram of the battery pack, and FIG. 27C is a block diagram of a vehicle including the battery pack.

FIG. 28A to FIG. 28D are diagrams illustrating examples of transport vehicles. FIG. 28E is a diagram showing an example of an artificial satellite.

FIG. 29A and FIG. 29B are diagrams illustrating buildings on each of which a secondary battery of one embodiment of the present invention is mounted.

FIG. 30A is a diagram illustrating an electric bicycle, FIG. 30B is a diagram illustrating a secondary battery of an electric bicycle, and FIG. 30C is a diagram illustrating a motor scooter.

FIG. 31A to FIG. 31D are diagrams illustrating examples of electronic devices.

FIG. 32A shows examples of wearable devices, FIG. 32B is a perspective view of a watch-type device, and FIG. 32C is a diagram illustrating a side surface of the watch-type device.

FIG. 33 is a graph showing particle size distributions of Sample 1 and the like.

FIG. 34A and FIG. 34B are graphs showing STEM-EDX analysis on Sample 1 and the like.

FIG. 35A to FIG. 35C are graphs showing STEM-EDX analysis on Sample 1 and the like.

FIG. 36A to FIG. 36C are graphs showing STEM-EDX analysis on Sample 1 and the like.

FIG. 37A and FIG. 37B are graphs showing STEM-EDX analysis on Sample 1 and the like.

FIG. 38A and FIG. 38B are graphs showing STEM-EDX analysis on Sample 1 and the like.

FIG. 39A and FIG. 39B are graphs showing STEM-EDX analysis on Sample 1 and the like.

FIG. 40A to FIG. 40C are graphs showing STEM-EDX analysis on Sample 1 and the like.

FIG. 41A to FIG. 41C are graphs showing STEM-EDX analysis on Sample 1 and the like.

FIG. 42 is a SEM image of a positive electrode.

FIG. 43 is a SEM image of a positive electrode.

FIG. 44A to FIG. 44C are graphs showing discharge capacities in a charge and discharge cycle test.

FIG. 45A to FIG. 45C are graphs showing discharge capacities in a charge and discharge cycle test.

FIG. 46 is a graph showing results of discharge capacities at each rate.

FIG. 47A and FIG. 47B are graphs showing discharge capacities in a charge and discharge cycle test.

FIG. 48A and FIG. 48B are graphs showing discharge capacities in a charge and discharge cycle test.

FIG. 49A to FIG. 49C are graphs showing XRD in charging.

### MODE FOR CARRYING OUT THE INVENTION

Embodiment examples for carrying out the present invention will be described below with reference to the drawings and the like. Note that the present invention should not be interpreted as being limited to the embodiment examples given below. Embodiments for carrying out the invention can be changed unless they deviate from the spirit of the present invention.

In this specification and the like, a space group is represented using the short notation of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “-” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( ), and a set plane having equivalent symmetry is denoted with “{ }”. A trigonal system represented by the space group R-3m is generally represented by a composite hexagonal lattice for easy understanding of the structure, and the space group R-3m is represented by a composite hexagonal lattice also in this specification and the like unless otherwise specified. In some cases, not only (hkl) but also (hkil) is used as the Miller index. Here, i is −(h+k).

In this specification and the like, particles are not necessarily spherical (with a circular cross section). Other examples of the cross-sectional shapes of particles include an ellipse, a rectangle, a trapezoid, a triangle, a quadrilateral with rounded corners, and an asymmetrical shape, and a particle may have an indefinite shape.

The theoretical capacity of a positive electrode active material refers to the amount of electricity obtained when all lithium that can be inserted and extracted and is contained in the positive electrode active material is extracted. For example, the theoretical capacity of LiCoO₂ is 274 mAh/g (per weight of the positive electrode active material, the same shall apply hereafter), the theoretical capacity of LiNiO₂ is 274 mAh/g, and the theoretical capacity of LiMn₂O₄ is 148 mAh/g.

The remaining amount of lithium that can be inserted into and extracted from a positive electrode active material is represented by x in a composition formula, e.g., x in LiMO₂. Note that M represents a transition metal and M is the sum of cobalt, nickel, and manganese unless otherwise specified in this specification and the like. In the case of a positive electrode active material in a lithium-ion secondary battery, x=(theoretical capacity-charge capacity)/theoretical capacity can be satisfied. For example, in the case where a lithium-ion secondary battery using LiMO₂ as a positive electrode active material is charged to 219.2 mAh/g per weight of the positive electrode active material, the positive electrode active material can be represented by Li_{0.2}MO₂, i.e., x=0.2. Note that “x in LiₓMO₂ is small” means, for example, 0.1<x≤0.24. LiₓMO₂ to be used for a positive electrode, which has been appropriately synthesized and almost satisfies the stoichiometric proportion, is LiMO₂ with x=1. In a lithium-ion secondary battery after its discharging ends, it can be said that contained LiₓMO₂ is also LiₓMO₂ with x=1. Here, “discharging ends” means that a voltage becomes 3.0 V or 2.5 V or lower at a current of 100 mA/g or lower, for example.

Charge capacity and/or discharge capacity used for calculation of x in LiₓMO₂ is preferably measured under the condition of no influence or small influence of a short circuit and/or decomposition of an electrolyte solution or the like. For example, data of a lithium-ion secondary battery, suffering from a sudden change of capacity that seems to result from a short circuit, should not be used for calculation of x.

The space group of a positive electrode active material or the like is identified by XRD, electron diffraction, neutron diffraction, or the like. Thus, in this specification and the like, belonging to a space group, being attributed to a space group, or being a space group can be rephrased as being identified as a space group.

Furthermore, when the arrangement of anions is close to a cubic close-packed structure, the arrangement can be regarded as the cubic close-packed structure. The arrangement of anions forming the cubic close-packed structure refers to a state where anions in a second layer are positioned above voids between anions packed in a first layer, and anions in a third layer are placed at the positions that are positioned right above voids between the anions in the second layer and are not positioned right above the anions in the first layer. Accordingly, anions do not necessarily form a precise cubic lattice structure. At the same time, actual crystals always have a defect and thus, analysis results are not necessarily consistent with the theory. For example, in an electron diffraction pattern or an FFT (fast Fourier transform) pattern of a TEM (Transmission Electron Microscope) image or the like, a spot may appear in a position slightly different from a theoretical position. For example, anions can be regarded as forming a cubic close-packed structure when a difference in orientation from a theoretical position is 5° or less or 2.5° or less.

The element distribution indicates the region where the element is successively detected by a successive analysis method to the extent that the detection value is no longer on the noise level.

Note that in this specification and the like, a surface portion of a positive electrode active material is a region that extends less than or equal to 20 nm or less than or equal to 30 nm from a surface toward an inner portion in a direction perpendicular or substantially perpendicular to the surface. The surface portion can be rephrased as the vicinity of a surface and a region in the vicinity of a surface. Note that “perpendicular” or “substantially perpendicular” specifically means that an angle between a direction and a surface is greater than or equal to 80° and less than or equal to 100°. The inner portion refers to a region that is at a larger depth than the surface portion of a positive electrode active material. The inner portion is synonymous with a bulk or a core.

Note that in this specification and the like, a surface of a positive electrode active material does not contain a carbonate, a hydroxy group, or the like which is chemisorbed after formation of the positive electrode active material. Furthermore, an electrolyte solution, a binder, a conductive material, and a compound originating from any of these that are attached to the surface of the positive electrode active material are not contained either. Thus, in quantitative analysis of the elements contained in the positive electrode active material, correction may be performed to exclude carbon, hydrogen, excess oxygen, excess fluorine, and the like that might be detected in surface analysis.

In this specification and the like, a positive electrode active material is sometimes referred to as a composite oxide, a positive electrode member, a positive electrode material, a secondary battery positive electrode member, a lithium-ion secondary battery positive electrode member, or the like. In this specification and the like, the positive electrode active material of one embodiment of the present invention preferably contains a compound. In this specification and the like, the positive electrode active material of one embodiment of the present invention preferably contains a composition. In this specification and the like, the positive electrode active material of one embodiment of the present invention preferably contains a composite.

In the case where the features of individual particles of a positive electrode active material are described in the following embodiment and the like, not all the particles necessarily have the features. When 50% or more, preferably 70% or more, further preferably 90% or more of three or more randomly selected particles of a positive electrode active material have the features, for example, it can be said that an effect of improving the characteristics of the positive electrode active material and a secondary battery including the positive electrode active material is sufficiently obtained.

The voltage applied to a positive electrode generally increases with increasing charge voltage of a secondary battery. Since the positive electrode active material of one embodiment of the present invention is stable when being in a charged state, a secondary battery in which a reduction in discharge capacity due to repeated charging and discharging is inhibited can be provided.

An internal short circuit or an external short circuit of a secondary battery might cause not only malfunction in charging operation and/or discharging operation of the secondary battery but also heat generation and ignition. In order to obtain a safe secondary battery, an internal short circuit or an external short circuit is preferably inhibited even at a high charge voltage. In the positive electrode active material of one embodiment of the present invention, an internal short circuit or an external short circuit is inhibited even at a high charge voltage. Thus, a secondary battery having both high discharge capacity and a high level of safety can be obtained. Note that an internal short circuit of a secondary battery refers to contact between a positive electrode and a negative electrode inside the battery. An external short circuit of a secondary battery refers to contact between a positive electrode and a negative electrode outside the battery on the assumption that the battery is misused.

Note that in this specification and the like, ignition in a nail penetration test refers to a state where fire is observed outside an exterior body within 1 minute of nail penetration or a state where thermal runaway of a secondary battery has occurred within 1 minute of nail penetration. For example, a state where a pyrolysate(s) of a positive electrode and/or a negative electrode are/is observed at a position more than or equal to 2 cm away from a penetration point after a nail penetration test is finished is referred to as a state where thermal runaway has occurred. The pyrolysate(s) of the positive electrode and/or the negative electrode contains, for example, aluminum oxide formed by oxidation of aluminum of a positive electrode current collector or copper oxide formed by oxidation of copper of a negative electrode current collector.

For example, when layered rock-salt LiMO₂ (M is often Co, but can be Co and Ni) is used as a positive electrode active material, the ratio of the atomic ratio of M to the atomic ratio of O (hereinafter referred to as A_{O}/A_{M}) is 2, theoretically. Meanwhile, the A_{O}/A_{M} decreases when oxygen is released from LiMO₂ owing to thermal runaway. Thus, a state where energy dispersive X-ray spectroscopy (EDX) analysis after a nail penetration test is finished reveals that the A_{O}/A_{M} at a position more than or equal to 2 cm away from a penetration point is less than 1.3, for example, is referred to as a state where thermal runaway has occurred. In other words, a state where EDX analysis reveals that the A_{O}/A_{M} at a position more than or equal to 2 cm away from the penetration point is greater than or equal to 1.3 can be referred to as a state where no thermal runaway has occurred. A state where a battery voltage after a nail penetration test is finished decreases but increases subsequently can also be referred to as a state where no thermal runaway has occurred.

Meanwhile, a state where fire, a spark, and/or smoke that are/is observed remain(s) at a penetration point in a nail penetration test, i.e., fire does not spread, and thermal runaway of a secondary battery does not occur is not referred to as ignition. For example, a secondary battery that does not suffer from the above ignition even after undergoing a nail penetration test can be regarded as a secondary battery that does not ignite.

Note that the description is made on the assumption that materials (such as a positive electrode active material, a negative electrode active material, an electrolyte solution, and a separator) of a secondary battery have not deteriorated unless otherwise specified. A decrease in discharge capacity due to aging treatment and burn-in treatment during the manufacturing process of a secondary battery is not regarded as deterioration. For example, the case where discharge capacity is higher than or equal to 97% of the rated capacity of a secondary battery composed of a cell or an assembled battery can be regarded as a non-deteriorated state. The rated capacity conforms to JIS C 8711:2019 in the case of a secondary battery for a portable device. The rated capacities of other secondary batteries conform to JIS described above, JIS for electric vehicle propulsion, industrial use, and the like, standards defined by IEC, and the like.

In this specification and the like, in some cases, materials included in a secondary battery that have not deteriorated are referred to as initial products or materials in an initial state, and materials that have deteriorated (have discharge capacity lower than 97% of the rated capacity of the secondary battery) are referred to as products in use, materials in a used state, products that are already used, or materials in an already-used state.

In this specification and the like, a lithium-ion secondary battery refers to a battery in which lithium ions are used as carrier ions; however, carrier ions in the present invention are not limited to lithium ions. For example, as the carrier ion in the present invention, alkali metal ions or alkaline earth metal ions can be used; specifically, sodium ions or the like can be used. In that case, the present invention can be understood by replacing lithium ions with sodium ions or the like. Furthermore, in the case where there is no limitation by carrier ions, the term “secondary battery” is sometimes used.

In this specification and the like, the (001) plane, the (003) plane, and the like are sometimes collectively referred to as the (001) plane. In this specification and the like, the (001) plane is sometimes referred to as a C-plane, a basal plane, or the like. In lithium cobalt oxide, lithium has a two-dimensional diffusion path. That is, it can be said that the diffusion path of lithium exists along a plane. In this specification and the like, a plane where the diffusion path of lithium is exposed, i.e., a plane other than a plane where lithium is inserted and extracted (specifically, the (001) plane), is sometimes referred to as an edge plane.

It can be said that when surface unevenness information in one cross section of an active material is converted into numbers with measurement data, a smooth surface of the active material has a surface roughness of at least less than or equal to 10 nm, in this specification and the like. The one cross section in this specification and the like is, for example, a cross section obtained in observation using a STEM (Scanning Transmission Electron Microscope) image.

In this specification and the like, a secondary particle refers to a particle formed by aggregation of primary particles. In this specification and the like, a primary particle refers to a particle whose appearance shows no grain boundary. In this specification and the like, a single particle refers to a particle whose appearance shows no grain boundary. In this specification and the like, a single crystal refers to a crystal whose inner portion has no grain boundary, whereas a polycrystal refers to a crystal whose inner portion has a grain boundary. A polycrystal may be regarded as a group of a plurality of crystallites, and a grain boundary may be regarded as an interface existing between two or more crystallites. Note that crystallites in a polycrystal are preferably in the same direction.

In this specification and the like, a median diameter (D50) is simply referred to as a median diameter in some cases.

In this specification and the like, the phrase “A and/or B” is an example of an expression that encompasses only A, only B, and A and B.

### EMBODIMENT 1

In this embodiment, a structure of a secondary battery with high capacity and a high level of safety will be described.

### <Secondary Battery>

A secondary battery of one embodiment of the present invention includes a positive electrode, a negative electrode, and an electrolyte. A liquid electrolyte at room temperature is referred to as an electrolyte solution. In the secondary battery including an electrolyte solution, a separator is provided between the positive electrode and the negative electrode. The positive electrode, the negative electrode, the electrolyte, and the like are stored in an exterior body.

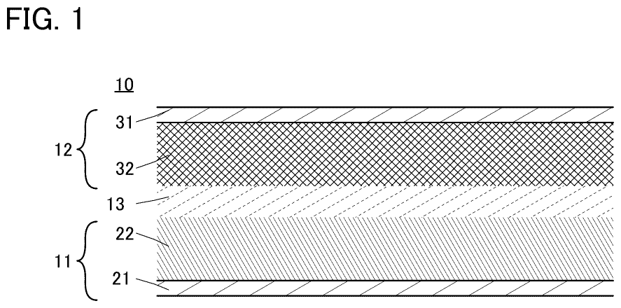

FIG. 1 shows a structure example of a secondary battery 10. In this example, the secondary battery 10 includes a positive electrode 12, a negative electrode 11, and a separator 13 between the positive electrode 12 and the negative electrode 11. The positive electrode 12 includes a positive electrode current collector 31 and a positive electrode active material layer 32 applied on the positive electrode current collector 31. The positive electrode active material layer 32 includes a positive electrode active material. The positive electrode active material preferably consists of a primary particle, a secondary particle, or a single particle. The negative electrode 11 includes a negative electrode current collector 21 and a negative electrode active material layer 22 applied on the negative electrode current collector 21. The negative electrode active material layer 22 includes a negative electrode active material. The separator 13 can be omitted.

### <Positive Electrode Active Material>

A positive electrode active material needs to contain a transition metal that can take part in an oxidation-reduction reaction in order to maintain a neutrally charged state even when lithium ions are inserted and extracted. It is preferable that the positive electrode active material of one embodiment of the present invention mainly contain cobalt as the transition metal taking part in an oxidation-reduction reaction. In addition to cobalt, at least one or two or more selected from nickel and manganese may be used. Using cobalt at greater than or equal to 75 atomic %, preferably greater than or equal to 90 atomic %, further preferably greater than or equal to 95 atomic % as the transition metal contained in the positive electrode active material brings many advantages such as relatively easy synthesis, easy handling, and excellent cycle performance, which is preferable. Such cobalt is referred to as a main component of the positive electrode active material or a main component of the transition metal of the positive electrode active material.

As the positive electrode active material, lithium cobalt oxide is preferably used. The lithium cobalt oxide can also be referred to as a composite oxide containing lithium, cobalt, and oxygen. Note that the composition of the lithium cobalt oxide that is the positive electrode active material is not strictly limited to Li:Co:O=1:1:2.

### <Additive Element>

Furthermore, the positive electrode active material preferably contains an additive element. As examples of the additive element, magnesium (Mg), fluorine (F), nickel (Ni), and aluminum (Al) are given, and in addition to them, titanium (Ti), zirconium (Zr), vanadium (V), iron (Fe), manganese (Mn), chromium (Cr), niobium (Nb), arsenic (As), zinc (Zn), silicon (Si), sulfur(S), phosphorus (P), boron (B), bromine (Br), beryllium (Be), and the like are given.

Note that as the additive element, magnesium, fluorine, nickel, aluminum, titanium, zirconium, vanadium, iron, manganese, chromium, niobium, arsenic, zinc, silicon, sulfur, phosphorus, boron, bromine, or beryllium is not necessarily contained.

When the positive electrode active material is substantially free from manganese, for example, the above advantages such as relatively easy synthesis, easy handling, and excellent cycle performance are enhanced. The weight of manganese contained in the positive electrode active material is preferably less than or equal to 600 ppm, further preferably less than or equal to 100 ppm, for example.

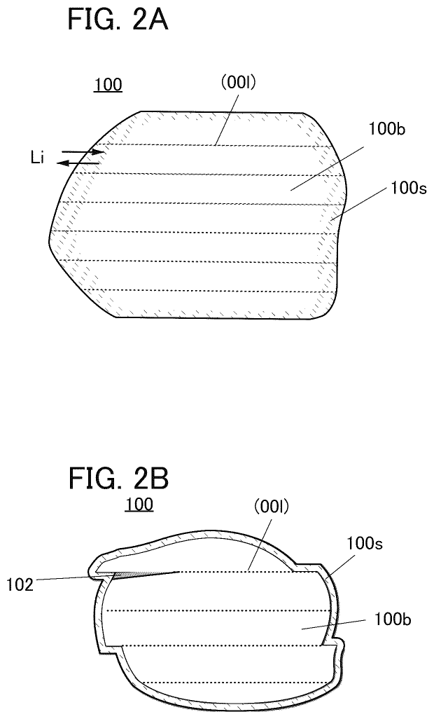

FIG. 2A and FIG. 2B show structure examples of a positive electrode active material 100 of one embodiment of the present invention. FIG. 2A and FIG. 2B each show a (001) plane of a layered rock-salt crystal structure, and a plane other than the (001) plane in FIG. 2A is shown with arrows indicating insertion and extraction of lithium.

As illustrated in FIG. 2A, the positive electrode active material 100 preferably includes an inner portion 100b and a first region 100s. The first region 100s preferably exists along the outer periphery of the positive electrode active material 100. The first region 100s is preferably positioned in the above-described surface portion. The first region 100s is a region containing an additive element in addition to an element contained in the positive electrode active material 100. In other words, the region where the additive element exists is the first region 100s.

A typical example of the additive element contained in the first region 100s is magnesium. The bonding strength of magnesium with oxygen is high, thereby inhibiting release of oxygen around magnesium, and thus the first region 100s is a region where oxygen release can be inhibited. The above-described first region 100s may be referred to as a shell region. The inhibition of oxygen release improves the safety of a secondary battery.

The first region 100s is a region where oxygen release is inhibited while the additive element is contained, and is a region having higher resistance than the inner portion 100b. That is, a positive electrode active material including the first region 100s may have higher resistance than a positive electrode active material not including the first region 100s. The positive electrode active material not including the first region 100s may be rephrased as a positive electrode active material not containing magnesium.

In the case where a secondary battery that includes the positive electrode active material 100 including the first region 100s undergoes a nail penetration test, the first region 100s can make the speed of a current flowing into the positive electrode active material 100 low. In consideration of the effect of making the speed of a current flowing into the positive electrode active material 100 low, it is further preferable that the first region 100s be positioned in the surface portion. Note that the first region 100s is not necessarily included in the entire surface portion.

As described above, a secondary battery including a positive electrode active material including the first region 100s can be regarded as having improved safety.

As the additive element contained in the first region 100s, an element other than magnesium may be used; in order to obtain the above effect, an element regarded as having at least a high bonding strength with oxygen is preferably used. Other than magnesium, aluminum, nickel, and the like are given as examples. In order to enhance the above effect, the first region 100s may contain, as the additive element, aluminum and/or nickel in addition to magnesium.

The surface portion of the positive electrode active material 100 includes a region having the (001) plane and a region having the plane other than the (001) plane. The additive element is likely to be added from the region having the plane with the arrows in FIG. 2A where lithium ions are diffused, i.e., the plane other than the (001) plane. That is, in the surface portion, the additive element distribution is sometimes different between the region having the (001) plane and the region having the plane other than the (001) plane. For example, magnesium is diffused more easily in the region having the plane other than the (001) plane than in the region having the (001) plane. Thus, in the first region 100s containing magnesium, the thickness of the region having the (001) plane is sometimes smaller than the thickness of the region having the plane other than the (001) plane, as illustrated in FIG. 2A. Note that the thickness of the first region 100s may also be referred to as a distance from the surface of the positive electrode active material 100 in the depth direction.

As described later, in the positive electrode active material 100 containing the additive element such as magnesium, the breakage of the crystal structure can be inhibited even in high-voltage charging. Thus, a secondary battery including the positive electrode active material 100 can have a high charge voltage and can achieve high capacity.

The positive electrode active material 100 illustrated in FIG. 2B is a structure example including a crack 102. Also this positive electrode active material 100 has the effect described above with reference to FIG. 2A by including the first region 100s.

The crack 102 may be referred to as a region with a shifted crystal plane or a region cracked at a crystal plane, and is often generated along the (001) plane. At the above-described crack 102, a new plane is exposed. The new plane does not include the first region 100s. At such a new plane, the effect of inhibiting oxygen release owing to magnesium or the like cannot be expected; thus, the positive electrode active material 100 preferably has an extremely small number of cracks 102. When the positive electrode active material 100 is observed with a surface SEM or a cross-sectional SEM, for example, the number of observable cracks 102 in one particle of the positive electrode active material is preferably greater than or equal to 0 and less than or equal to 5.

Generation of the crack 102 is sometimes triggered by pressure application following application of slurry for the positive electrode on the positive electrode current collector. Thus, in the formation process of the positive electrode of the present invention, the pressure of a press machine is preferably a linear pressure lower than or equal to 500 kN/m, further preferably a linear pressure lower than or equal to 300 kN/m, still further preferably a linear pressure lower than or equal to 250 kN/m, for example. During pressure application with use of the press machine, rollers are preferably heated. The heating melts a binding agent in the slurry for the positive electrode, which can strengthen the bonds between the positive electrode active materials, between the positive electrode active material and a conductive material, and between the positive electrode active material and the positive electrode current collector, for example.

### <Electrode Density>

The electrode density of the positive electrode is preferably higher than or equal to 3.0 g/cm³ and lower than or equal to 4.0 g/cm³, further preferably higher than or equal to 3.0 g/cm³ and lower than or equal to 3.5 g/cm³. The electrode density can be within the above range when the linear pressure is set as described above. The positive electrode that has such an electrode density and a secondary battery that includes the positive electrode are presumably unlikely to enter thermal runaway.

### <Smooth Surface of Positive Electrode Active Material>

As illustrated in FIG. 2A, the positive electrode active material 100 preferably has a smooth surface on the whole. In other words, the positive electrode active material 100 preferably has a shiny surface on the whole. The above-described positive electrode active material 100 can be regarded as having no corner or being rounded.

In addition, it is preferable that no or few ultrafine particles be attached to the surface of the positive electrode active material 100, as illustrated in FIG. 2A and FIG. 2B. In this specification and the like, an ultrafine particle refers to a metal oxide particle with a particle diameter greater than or equal to 0.001 μm and less than or equal to 0.1 μm. The ultrafine particle might be a fragment of the positive electrode active material and/or an additive element source that has not reacted, for example.

The particle diameter of the ultrafine particle is the Feret diameter or the equivalent diameter of projected area measured from a surface SEM (Scanning Electron Microscope) image. A state where the number of the ultrafine particles in a surface SEM image of the positive electrode is less than or equal to 10/cm², preferably less than or equal to 5/cm² can be referred to as a state where there are no or few ultrafine particles.

### <Heating Using Fusing Agent>

As described later, in the formation process of the positive electrode active material 100, a material serving as a fusing agent is preferably added together with the additive element source before heating. The fusing agent allows the surface of the composite oxide and the additive element source to be sufficiently melted and then, solidification starts. Thus, even if the ultrafine particles are attached to the surface of the composite oxide, they are melted through these steps, so that there are no or few ultrafine particles on the surface. In other words, the fact that there are no or few ultrafine particles on the surface of the positive electrode active material 100 means that a material serving as a fusing agent has been added before heating in the formation process of the positive electrode active material 100.

### <Initial Heating>

The positive electrode active material 100 that has been subjected to initial heating is smooth and shiny on the whole as illustrated in FIG. 2A. The initial heating refers to heating performed on the composite oxide in the formation process of the positive electrode active material. Performing the initial heating also brings about an effect of reducing distortion, a crystal defect, and the like of the positive electrode active material.

### <Crystallinity>

The positive electrode active material 100 preferably has high crystallinity and is further preferably a single crystal or a polycrystal. The positive electrode active material 100 is preferably subjected to the above initial heating to have high crystallinity. It is particularly preferable that the positive electrode active material 100 include a single crystal, in which case a crack is unlikely to be generated even when the volume of the positive electrode active material 100 is changed due to charging and discharging. Furthermore, when the positive electrode active material 100 is a single crystal, a secondary battery using the positive electrode active material 100 is presumably unlikely to ignite and can have a high level of safety.

### <Crystal Grain Boundary>

A crystal grain boundary refers to, for example, a portion where particles of the positive electrode active material 100 adhere to each other or a portion where a crystal orientation changes inside the positive electrode active material 100, e.g., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM (transmission electron microscope) image, a cross-sectional STEM image, or the like, i.e., a structure containing another atom between lattices, a hollow, or the like. The crystal grain boundary is one of plane defects. The vicinity of the crystal grain boundary refers to a region positioned within 10 nm from the crystal grain boundary. It is further preferable that the additive element contained in the positive electrode active material 100 have the above-described distribution and be at least partly unevenly distributed at the crystal grain boundary and the vicinity thereof.

Note that in this specification and the like, uneven distribution means that the concentration of an element in a certain region differs from those in other regions. This may be rephrased as segregation, precipitation, unevenness, deviation, or a mixture of a high-concentration portion and a low-concentration portion.

For example, the concentration of magnesium at the crystal grain boundary and the vicinity thereof in the positive electrode active material 100 is preferably higher than that in the other regions in the inner portion 100b. In addition, the concentration of fluorine at the crystal grain boundary and the vicinity thereof is preferably higher than that in the other regions in the inner portion 100b. The concentration of nickel at the crystal grain boundary and the vicinity thereof is preferably higher than that in the other regions in the inner portion 100b. The concentration of aluminum at the crystal grain boundary and the vicinity thereof is preferably higher than that in the other regions in the inner portion 100b.

The crystal grain boundary is a type of plane defect. Thus, the crystal grain boundary tends to be unstable and the crystal structure easily starts to change like the surface. Thus, the higher the concentration of an additive element A at the crystal grain boundary and its vicinity is, the more effectively the change in the crystal structure can be inhibited.

When the concentration of magnesium and the concentration of fluorine are high at the crystal grain boundary and the vicinity thereof, the concentration of magnesium and the concentration of fluorine in the vicinity of a surface generated by a crack are also high even when the crack is generated along the crystal grain boundary of the positive electrode active material 100 of one embodiment of the present invention. Thus, the positive electrode active material having a crack can also have an increased corrosion resistance to hydrofluoric acid.

### <Median Diameter of Positive Electrode Active Material>

The median diameter of the positive electrode active material of the present invention is preferably small. The allowable range of the median diameter is described. When the positive electrode active material is too small, application might be difficult to perform in the formation of the positive electrode. Alternatively, when the positive electrode active material is too small, the surface area becomes too large, which might cause an excessive reaction between a positive electrode active material surface and an electrolyte. Alternatively, when the positive electrode active material is too small, a large amount of conductive material sometimes needs to be mixed, which might lead to a decrease in capacity. Considering these, the median diameter of the positive electrode active material is preferably greater than or equal to 1 μm. The median diameter of the minimum particle of the positive electrode active material is preferably greater than or equal to 100 nm. The positive electrode active material with a small median diameter is unlikely to include a shifted region, which is preferable. The positive electrode active material with a small median diameter is unlikely to have a crack a even after pressing step, which is preferable.

However, when the majority of the active material is too small, the positive electrode active material layer might have a reduced density or a side reaction with the electrolyte solution might be promoted, for example. In view of this, the median diameter of the positive electrode active material is preferably less than or equal to 12 μm, further preferably less than or equal to 10 μm, still further preferably less than or equal to 8 μm.

That is, the median diameter of the positive electrode active material is greater than or equal to 1 μm and less than or equal to 12 μm, preferably greater than or equal to 1 μm and less than or equal to 10 μm. Alternatively, the median diameter of the positive electrode active material is greater than or equal to 100 nm and less than or equal to 12 μm, preferably 100 nm and less than or equal to 10 μm.

Note that above-described median diameter can be measured by observation using a SEM or a TEM or with a particle size distribution analyzer using a laser diffraction and scattering method, for example. When measured with a particle size distribution analyzer or the like using a laser diffraction and scattering method, the median diameter is the particle diameter when the cumulative amount is 50% in a cumulative curve obtained as a result of the particle size distribution measurement. Note that an example of a method for measuring the median diameter by analysis with a SEM, a TEM, or the like includes a method for measuring 20 or more particles to make an accumulated particle amount curve, and setting a particle diameter when the accumulation of particles accounts for 50% as the median diameter.

### <Conductive Material>

A conductive material is also referred to as a conductivity-imparting agent or a conductive additive, and a carbon material is used. When a conductive material covers, adheres to, or is attached to active materials, a plurality of active materials can be electrically connected to each other, and the conductivity of the positive electrode can be increased. Note that the term “adhere” or “attach” refers not only to a state where an active material and a conductive material are physically in close contact with each other, and includes, for example, the following concepts: the case where covalent bonding occurs, the case where bonding with the Van der Waals force occurs, the case where a conductive material covers part of an active material surface, the case where a conductive material is embedded in projections and depressions of an active material surface, and the case where an active material and a conductive material are electrically connected to each other without being in contact with each other. Specifically, the expression “an active material and a conductive material adhere to each other” refers to a state where contact between them can be observed in a surface SEM image or a cross-sectional SEM image. In this case, there is no limitation on the kind and intensity of the attractive force between them. Furthermore, a binder may be positioned at the interface between them.

As a conductive material for the positive electrode active material with a small median diameter, carbon black, Ketjen black (registered trademark), acetylene black (hereinafter, sometimes referred to as AB), fullerene, graphene, a graphene compound, carbon fiber, or the like can be used. When a particulate conductive material such as carbon black, Ketjen black, or AB is used as the conductive material for the positive electrode active material with a small median diameter, sufficient charge and discharge characteristics can be obtained.

When a string-like or fibrous conductive material is used as the conductive material for the positive electrode active material with a small median diameter, an efficient conductive path can be provided even with a small addition amount, and sufficient charge and discharge characteristics can be obtained. Moreover, a long conductive path can be ensured. In this specification and the like, a string-like or fibrous conductive material may be simply called carbon fiber, and specifically refers to VGCF (registered trademark), carbon fiber, or a carbon nanotube (hereinafter, sometimes referred to as CNT). Examples of the CNT include a single-layer CNT and a multilayer CNT. Carbon fiber has a long major axis or a long fiber length, and thus can be placed across a plurality of positive electrode active materials, that is, along a plurality of positive electrode active materials. Carbon fiber placed in such a manner seems to bind positive electrode active materials. Such carbon fiber also enables a conductive path between a current collector and a positive electrode active material not adjacent to but far from the current collector, for example. Thus, carbon fiber allows rapid charging and discharging. Furthermore, carbon fiber that seems to bind positive electrode active materials can inhibit cracking, breakage, or shifting of the positive electrode active material, so that a secondary battery with improved safety can be provided.

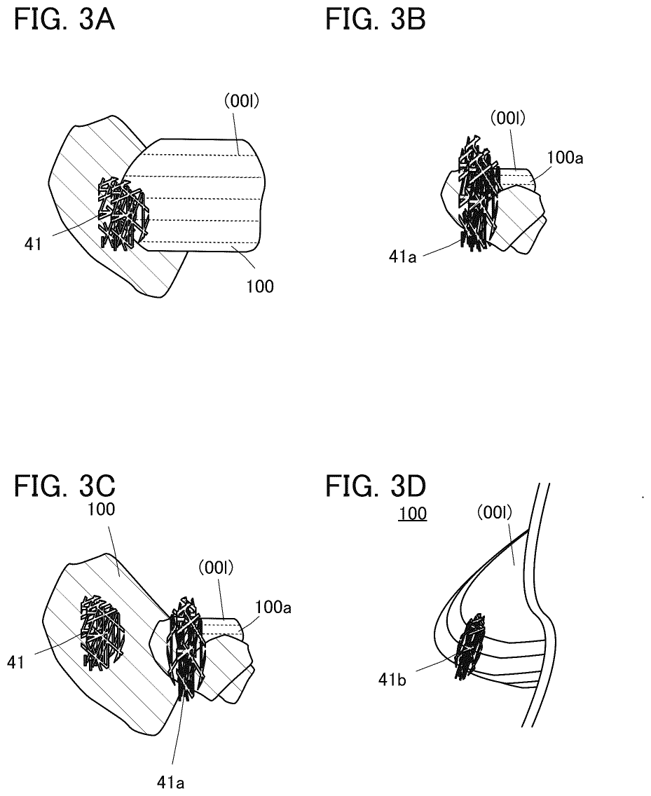

FIG. 3A shows a plan view of the positive electrode 12 including the positive electrode active material 100 and a conductive material 41. The plan view can be observed using a surface SEM image or the like. FIG. 3A shows a structure example in which a CNT is used as the conductive material 41. The conductive material 41 is in a tangled state, and is positioned between a plurality of the positive electrode active materials 100 so as to adhere to at least one positive electrode active material 100. Examples of the tangled state include a state where one or more CNTs are tangled with each other, and the tangled state can be rephrased as a state where one or more CNTs are aggregated or a state where one or more CNTs form a lump. The above-described adhering state can be rephrased as a state where the conductive material 41 is positioned to cover the plurality of positive electrode active materials 100, be along the plurality of positive electrode active materials 100, cling to the plurality of positive electrode active materials 100, or wrap the plurality of positive electrode active materials 100. Note that the state where, for example, the conductive material 41 adheres to the positive electrode active material 100 can be rephrased as a state where the conductive material 41 binds the positive electrode active material 100.

FIG. 3B illustrates the positive electrode 12 including a positive electrode active material 100a having a smaller particle diameter, i.e., a smaller median diameter, than that in FIG. 3A. A plurality of the positive electrode active materials 100a are aggregated in some cases. A conductive material 41a is in a tangled state, and is positioned to adhere to the plurality of positive electrode active materials 100a. The adhering state can be rephrased as a state where the conductive material 41a is positioned to cover the plurality of positive electrode active materials 100a, be along the plurality of positive electrode active materials 100a, cling to the plurality of positive electrode active materials 100a, or wrap the plurality of positive electrode active materials 100a. Note that the state where, for example, the conductive material 41a adheres to the positive electrode active material 100a can be rephrased as a state where the conductive material 41a binds the positive electrode active material 100a.

FIG. 3C illustrates the positive electrode 12 including both the positive electrode active material 100 in FIG. 3A with a large particle diameter, i.e., a large median diameter, and the positive electrode active material 100a in FIG. 3B with a small particle diameter, i.e., a small median diameter. A plurality of the positive electrode active materials 100a are aggregated in some cases. The conductive material 41 is in a tangled state, and is positioned to adhere to at least the positive electrode active material 100. The conductive material 41a is in a tangled state, and is positioned to adhere to the plurality of positive electrode active materials 100a.

An enlarged view in FIG. 3D shows an example of a conductive material 41b adhering to the plane other than the (001) plane of the positive electrode active material 100. The conductive material 41b is considered to more easily adhere to the plane other than the (001) plane than to the (001) plane of the positive electrode active material 100. By reinforcing the plane other than the (001) plane, which triggers cracking, with use of the conductive material 41b or the like adhering to the plane other than the (001) plane, cracking of the positive electrode active material 100 can be inhibited.

The above-described conductive material 41, conductive material 41a, and conductive material 41b ensure a long conductive path and thus allow rapid charging. Furthermore, cracking, breakage, shifting, or the like of the positive electrode active material 100 can be inhibited and thus the safety can be improved.

The conductive material 41 is a material having a lower resistance than the positive electrode active material 100. Meanwhile, when the first region 100s has a high concentration of magnesium or the like, the positive electrode active material 100 might have a high insulating property. That is, the safety is improved, but the discharge capacity might be decreased. In view of the above, the structure is employed in which the conductive material 41 adheres to the surface of the positive electrode active material 100, which facilitates insertion and extraction of lithium even with a high concentration of the additive element such as magnesium, enabling operation of a secondary battery.

The specific surface area of VGCF among carbon fiber is preferably less than or equal to 100 m²/g, further preferably greater than or equal to 60 m²/g, still further preferably greater than or equal to 20 m²/g. The specific surface area of a CNT among carbon fiber is preferably greater than or equal to 500 m²/g, further preferably greater than or equal to 650 m²/g, still further preferably greater than or equal to 800 m²/g. The specific surface area is, for example, a value measured by a BET method.

The major axis length or the fiber length of VGCF among carbon fiber is preferably greater than or equal to 1 μm and less than or equal to 100 μm, further preferably greater than or equal to 2 μm and less than or equal to 20 μm. The major axis length or the fiber length of a CNT among carbon fiber is preferably greater than or equal to 100 μm and less than or equal to 600 μm, further preferably greater than or equal to 200 μm and less than or equal to 500 μm. Carbon fiber having a major axis length or a fiber length that is larger than the median diameter of the positive electrode active material can be placed across a plurality of positive electrode active materials; thus, the present invention is not limited to the above values. Furthermore, since carbon fiber is in a tangled state, the major axis length or the fiber length of one carbon fiber is not so important, and the major axis length in the tangled state is also important for the conductive material.

Furthermore, the average diameter of carbon fiber is preferably greater than or equal to 1 nm and less than or equal to 180 nm, further preferably greater than or equal to 2 nm and less than or equal to 150 nm. The average diameter of VGCF or the like is large and thus can be greater than or equal to 100 nm and less than or equal to 180 nm, preferably greater than or equal to 130 nm and less than or equal to 160 nm. With a large diameter, high dispersibility can be obtained. The average diameter of a CNT or the like is small and thus can be greater than or equal to 1 nm and less than or equal to 100 nm, preferably greater than or equal to 1 nm and less than or equal to 50 nm, further preferably greater than or equal to 3 nm and less than or equal to 5 nm. Note that not an aggregate but one carbon fiber needs to have the average diameter. Carbon fiber having the above-described length and average diameter is likely to form an aggregate and is likely to be in a tangled state. In particular, a CNT or the like with a small average diameter is likely to be in a tangled state. Carbon fiber in a tangled state can inhibit occurrence of cracking, breakage, shifting, or the like of the positive electrode active material while functioning as a conductive path for the positive electrode active material with a small median diameter, and can inhibit a change in a plurality of positive electrode active materials and the like due to charge and discharge cycles.

Instead of carbon fiber, graphene or a graphene compound may be used as the conductive material. Graphene or a graphene compound can be regarded as a sheet-like conductive material, and thus, like a fibrous conductive material, can inhibit occurrence of cracking, breakage, shifting, or the like of the positive electrode active material while functioning as a conductive path for the positive electrode active material with a small median diameter, and is expected to have an effect of inhibiting a change in a plurality of positive electrode active materials and the like due to charge and discharge cycles.

A graphene compound in this specification and the like refers to graphene, multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound is preferably curved.

The content of the conductive material to the total amount of the active material layer is preferably greater than or equal to 0.1 wt % and less than or equal to 10 wt %, further preferably greater than or equal to 1 wt % and less than or equal to 5 wt %. In the case of using a CNT as the conductive material, the content of the CNT to the total amount of the active material layer is preferably greater than or equal to 0.3 wt % and less than or equal to 10 wt %, further preferably greater than or equal to 0.3 wt % and less than or equal to 5 wt %.

### <Details of Additive Element>

### <Magnesium>

Magnesium, which is an example of the additive element, is divalent, and an magnesium ion is more stable in lithium sites than in cobalt sites in the layered rock-salt crystal structure and thus is likely to enter the lithium sites. An appropriate concentration of magnesium in the lithium sites of the surface portion can facilitate maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100. In addition, a high concentration of magnesium in the surface portion probably increases the corrosion resistance to hydrofluoric acid generated by the decomposition of the electrolyte solution.

An appropriate concentration of magnesium can bring the above-described advantages without an adverse effect on insertion and extraction of lithium in charging and discharging. However, excess magnesium might adversely affect insertion and extraction of lithium. Furthermore, the effect of stabilizing the crystal structure might be reduced. This is probably because magnesium enters the cobalt sites in addition to the lithium sites. Moreover, a surplus magnesium compound (e.g., oxide or fluoride) which is substituted for neither the lithium site nor the cobalt site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 100 preferably contains an appropriate amount of magnesium. For example, the atomic ratio of magnesium is preferably greater than or equal to 0.001 times and less than or equal to 0.1 times, further preferably greater than 0.01 times and less than 0.04 times, still further preferably approximately 0.02 times the atomic ratio of cobalt. The amount of magnesium contained in the entire positive electrode active material 100 here may be a value obtained by element analysis on the entire positive electrode active material 100 with GD-MS, ICP-MS, or the like, or may be a value based on the ratio of the raw materials mixed in the formation process of the positive electrode active material 100, for example.

### <Aluminum>

Aluminum, which is an example of the additive element, can exist in the cobalt site in the layered rock-salt crystal structure. Since aluminum is a trivalent representative element and its valence does not change, lithium around aluminum is unlikely to move even in charging and discharging. Thus, aluminum and lithium therearound serve as columns to inhibit a change in the crystal structure. Furthermore, aluminum has effects of inhibiting elution of cobalt around aluminum and improving continuous charge tolerance. Moreover, an Al—O bond is stronger than a Co—O bond; thus, extraction of oxygen around aluminum can be inhibited. These effects improve thermal stability. Thus, a secondary battery that includes the positive electrode active material 100 containing aluminum as the additive element can have higher level of safety. Furthermore, the positive electrode active material 100 can have a crystal structure that is unlikely to be broken by repeated charging and discharging.

Meanwhile, excess aluminum might adversely affect insertion and extraction of lithium.

Thus, the entire positive electrode active material 100 preferably contains an appropriate amount of aluminum. For example, in the entire positive electrode active material 100, the atomic ratio of aluminum is preferably greater than or equal to 0.05% and less than or equal to 4%, further preferably greater than or equal to 0.1% and less than or equal to 2%, still further preferably greater than or equal to 0.3% and less than or equal to 1.5% of the atomic ratio of cobalt. Alternatively, it is preferably greater than or equal to 0.05% and less than or equal to 2%. Alternatively, it is preferably greater than or equal to 0.1% and less than or equal to 4%. The amount contained in the entire positive electrode active material 100 here may be a value obtained by element analysis on the entire positive electrode active material 100 with GD-MS, ICP-MS, or the like or may be a value based on the ratio of the raw materials mixed in the formation process of the positive electrode active material 100, for example.

### <Nickel>

Nickel, which is an example of the additive element, can exist in both the cobalt site and the lithium site. Nickel preferably exists in the cobalt sites because a lower oxidation-reduction potential can be obtained as compared with the case where only cobalt exists in the cobalt sites, leading to an increase in discharge capacity.

In addition, when nickel exists in lithium sites, a shift in the layered structure formed of octahedrons of cobalt and oxygen might be inhibited. Moreover, a change in volume in charging and discharging is inhibited. Furthermore, the elastic modulus becomes large, i.e., hardness increases. This is probably because nickel in the lithium sites serves as a column supporting the CoO₂ layers. Thus, the crystal structure is expected to be more stable in a charged state particularly at high temperatures, e.g., 45° C. or higher, which is preferable.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, the atomic ratio of nickel contained in the positive electrode active material 100 is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the atomic ratio of cobalt. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material with GD-MS, ICP-MS, or the like, or may be a value based on the ratio of the raw materials mixed in the formation process of the positive electrode active material, for example.

### <Fluorine>

Fluorine, which is an example of the additive element, is a monovalent anion; when fluorine is substituted for part of oxygen in the surface portion, the lithium extraction energy is lowered. This is because the change in valence of cobalt ions associated with lithium extraction is from trivalent to tetravalent in the case of not containing fluorine and is from divalent to trivalent in the case of containing fluorine, and the oxidation-reduction potentials in these cases differ from each other. It can thus be said that when fluorine is substituted for part of oxygen in the surface portion of the positive electrode active material 100, lithium ions near fluorine are likely to be extracted and inserted smoothly. Accordingly, a secondary battery including the positive electrode active material 100 can have improved charge and discharge characteristics, improved large current characteristics, or the like. When fluorine exists in the surface portion, which has a surface in contact with the electrolyte solution, the corrosion resistance to hydrofluoric acid can be effectively increased.

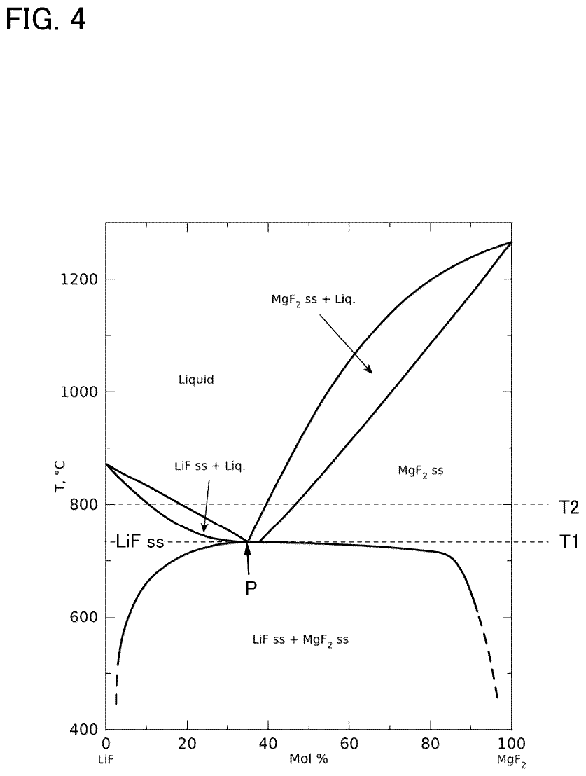

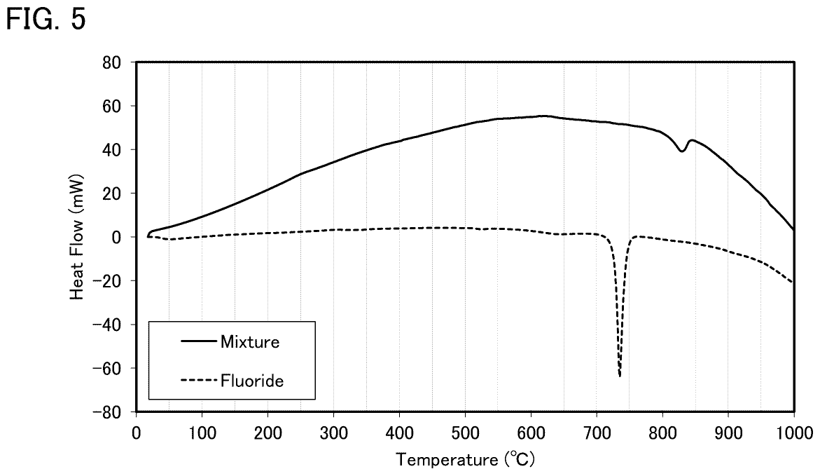

In the case where a fluorine compound (also referred to as a fluoride in some cases) such as lithium fluoride has a lower melting point than another additive element source, the fluorine compound or the like can serve as a fusing agent (also referred to as a flux agent) for lowering the melting point of the other additive element source. In the case of a fluorine compound containing LiF and MgF₂, the eutectic point P of LiF and MgF₂ is around 742° C. (T1) as shown in FIG. 4 (which is cited from FIG. 5 of Non-Patent Document 6 and retouched); thus, the heating temperature in the heating step following the mixing of the additive element is preferably set higher than or equal to 742° C.

Here, the results of the differential scanning calorimetry measurement (DSC measurement) of the fluoride and the mixture are described with reference to FIG. 5. FIG. 5 is a graph showing the amount of heat (Heat Flow) as a function of the temperature; the mixture is obtained by mixing lithium cobalt oxide and a fluoride, and LiF and MgF₂ are used for the fluoride. Specifically, the mixture is obtained by performing mixing at LiCoO₂:LiF:MgF_{2=100:0.33:1} (molar ratio). The fluoride in FIG. 5 is a mixture of LiF and MgF₂. Specifically, the fluoride is obtained by performing mixing at LiF:MgF₂=1:3 (molar ratio).

As shown in FIG. 5, the endothermic peak of the fluoride is observed around 735° C. In addition, the endothermic peak of the mixture is observed around 830° C. Thus, the temperature of the heating following the mixing of the additive element is preferably higher than or equal to 742° C., further preferably higher than or equal to 830° C. Alternatively, the temperature of the heating may be higher than or equal to 800° C. (T2 in FIG. 4), which is between the above temperatures.

### <Titanium>

An oxide of titanium, which is an example of the additive element, is known to have superhydrophilicity. Accordingly, the positive electrode active material 100 that contains titanium oxide in the surface portion presumably has good wettability with respect to a high-polarity solvent. In a secondary battery formed using this positive electrode active material 100, the positive electrode active material 100 and a high-polarity electrolyte solution can have favorable contact at the interface therebetween, which may inhibit an internal resistance increase.

### <Additive Element Distribution>

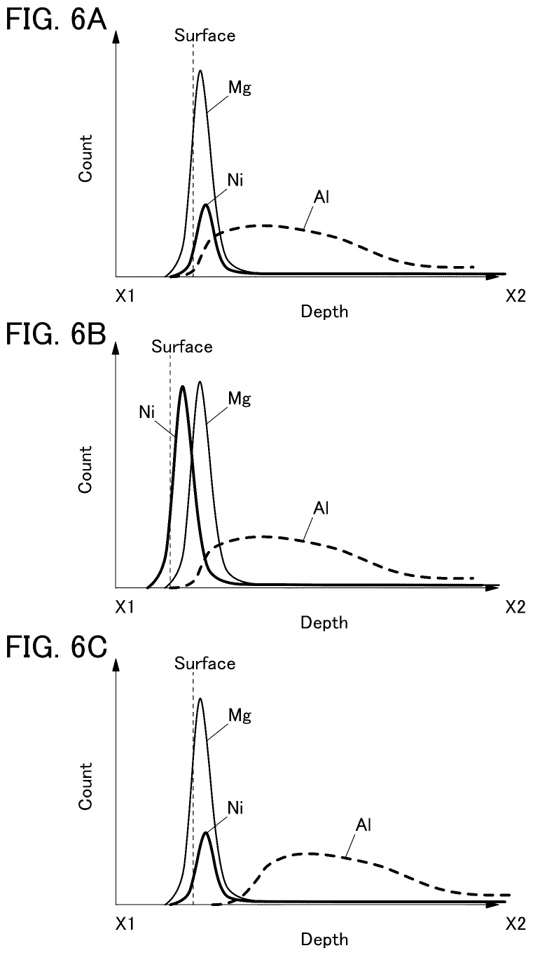

As shown in FIG. 6A to FIG. 6C, the detection intensities of at least magnesium and nickel among the additive elements in the surface portion are each preferably larger than the detection intensity in the inner portion 100b. A peak with a small width of the detection intensity is preferably observed in a region of the surface portion that is closer to the surface. For example, the peak of the detection intensity is preferably observed in a region ranging from the surface or the reference point to 3 nm or less. The distribution of magnesium and that of nickel preferably overlap with each other. The peak of the detection intensity of magnesium and that of the detection intensity of nickel may be at the same depth, the peak of magnesium may be closer to the surface, or the peak of nickel may be closer to the surface as shown in FIG. 6B. The difference in depth between the peak of the detection intensity of nickel and the peak of the detection intensity of magnesium is preferably less than or equal to 3 nm, further preferably less than or equal to 1 nm. In some cases, the detection intensity of nickel is much smaller in the inner portion 100b than in the surface portion, or no nickel is detected in the inner portion 100b.

Although not illustrated, as in the case of magnesium or nickel, the detection intensity of fluorine in the surface portion is preferably larger than the detection intensity in the inner portion. In addition, a peak of the detection intensity is preferably observed in a region of the surface portion that is closer to the surface. For example, the peak of the detection intensity is preferably observed in a region ranging from the surface or the reference point to 3 nm or less. Similarly, the detection intensity(s) of titanium, silicon, phosphorus, boron, and/or calcium in the surface portion are/is also preferably larger than the detection intensity(s) in the inner portion. In addition, a peak of the detection intensity is preferably observed in a region of the surface portion that is closer to the surface. For example, the peak of the detection intensity is preferably observed in a region ranging from the surface or the reference point to 3 nm or less.

A peak of the detection intensity of at least aluminum among the additive elements is preferably observed in a region that is located inward from a region where a peak of the detection intensity of magnesium is observed. The distribution of magnesium and that of aluminum may overlap with each other as shown in FIG. 6A, or there may be almost no overlap between the distribution of magnesium and that of aluminum as shown in FIG. 6C. A peak of the detection intensity of aluminum may exist in the surface portion or exist in a position deeper than the surface portion. For example, the peak is preferably observed in a region extending, toward the inner portion, from a depth from the surface or the reference point of 5 nm to a depth from the surface or the reference point of 30 nm.

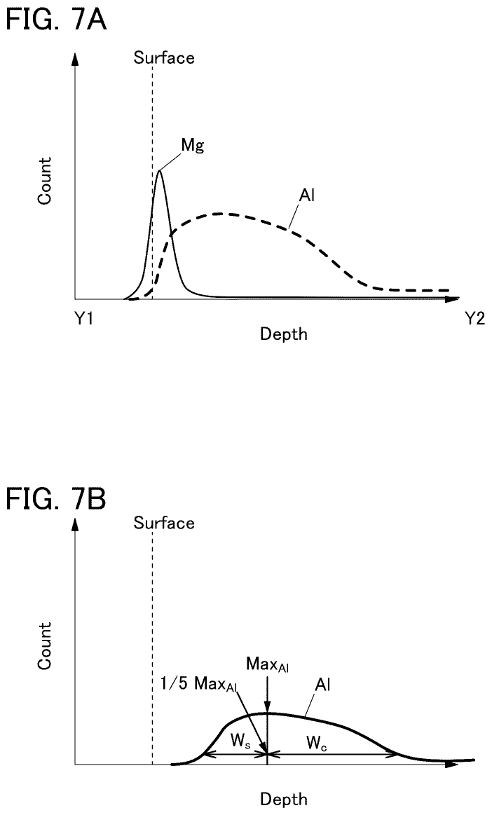

The distribution of aluminum is not normal distribution in some cases. For example, when the distribution of aluminum is divided by the maximum value Max_{Al}, the length of the tail on the surface side is sometimes different from that of the tail on the inner portion side. More specifically, when the peak width at the height (⅕ Max_{Al}) that is ⅕ of the height of the maximum value (Max_{Al}) of the detection intensity of aluminum is divided into two parts by a perpendicular extending from the maximum value to the horizontal axis, the peak width W_{c} on the inner portion side is sometimes larger than the peak width Wₛ on the surface side as shown in FIG. 7B.

In such a manner, aluminum is distributed more inwardly than magnesium presumably because the diffusion rate of aluminum is higher than that of magnesium. Meanwhile, the detection intensity of aluminum is low in the region that is the closest to the surface, which is presumably because aluminum can exist more stably in a region other than a region where magnesium or the like at a high concentration forms a solid solution.

To be specific, in a region having a layered rock-salt crystal structure belonging to the space group R-3m or a cubic rock-salt crystal structure, the distance between a cation and oxygen in a region where magnesium at a high concentration forms a solid solution is longer than the distance in LiAlO₂ having a layered rock-salt crystal structure, and thus aluminum is difficult to exist stably. In the vicinity of cobalt, valence change due to replacement of Li⁺ with Mg²⁺ can be offset by Co²⁺ which is changed from Co³⁺, so that cation balance can be maintained. By contrast, Al is always trivalent and thus is presumed to be unlikely to coexist with magnesium in a rock-salt or layered rock-salt crystal structure.

Although not illustrated, as in the case of aluminum, a peak of the detection intensity of manganese is preferably observed in a region that is located inward from that of magnesium.

Note that the additive elements do not necessarily have similar concentration gradients or similar distributions throughout the surface portion of the positive electrode active material 100. FIG. 7A shows an example of the profile of the additive element, showing a depth direction example of the (001) plane of lithium cobalt oxide that is the positive electrode active material 100.

The additive element distribution in the region having the surface with a (001) orientation may be different from that in the region having other surfaces. For example, the detection intensity of one or two or more selected from the additive elements may be lower in the region having the (001) plane than in the plane other than the (001) plane. Specifically, the detection intensity of nickel may be low. Alternatively, the peak of the detection intensity of one or two or more selected from the additive elements in the region having the surface with a (001) orientation may be positioned shallower from the surface than the peak thereof in the region having the plane other than the (001) plane is. Specifically, the peaks of the detection intensities of magnesium and aluminum may be positioned shallow from the surface in the region having the plane other than the (001) plane.

In a layered rock-salt crystal structure belonging to R-3m, cations are arranged parallel to the (001) plane. In other words, CoO₂ layers and lithium layers are alternately stacked parallel to the (001) plane. Accordingly, a diffusion path of lithium ions also exists parallel to the (001) plane. Meanwhile, the CoO₂ layer is relatively stable and thus, the surface of the positive electrode active material 100 is more stable when having a (001) orientation. A main diffusion path of lithium ions in charging and discharging is not exposed at the (001) plane.

A diffusion path of lithium ions is exposed at the plane other than the (001) plane. Thus, the plane other than the (001) plane and the surface portion thereof easily lose stability because they are regions where extraction of lithium ions starts as well as important regions for maintaining a diffusion path of lithium ions. It is thus extremely important to reinforce the plane other than the (001) plane and the surface portion thereof so that the crystal structure of the whole positive electrode active material 100 is maintained.

Accordingly, in the positive electrode active material 100, it is preferable that the additive element profile in the region having the plane other than the (001) plane be distribution shown in any one of FIG. 6A to FIG. 6C. In particular, among the additive elements, nickel is preferably detected in the region having the plane other than the (001) plane. By contrast, in the region having the (001) plane, the concentration of the additive element may be low as described above.

For example, the half width of the distribution of magnesium in the region having the (001) plane is preferably greater than or equal to 10 nm and less than or equal to 200 nm, further preferably greater than or equal to 50 nm and less than or equal to 150 nm, still further preferably greater than or equal to 80 nm and less than or equal to 120 nm. The half width of the distribution of magnesium in the region having the plane other than the (001) plane is preferably greater than 200 nm and less than or equal to 500 nm, further preferably greater than 200 nm and less than or equal to 300 nm, still further preferably greater than or equal to 230 nm and less than or equal to 270 nm.

The half width of the distribution of nickel in the region having the plane other than the (001) plane is preferably greater than or equal to 30 nm and less than or equal to 150 nm, further preferably greater than or equal to 50 nm and less than or equal to 130 nm, still further preferably greater than or equal to 70 nm and less than or equal to 110 nm.

In the formation method as described in the following embodiment, in which high-purity LiCoO₂ is formed, the additive element is mixed afterwards, and heating is performed, the additive element spreads mainly through a diffusion path of lithium ions. Thus, the additive element distribution in the region having the plane other than the (001) plane can easily fall within a preferred range.

### <Crystal Structure>

<x in LiₓCoO₂ is 1>

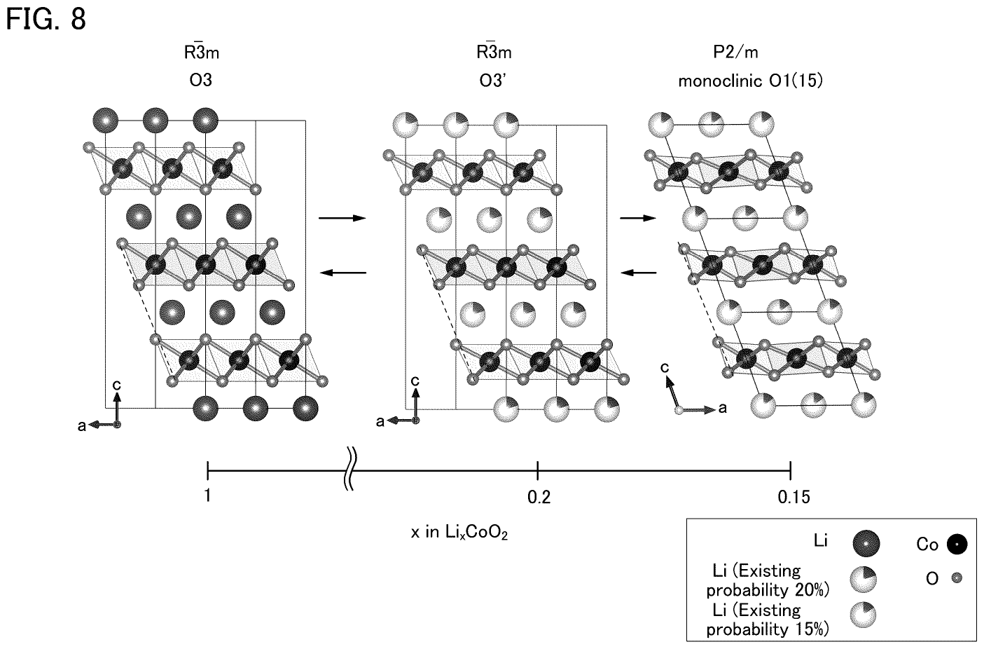

FIG. 8 illustrates the crystal structure of lithium cobalt oxide with x in LiₓCoO₂ of 1. In the case where x in LiₓCoO₂ is 1, the positive electrode active material 100 is in a discharged state. In the discharged state, the positive electrode active material 100 preferably has a layered rock-salt crystal structure belonging to the space group R-3m. It is preferable that the inner portion 100b, which accounts for the majority of the volume of the positive electrode active material 100, have a layered rock-salt crystal structure. In the layered rock-salt crystal structure, lithium occupies octahedral sites and a unit cell includes three CoO₂ layers; thus, this crystal structure is referred to as an O3 type crystal structure (denoted by O3 in the diagram) in some cases. Note that the CoO₂ layer is assumed to have a structure in which an octahedral structure with cobalt coordinated to six oxygen atoms continues on a plane in an edge-shared state. Such a layer is sometimes referred to as a layer formed of octahedrons of cobalt and oxygen.

The surface portion of the positive electrode active material 100 preferably has a function of reinforcing the layered structure, which is formed of octahedrons of a transition metal M and oxygen, of the inner portion 100b so that the layered structure does not break even when lithium is extracted from the positive electrode active material 100 by charging. Alternatively, the surface portion preferably functions as a barrier film for the positive electrode active material 100. Alternatively, the surface portion, which is the outer portion of the positive electrode active material 100, preferably reinforces the positive electrode active material 100. Here, the term “reinforce” means inhibition of a change in the structures of the surface portion and the inner portion 100b of the positive electrode active material 100, such as extraction of oxygen, and/or inhibition of oxidative decomposition of an electrolyte on the surface of the positive electrode active material 100.

Accordingly, the surface portion may have a crystal structure different from that of the inner portion 100b. For example, at least part of the surface portion of the positive electrode active material 100 may have a rock-salt crystal structure. Alternatively, the surface portion may have both a layered rock-salt crystal structure and a rock-salt crystal structure.

<State where x in LiₓCoO₂ is small>

The crystal structure in a state where x in LiₓCoO₂ is small of the positive electrode active material 100 is different from that of a conventional positive electrode active material. Here, “x is small” means 0.1<x≤0.24, and x=0.12 or x=0.2 may be used, for example. The conventional positive electrode active material is lithium cobalt oxide containing no additive element.

Conventional lithium cobalt oxide with x being approximately 0.12 has a crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that the number of cobalt atoms per unit cell in the actual H1-3 type crystal structure is twice that in other structures. However, in this specification including FIG. 8, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O1(0, 0, 0.27671±0.00045), and O2 (0, 0011535±0.00045). O1 and O2 are each an oxygen atom. A unit cell that should be used for representing a crystal structure in a positive electrode active material can be judged by Rietveld analysis of XRD patterns, for example. In this case, a unit cell is selected such that the value of GOF (goodness of fit) is small.

When such charging that makes x be 0.24 or less and discharging are repeated, the crystal structure of conventional lithium cobalt oxide repeatedly and dynamically changes between the R-3m O3 structure in a discharged state and the H1-3 type crystal structure (i.e., an unbalanced phase change), which might adversely affect the stability of the crystal structure.

Accordingly, when charging that makes x be 0.24 or less and discharging are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

Meanwhile, the positive electrode active material 100 illustrated in FIG. 8 has a crystal with a structure different from the H1-3 type crystal structure in a state where x is 0.24 or less, e.g., approximately 0.2, with which conventional lithium cobalt oxide has the H1-3 type crystal structure. The positive electrode active material 100 with x being approximately 0.2 has a trigonal crystal structure belonging to the space group R-3m. The symmetry of the CoO₂ layers of this structure is the same as that of O3. Thus, this crystal structure is called an O3′ type crystal structure. This crystal structure belongs to the space group R-3m, and thus is denoted by R-3m O3′ in FIG. 8. Although this crystal structure is not a spinel structure, an XRD pattern similar to that of the spinel structure appears in some cases, and this crystal structure is referred to as a pseudo-spinel structure in some cases.

In the unit cell of the O3′ type crystal structure, the coordinates of cobalt and oxygen can be represented by Co (0, 0, 0.5) and O (0, 0, x) within the range of 0.20<x<0.25. In the unit cell, the lattice constant of the a-axis is preferably 2.797≤a≤2.837 (×10⁻¹ nm), further preferably 2.807≤a≤2.827 (×10⁻¹ nm), typically a=2.817 (×10⁻¹ nm). The lattice constant of the c-axis is preferably 13.681≤c≤13.881 (×10⁻¹ nm), further preferably 13.751≤c≤13.811, typically c=13.781 (×10⁻¹ nm).

The positive electrode active material 100 of one embodiment of the present invention with x being approximately 0.15 has a monoclinic crystal structure belonging to the space group P2/m. This structure includes one CoO₂ layer in a unit cell. Here, lithium existing in the positive electrode active material 100 is approximately 15 atomic % of that in a discharged state.

Thus, this crystal structure is referred to as a monoclinic O1(15) type crystal structure. In FIG. 8, this crystal structure is denoted by P2/m monoclinic O1(15).

In the unit cell of the monoclinic O1(15) type crystal structure, the coordinates of cobalt and oxygen can be represented within the ranges below:

$$\begin{matrix}Co 1 ( 0.5 , 0 , 0.5 ) , \\ Co 2 ( 0 , 0.5 , 0.5 ) , \\ O 1 ( X ( O 1 ) , 0 , Z ( O 1 ) \\ 0.23 \leq X ( O 1 ) \leq 0.24 and 0.61 \leq Z ( O 1 ) \leq 0.65 , \\ O 2 ( X ( O 2 ) , 0.5 , Z ( O 2 ) ) , and \\ 0.75 \leq X ( O 2 ) \leq 0.78 and 0.68 \leq Z ( O 2 ) \leq 0.71 .\end{matrix}$$

The lattice constant of the unit cell is as follows:

$$\begin{matrix}a = 4.880 \pm 0.05 ( \times 1 {0}^{- 1} nm ) , \\ b = 2. 817 \pm 0.05 ( \times 1 {0}^{- 1} nm ) , \\ c = 4. 839 \pm 0.05 ( \times 1 {0}^{- 1} nm ) , \\ α = 90 ° , \\ β = 10 \; 9.6 \pm 0.1 ° , and \\ γ = 90 ° .\end{matrix}$$

Note that this crystal structure can have lattice constants even when belonging to the space group R-3m if a certain level of error is allowed. The coordinates of cobalt and oxygen in the unit cell of this case can be represented within the ranges below:

$$\begin{matrix}Co ( 0 , 0 , 0.5 ) , \\ O ( 0 , 0 , Z ( O ) ) , and \\ 0.21 \leq Z ( O ) \leq 0.23 .\end{matrix}$$

The lattice constant of the unit cell is as follows:

$$\begin{matrix}a = 2.817 \pm 0.02 ( \times 1 {0}^{- 1} nm ) , and \\ c = 13 \; 68 \pm 0.1 ( \times 1 {0}^{- 1} nm ) .\end{matrix}$$

In both of the O3′ type crystal structure and the monoclinic O1(15) type crystal structure, an ion of cobalt, nickel, magnesium, or the like occupies a site coordinated to six oxygen atoms. Note that a light element such as lithium and magnesium sometimes occupies a site coordinated to four oxygen atoms.

As denoted by the dotted lines in FIG. 8, the CoO₂ layers hardly shift between the R-3m O3 in a discharged state, the O3′ type crystal structure, and the monoclinic O1(15) type crystal structure.

The R-3m O3 in a discharged state and the O3′ type crystal structure which contain the same number of cobalt atoms have a difference in volume of 2.5% or less, specifically 2.2% or less, typically 1.8%.

The R-3m O3 in a discharged state and the monoclinic O1(15) type crystal structure which contain the same number of cobalt atoms have a difference in volume of 3.3% or less, specifically 3.0% or less, typically 2.5%.

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume per the same number of cobalt atoms is inhibited. Thus, the crystal structure of the positive electrode active material 100 is unlikely to break even when charging that makes x be 0.24 or less and discharging are repeated. Thus, a decrease in discharge capacity of the positive electrode active material 100 in charge and discharge cycles is inhibited. Furthermore, compared with the case of a conventional positive electrode active material, a larger amount of lithium can be inserted and extracted stably, and thus the positive electrode active material 100 enables high discharge capacity per weight and per volume. Accordingly, with the use of the positive electrode active material 100, a secondary battery with high discharge capacity per weight and per volume can be fabricated.

Note that the positive electrode active material 100 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27.

However, the crystal structure is influenced by not only x in LiₓCoO₂ but also the number of charge and discharge cycles, a charge current and a discharge current, temperature, an electrolyte, and the like, so that the range of x is not limited to the above. Hence, when x in LiₓCoO₂ in the positive electrode active material 100 is greater than 0.1 and less than or equal to 0.24, not all of the inner portion 100b of the positive electrode active material 100 necessarily has the O3′ type crystal structure. The positive electrode active material may include another crystal structure or may be partly amorphous.

In order to make x in LiₓCoO₂ small, charging at a high charge voltage is necessary in general. Thus, the state where x in LiₓCoO₂ is small can be rephrased as a state where charging at a high charge voltage has been performed. For example, when CC/CV charging is performed at a voltage of 4.6 V or higher with reference to the potential of a lithium metal in a 25° C. environment, the H1-3 type crystal structure appears in a conventional positive electrode active material. Thus, a charge voltage of 4.6 V or higher can be regarded as a high charge voltage with reference to the potential of a lithium metal. In this specification and the like, unless otherwise specified, a charge voltage is shown with reference to the potential of a lithium metal.

In the positive electrode active material 100, when the charge voltage is increased, the H1-3 type crystal is eventually observed in some cases. As described above, the crystal structure is influenced by the number of charge and discharge cycles, a charge current and a discharge current, an electrolyte, and the like, so that the positive electrode active material 100 of one embodiment of the present invention sometimes has the O3′ type crystal structure even at a lower charge voltage, e.g., a charge voltage of higher than or equal to 4.5 V and lower than 4.6 V at 25° C.

Note that in the case where graphite is used as a negative electrode active material in a secondary battery, for example, the voltage of the secondary battery is lower than the above-mentioned voltages by the potential of the graphite. The potential of the graphite is approximately 0.05 V to 0.2 V with reference to the potential of a lithium metal. Thus, in the case of a secondary battery using graphite as a negative electrode active material, a crystal structure similar to that at a voltage corresponding to a difference between the above-described voltage and the potential of the graphite is obtained.

Although a chance of the existence of lithium is the same in all lithium sites in O3′ in FIG. 8, one embodiment of the present invention is not limited thereto. Lithium may exist unevenly in only some of the lithium sites; for example, lithium may symmetrically exist as in the monoclinic O1 (Li_{0.5}CoO₂). Distribution of lithium can be analyzed by neutron diffraction, for example.

The O3′ type crystal structure can be regarded as a crystal structure that contains lithium between layers randomly but is similar to a CdCl₂ type crystal structure. The crystal structure similar to the CdCl₂ type crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ type crystal structure in general.

### <Analysis Method>

Whether or not a given positive electrode active material is the positive electrode active material 100 of one embodiment of the present invention, which has the O3′ type crystal structure when x in LiₓCoO₂ is small, can be judged by analyzing a positive electrode including the positive electrode active material with small x in Li.CoO₂ by XRD, electron diffraction, neutron diffraction, electron spin resonance (ESR), nuclear magnetic resonance (NMR), or the like.

XRD is particularly preferable because the symmetry of a transition metal such as cobalt contained in the positive electrode active material can be analyzed with high resolution, comparison of the degree of crystallinity and comparison of the crystal orientation can be performed, distortion of lattice periodicity and the crystallite size can be analyzed, and a positive electrode obtained only by disassembling a secondary battery can be measured with sufficient accuracy, for example. A diffraction peak reflecting the crystal structure of the inner portion 100b of the positive electrode active material 100, which accounts for the majority of the volume of the positive electrode active material 100, is obtained through XRD, in particular, powder XRD.

In the case where the crystallite size is analyzed by powder XRD, the measurement is preferably performed while the influence of orientation due to pressure or the like is preferably removed. For example, it is preferable that the positive electrode active material be taken out from a positive electrode obtained from a disassembled secondary battery, the positive electrode active material be made into a powder sample, and then the measurement be performed. Note that a positive electrode active material with small x sometimes causes a change in the crystal structure when exposed to the air. For example, the O3′ type crystal structure changes into the H1-3 type crystal structure in some cases. For that reason, all samples subjected to analysis of crystal structures are preferably handled in an inert atmosphere such as an argon atmosphere.

### <XRD>

The apparatus and conditions of the XRD measurement are not particularly limited as long as appropriate adjustment and calibration are performed. The measurement can be performed with the apparatus and conditions as described below, for example.
XRD apparatus: D8 ADVANCE produced by Bruker AXS
X-ray source: Cu (CuKα₁ radiation)
Output: 40 kV, 40 mA
Angle of divergence: Div. Slit, 0.5°
Detector: LynxEye
Scanning method: 2θ/θ continuous scanning
Measurement range (2θ): from 15° to 90°
Step width (2θ): 0.01° counting time: 1 second/step
Rotation of sample stage: 15 rpm

As a standard sample used for the adjustment and calibration, a standard sintered alumina plate SRM 1976 from NIST (National Institute of Standards and Technology) can be used, for example.

In the case where the measurement sample is a powder, the sample can be set by, for example, being put on a glass sample holder or being sprinkled on a reflection-free silicon plate to which grease is applied. In the case where the measurement sample is a positive electrode, the positive electrode can be set by being attached to a substrate with a double-sided adhesive tape such that the position of the positive electrode active material layer can be adjusted to the measurement plane required by the apparatus.

Characteristic X-rays may be monochromatized with the use of a filter or the like or may be monochromatized with XRD data analysis software after an XRD pattern is obtained. For example, a peak due to CuKα₂ radiation can be eliminated and only a peak due to CuKα₁ radiation can be extracted by using DEFFRAC.EVA (XRD data analysis software produced by Bruker Corporation). This software can also be used to eliminate the background, for example.

In this specification and the like, the value of 20 of a diffraction peak refers to the value of 20 at which a peak top of the diffraction peak appears in the XRD pattern after the calculation model is fitted. There is no particular limitation on the crystal structure analysis software used for the fitting; for example, it is possible to use TOPAS ver. 3 (crystal structure analysis software produced by Bruker Corporation).

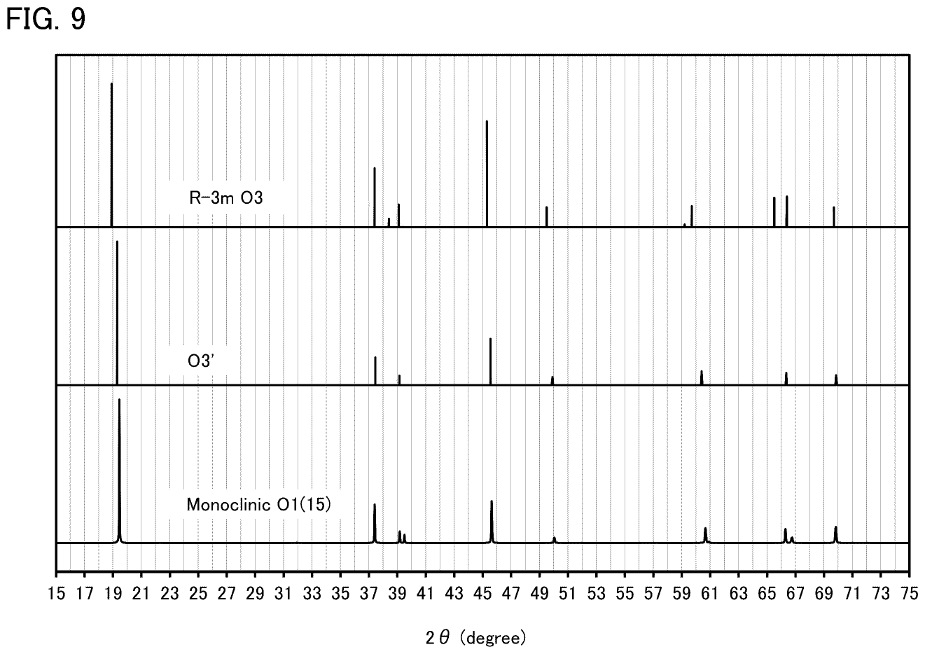

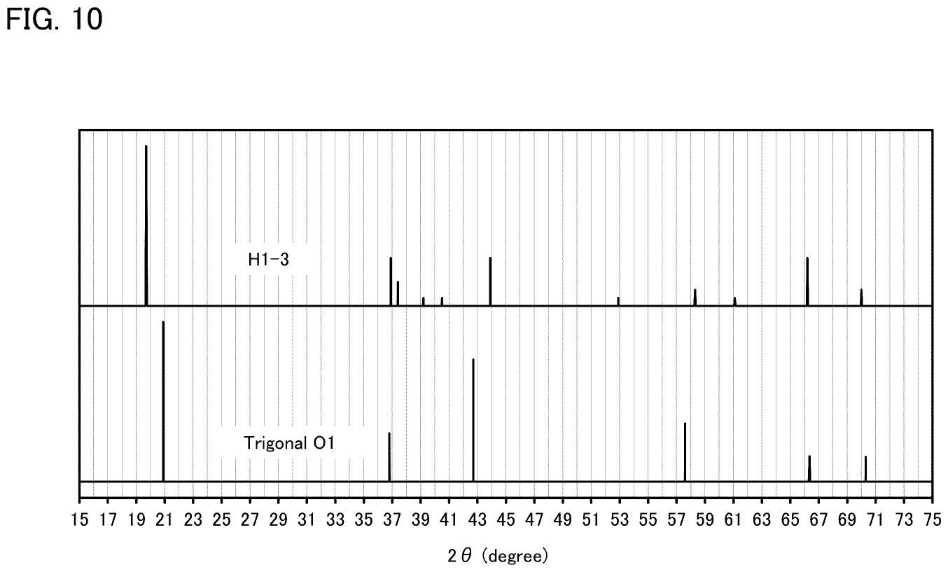

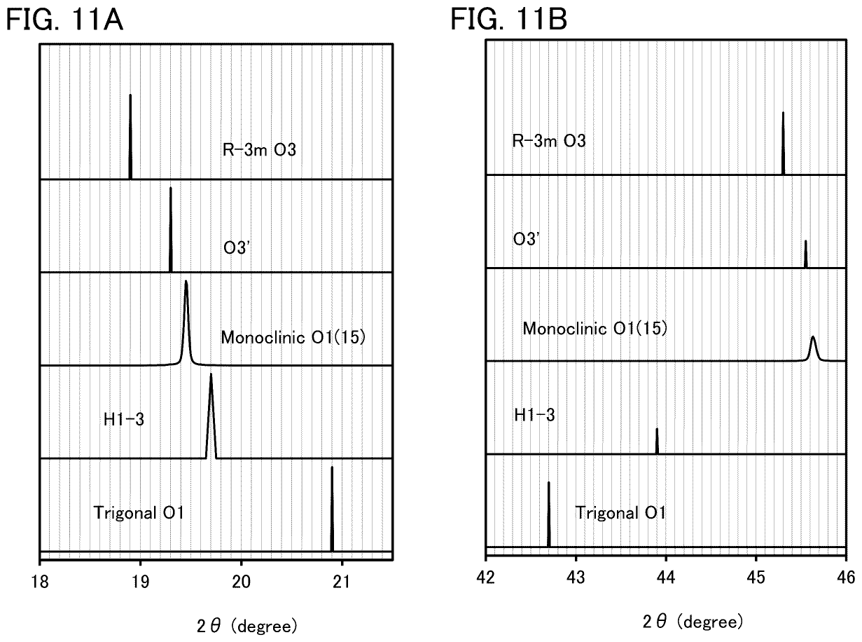

FIG. 9 shows XRD patterns of the O3 type crystal structure, the O3′ type crystal structure, and the monoclinic O1(15) type crystal structure of the case where CuKα₁ is used as a radiation source. FIG. 10 shows an ideal powder XRD pattern with CuKα₁ radiation calculated from a model of the H1-3 type crystal structure and an ideal XRD pattern with CuKα₁ radiation calculated from the trigonal O1 type crystal structure with x of 0. FIG. 11A and FIG. 11B show all the XRD patterns described above. Note that the patterns in the range of 20 of 18° to 21°, and the range of 20 of 42° to 46° are shown. Note that the patterns of LiCoO₂ (O3) and CoO₂ (O1) were made from crystal structure data obtained from ICSD (Inorganic Crystal Structure Database) with Reflex Powder Diffraction, which is a module of Materials Studio (BIOVIA). At this time, the 20 range was from 15° to 75°, the step size was 0.01, the wavelength λ was 1.54×10⁻¹⁰ m, and a single monochromator was used. Patterns of the O3′ type crystal structure and the monoclinic O1(15) type crystal structure were obtained in the following manner: the crystal structures were estimated from the XRD pattern of the positive electrode active material 100, and the fitting was performed with TOPAS ver. 3 (crystal structure analysis software produced by Bruker Corporation).

As shown in FIG. 9, FIG. 11A, and FIG. 11B, the O3′ type crystal structure exhibits diffraction peaks at 2θ of 19.25±0.12° (greater than or equal to 19.13° and less than) 19.37° and 2θ of 45.47±0.10° (greater than or equal to 45.37° and less than 45.57°).

Furthermore, the monoclinic O1(15) type crystal structure exhibits diffraction peaks at 20 of 19.47±0.10° (greater than or equal to 19.37° and less than or equal to 19.57°) and 20 of 45.62±0.05° (greater than or equal to 45.57° and less than or equal to 45.67°).

However, as shown in FIG. 10, FIG. 11A, and FIG. 11B, the H1-3 type crystal structure and the trigonal O1 do not exhibit peaks at these positions. Thus, exhibiting the peak at greater than or equal to 19.13° and less than 19.37° and/or the peak at greater than or equal to 19.37° and less than or equal to 19.57° and the peak at greater than or equal to 45.37° and less than 45.57° and/or the peak at greater than or equal to 45.57° and less than or equal to 45.67° in a state with small x in LiₓCoO₂ can be the feature of the positive electrode active material 100.

It can be said that the positions of the XRD diffraction peaks exhibited by the crystal structure with x=1 and the crystal structure with x≤0.24 are close to each other. More specifically, it can be said that a difference in 20 between the main diffraction peak exhibited by the crystal structure with x=1 and the main diffraction peak exhibited by the crystal structure with x≤0.24, which are exhibited at 20 of greater than or equal to 42° and less than or equal to 46°, is 0.7° or less, preferably 0.5° or less.

Although the positive electrode active material 100 has the O3′ type crystal structure and/or the monoclinic O1(15) type crystal structure when x in LiₓCoO₂ is small, not all of the particles necessarily have the O3′ type crystal structure and/or the monoclinic O1(15) type crystal structure. The positive electrode active material may include another crystal structure or may be partly amorphous. Note that when the XRD patterns are subjected to Rietveld analysis, the O3′ type crystal structure and/or the monoclinic O1(15) type crystal structure preferably account(s) for greater than or equal to 50%, further preferably greater than or equal to 60%, still further preferably greater than or equal to 66%. The positive electrode active material in which the O3′ type crystal structure and/or the monoclinic O1(15) type crystal structure account(s) for greater than or equal to 50%, preferably greater than or equal to 60%, further preferably greater than or equal to 66% enables sufficiently good cycle performance.

Furthermore, even after 100 or more cycles of charging and discharging after the measurement starts, the O3′ type crystal structure and/or the monoclinic O1(15) type crystal structure preferably account(s) for greater than or equal to 35%, further preferably greater than or equal to 40%, still further preferably greater than or equal to 43% when Rietveld analysis is performed.

In addition, the H1-3 type crystal structure and the O1 type crystal structure preferably account for less than or equal to 50% in Rietveld analysis performed in a similar manner. Alternatively, the H1-3 type crystal structure and the O1 type crystal structure preferably account for less than or equal to 34%. It is further preferable that substantially no H1-3 type crystal structure and substantially no O1 type crystal structure be observed.

Sharpness of a diffraction peak in an XRD pattern indicates the degree of crystallinity. It is thus preferable that the diffraction peaks after charging be sharp or in other words, have a small half width, e.g., a small full width at half maximum. Even peaks that are derived from the same crystal phase have different half widths depending on the XRD measurement conditions and the 2θ value. In the case of the above-described measurement conditions, the peak observed at 2θ greater than or equal to 43° and less than or equal to 46° preferably has a full width at half maximum less than or equal to 0.2°, further preferably less than or equal to 0.15°, still further preferably less than or equal to 0.12°. Note that not all peaks need to fulfill the requirement. A crystal phase can be regarded as having high crystallinity when some peaks fulfill the requirement. Such high crystallinity contributes to stability of the crystal structure after sufficient charging.

The crystallite sizes of the O3′ type crystal structure and the monoclinic O1(15) type crystal structure included in the positive electrode active material 100 do not decrease to less than approximately one-twentieth that of LiCoO₂ (03) in a discharged state. Thus, a clear peak of the O3′ type crystal structure and/or the monoclinic O1(15) type crystal structure can be observed when x in LiₓCoO₂ is small, even under the same XRD measurement conditions as those of a positive electrode before charging and discharging. In contrast, conventional LiCoO₂ has a small crystallite size and a broad and small peak even when it can have a structure part of which is similar to the O3′ type crystal structure and/or the monoclinic O1(15) type crystal structure.

### <Crystallite Size>

The crystallite size can be calculated from, for example, the Scherrer equation shown below.

$$Crystallite size [ nm ] = \frac{Scherrer Constant \times X - ray wavelength [ nm ]}{Half width [ rad ] \times cos ( \frac{Peak diffraction angle [ rad ]}{2} )} \qquad [ Formula 1 ]$$

To calculate the crystallite size, all diffraction peaks detected in a range where 20 is greater than or equal to 15° and less than or equal to 90° can be used. The crystallite sizes obtained at the diffraction peaks are preferably corrected to calculate an average value of the crystallite sizes.

An XRD diffraction pattern for calculation of the crystallite size is preferably obtained in a state of the positive electrode active material alone, or may be obtained in a state of a positive electrode including a current collector, a binder, a conductive material, and the like in addition to the positive electrode active material. Note that the positive electrode active material particles present in the positive electrode might be oriented such that the crystal planes of the positive electrode active material particles are oriented in the same direction owing to, for example, pressure application in a formation process. When the positive electrode active material particles have high orientation, the crystallite size might fail to be calculated accurately; thus, it is further preferable that to obtain an XRD diffraction pattern, a positive electrode active material layer be taken out of the positive electrode, the binder and the like in the positive electrode active material layer be eliminated to some extent using a solvent or the like, and a sample holder be filled, for example. Alternatively, a powder sample of the positive electrode active material or the like may be attached onto a reflection-free silicon plate to which grease is applied, for example.

The crystallite size can be calculated using ICSD coll. code. 172909 as the literature value of lithium cobalt oxide and a diffraction pattern that is obtained with Bruker D8 ADVANCE, for example, CuKα₁ used as an X-ray source, the 2θ ranged from 15° to 90°, an increment being 0.005, and a detector being LYNXEYE XE-T. This literature value can be used for correction. DIFFRAC.TOPAS ver. 6 can be used as crystal structure analysis software for analysis, and set as follows, for example. A value of L Vol-IB, which is a crystallite size, is preferably employed as a crystallite size. Note that preferred orientation is calculated to be less than 0.8, too many particles are oriented in the same direction in a sample; thus, this sample is not suitable for calculation of a crystallite size in some cases.

### <Charging Method>

Charging for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, it is possible to use a positive electrode formed by application of slurry in which the positive electrode active material, a conductive material, and a binder are mixed to a positive electrode current collector made of aluminum foil.

A lithium metal can be used for a counter electrode. Note that when a material other than the lithium metal is used for the counter electrode, the potential of a secondary battery differs from the potential of the positive electrode. Unless otherwise specified, the voltage and the potential in this specification and the like refer to the potential of a positive electrode.

As an electrolyte contained in an electrolyte solution, 1 mol/L lithium hexafluorophosphate (LiPF₆) can be used. As the electrolyte solution, a solution in which ethylene carbonate (EC) and diethyl carbonate (DEC) are mixed at EC: DEC=3:7 (volume ratio) and 2 wt % vinylene carbonate (VC) is added thereto can be used.

As a separator, a 25-μm-thick polypropylene porous film can be used.

A positive electrode can and a negative electrode can each formed using stainless steel (SUS) can be used.

The coin cell fabricated with the above conditions is charged with a given voltage (e.g., 4.5 V, 4.55 V, 4.6 V, 4.65 V, 4.7 V, 4.75 V, or 4.8 V). The charging method is not particularly limited as long as charging with a given voltage can be performed for sufficient time. In the case of CCCV charging, for example, CC charging can be performed with a current higher than or equal to 20 mA/g and lower than or equal to 100 mA/g. CV charging can be ended with a current higher than or equal to 2 mA/g and lower than or equal to 10 mA/g. To observe a phase change of the positive electrode active material, charging with such a small current value is preferably performed. The temperature is set to 25° C. or 45° C. After charging is performed in this manner, the coin cell is disassembled in a glove box with an argon atmosphere to take out the positive electrode, whereby the positive electrode active material with predetermined charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. After charging is completed, the positive electrode is preferably taken out immediately and subjected to the analysis. Specifically, the positive electrode is preferably subjected to analysis within 1 hour, further preferably within 30 minutes after the completion of charging.

In the case where the crystal structure in a charged state after charging and discharging are performed multiple times is analyzed, the conditions of the charging and discharging performed multiple times may be different from the above-described charging conditions. For example, as charging, constant current charging to a given voltage (e.g., 4.6 V, 4.65 V, 4.7 V, 4.75 V, or 4.8 V) at a current value higher than or equal to 20 mA/g and lower than or equal to 100 mA/g can be performed and then constant voltage charging can be performed until the current value becomes higher than or equal to 2 mA/g and lower than or equal to 10 mA/g, and as discharging, constant current discharging can be performed until the voltage reaches 2.5 V at higher than or equal to 20 mA/g and lower than or equal to 100 mA/g.

Also in the case where the crystal structure in a discharged state after charging and discharging are performed multiple times is analyzed, constant current discharging can be performed at 2.5 V and a current value higher than or equal to 20 mA/g and lower than or equal to 100 mA/g, for example.

### <Powder Resistivity Measurement>

The volume resistivity of a powder of the positive electrode active material 100 is described.

The volume resistivity of the powder of the positive electrode active material 100 is preferably higher than or equal to 1.0×10³Ω³·cm, further preferably higher than or equal to 4.0×10³Ω·cm under a pressure of 64 MPa. The additive element is distributed at a preferable concentration in the first region 100s of the positive electrode active material 100, so that the above value is obtained. In other words, the volume resistivity can be used as an indicator showing the favorable formation of the first region 100s. The positive electrode active material 100 with the above volume resistivity has a stable crystal structure even at a high voltage, and can be regarded as having a stable crystal structure of a positive electrode active material in a charged state.

Note that a battery reaction might be hindered in the case where a high-resistance region extends from the surface of the positive electrode active material 100 toward the inner portion thereof to have a large thickness. It is thus further preferable that only a thin region near the surface such as the first region 100s actually have high resistance. The first region 100s preferably extends from the surface toward the inner portion to have a small thickness, like a region that extends less than or equal to 20 nm, preferably less than or equal to 10 nm, further preferably less than or equal to 5 nm in a direction perpendicular or substantially perpendicular to the surface. Thus, the first region 100s is thinner than the surface portion in some cases.

When the volume resistivity is too high, charge and discharge cycle performance is insufficient in some cases. Thus, the volume resistivity of the powder of the positive electrode active material 100 is preferably lower than or equal to 1.0×10¹²Ω·cm. Note that in the case of using a CNT as the conductive material, the volume resistivity of the powder of the positive electrode active material 100 can be lower than or equal to 1.0×10¹³Ω·cm. Since the CNT can sufficiently ensure a conductive path, favorable charge and discharge cycle performance can be obtained even with the above-described volume resistivity.

A battery including the positive electrode active material 100 having such a volume resistivity can be a secondary battery that is unlikely to ignite in an internal short circuit test such as a nail penetration test. Moreover, the battery can achieve favorable performance in a charge and discharge cycle test under high-voltage conditions.

A method for measuring the volume resistivity of the powder of the positive electrode active material 100 of one embodiment of the present invention is described.

Measurement of the volume resistivity of a powder preferably employs a first mechanism including terminals for measuring resistance and a second mechanism for applying pressure to a powder sample (sample) serving as a measurement target. The second mechanism preferably includes a cylinder into which the powder sample is to be put and a piston which can move up and down in the cylinder. A spring or the like is connected to the piston, so that pressure can be applied to the sample in the cylinder. The first mechanism preferably includes a measurement electrode that is in contact with the bottom surface of the cylinder. As such a measurement instrument that includes the terminals for resistance measurement and the mechanism for applying pressure to the powder serving as a measurement target, for example, MCP-PD51 produced by Mitsubishi Chemical Analytech Co., Ltd. can be used. As a resistance meter, Loresta-GP or

Hiresta-UP can be used. Loresta-GP can be used for the measurement for a low-resistance sample by a four-probe method, whereas Hiresta-UP can be used for the measurement for a high-resistance sample by a two-terminal method. Note that the measurement environment is preferably a stable environment such as an environment of a dry room but may be an environment of a common laboratory. In the environment of a dry room, the temperature is preferably higher than or equal to 20° C. and lower than or equal to 25° C. and the dew point is preferably lower than or equal to −40° C., for example. In the environment of a common laboratory, the temperature may be higher than or equal to 15° C. and lower than or equal to 30° C. and the humidity may be higher than or equal to 30% and lower than or equal to 70%.

The measurement of the volume resistivity of the powder using the above-described measurement instrument is described. In the measurement of the volume resistivity of the powder, the electric resistance and thickness of the powder under pressure are measured. The pressure applied to the powder can be varied. For example, the electric resistance and thickness of the powder can be measured under pressures of 13 MPa, 25 MPa, 38 MPa, 51 MPa, and 64 MPa. The volume resistivity of the powder can be calculated from the measured value of the electric resistance and thickness of the powder.

A calculation method of volume resistivity is described. In the case where the measurement is performed by a two-terminal method using Hiresta-UP, the volume resistivity can be calculated by multiplying the electric resistance of the powder by the area of the electrode putting pressure on the powder and then dividing the product by the thickness of the powder. In the case where the measurement is performed by a four-probe method using Loresta-GP, the volume resistivity can be calculated by multiplying the electric resistance of the powder, a correction coefficient, and the thickness of the powder. The correction coefficient is a value that depends on the sample shape, the sample size, and the measurement position and can be calculated using calculation software incorporated in Loresta-GP.

### <X-Ray Photoelectron Spectroscopy (XPS)>

In an inorganic oxide, a region that extends from the surface to a depth of approximately 2 to 8 nm (usually, less than or equal to 5 nm) can be analyzed by XPS using monochromatic aluminum Kα radiation as an X-ray source; thus, the concentrations of elements in approximately half the depth of the surface portion can be quantitatively analyzed. The bonding states of the elements can be analyzed by narrow scanning.

In the positive electrode active material 100 of one embodiment of the present invention, the concentration of one or two or more selected from the additive elements is preferably higher in the surface portion or the first region 100s than in the inner portion 100b. This means that the concentration of one or two or more selected from the additive elements in the surface portion or the first region 100s is preferably higher than the average concentration of the selected element(s) in the entire positive electrode active material 100. For this reason, for example, it can be said that the concentration of one or two or more additive elements, which is measured by XPS or the like, is preferably higher than the average concentration of the additive element(s) in the entire positive electrode active material 100, which is measured by ICP-MS, GD-MS, or the like. The average concentration of the additive element in the entire positive electrode active material 100 includes the average of the concentration of the additive element in the surface portion and the concentration of the additive element in the inner portion. For example, the concentration of magnesium measured by XPS or the like is preferably higher than the average concentration of magnesium in the entire positive electrode active material 100. The concentration of nickel measured by XPS or the like is preferably higher than the average concentration of nickel in the entire positive electrode active material 100. The concentration of aluminum measured by XPS or the like is preferably higher than the average concentration of aluminum in the entire positive electrode active material 100. The concentration of fluorine measured by XPS or the like is preferably higher than the average concentration of fluorine in the entire positive electrode active material 100.

In XPS analysis on the positive electrode active material 100, for example, the ratio of the atomic ratio of cobalt to the atomic ratio of magnesium (which may be referred to as the existence ratio and is denoted by A_{Mg}/A_{Co}) is preferably greater than 0, and specifically, preferably greater than or equal to 0.8 and less than or equal to 1.4, further preferably greater than or equal to 0.9 and less than or equal to 1.3, still further preferably greater than or equal to 1.0 and less than or equal to 1.2. For example, the ratio of the atomic ratio of cobalt to the atomic ratio of nickel (A_{Ni}/A_{Co}) is preferably greater than 0, and preferably greater than or equal to 0.07 and less than or equal to 0.15, further preferably greater than or equal to 0.08 and less than or equal to 0.13, still further preferably greater than or equal to 0.09 and less than or equal to 0.11. For example, the ratio of the atomic ratio of cobalt to the atomic ratio of fluorine (A_{F}/A_{Co}) is preferably greater than 0, and preferably greater than or equal to 0.5 and less than or equal to 1.0, further preferably greater than or equal to 0.6 and less than or equal to 0.9, still further preferably greater than or equal to 0.7 and less than or equal to 0.8. The ratio is preferably within the above range in a plurality of portions, e.g., three or more portions of the positive electrode active material 100.

### <EDX>

The concentration of the additive element in the positive electrode active material 100 can be evaluated, for example, by exposing a cross section of the positive electrode active material 100 using FIB (Focused Ion Beam) or the like and analyzing the cross section using energy dispersive X-ray spectroscopy (EDX), EPMA (electron probe microanalysis), or the like. EDX analysis apparatuses are often provided in a SEM apparatus and a STEM apparatus, in which case the measurements are referred to as SEM-EDX measurement and STEM-EDX measurement, respectively.

EDX measurement that performs line scanning along with electron beam irradiation to conduct measurement and evaluation is referred to as line analysis. Meanwhile, EDX measurement that performs scanning on a point or a given area along with electron beam irradiation to conduct measurement is referred to as point analysis. The point analysis can measure a larger area than the line analysis, and thus is preferable in the case where a slight amount of element in a region is quantified. In each analysis, the concentration of each element can be calculated as a quantitative value. Moreover, in each measurement, the energy spectrum of each element can be obtained. In the case where the concentration of each element is very low, the concentration is preferably evaluated in combination with the energy spectrum.

A method for calculating a quantitative value of an element by STEM-EDX measurement is described. First, a positive electrode active material that has been processed using FIB is prepared as a sample, and a cross-sectional STEM image is obtained with a STEM apparatus. STEM-EDX line analysis is performed on a region using the cross-sectional STEM image as a reference; as a result, a graph with a horizontal axis representing the distance (nm) and a vertical axis representing the detected amount (detection intensity or Counts) of the characteristic X-ray or the quantitative value (atomic %) can be made. The quantitative value is calculated from the detection intensity. In the case of calculating the quantitative value of an element, a graph with a vertical axis representing the quantitative value (atomic %) is used. Furthermore, in the case of quantifying the concentration of an element in each of the surface portion and the inner portion of the positive electrode active material, a reference point such as the position of the surface needs to be specified. In this case, the reference point or the surface is a point corresponding to 50% of the sum of an average value MAVE of the detection intensity of cobalt in the inner portion and an average value MBG of the detection intensity of cobalt of the background, or a point corresponding to 50% of the sum of an average value OAVE of the detection intensity of oxygen in the inner portion and an average value OBG of oxygen of the background. The surface portion and the inner portion can be identified on the basis of the distance from the reference point or the surface. Note that in the case where the reference point obtained from cobalt and the reference point obtained from oxygen are different from each other, the difference is probably due to the influence of a carbonate, a metal oxide containing oxygen, or the like, which is attached to the surface. It is thus possible to employ the reference point obtained from cobalt.

The average value MBG of cobalt of the background can be calculated by averaging the detection intensity in the range extending greater than or equal to 2 nm, preferably greater than or equal to 3 nm in a region corresponding to the outside of the active material avoiding the vicinity of the portion where the detection intensity of cobalt begins to increase, for example. The average value MAVE of the detection intensity in the inner portion can be calculated by averaging the detection intensity in the range extending greater than or equal to 2 nm, preferably greater than or equal to 3 nm in a region where the detection intensities of cobalt and oxygen are saturated and stabilized, e.g., a region extending from a depth from the reference point or the surface of 30 nm, preferably from a depth from the reference point or the surface of 50 nm, in a depth direction. The average value OBG of oxygen of the background and the average value OAVE of the detection intensity of oxygen in the inner portion can be calculated in a similar manner.

When an element has a sufficient concentration, the peak or distribution of the element is observed in STEM-EDX line analysis results. On the other hand, when an element has a very low concentration, the peak and distribution of the element cannot be observed in some cases. In the case where an element has a sufficient concentration and thus its distribution is observed, the quantitative value (atomic %) on the vertical axis is the quantitative value of the element, and the concentration range of the element can be specified by reading the quantitative value (atomic %) on the vertical axis. In the case where an element has a very low concentration and thus its distribution is not observed, STEM-EDX point analysis is also preferably performed to determine the quantitative value in a complex manner. Specifically, the quantitative value is preferably determined in the following complex manner: an energy spectrum is obtained by STEM-EDX point analysis and the spectrum of the element is combined with the concentration.

The case of calculating a quantitative value of nickel, which is an additive element, is described as an example. Here, it is assumed that the surface portion and/or the inner portion contains a slight amount of nickel, and a clear distribution of nickel cannot be observed in STEM-EDX line analysis. In this case, the surface portion and/or the inner portion is subjected to STEM-EDX point analysis, and the obtained energy spectrum is referred to. When an energy peak of nickel is observed in the energy spectrum, the quantitative value (atomic %) on the vertical axis is the quantitative value of nickel. That is, the concentration range of nickel can be specified by reading the vertical axis of the graph. Meanwhile, when the spectrum of nickel is not observed, the quantitative value (atomic %) on the vertical axis can be regarded as an example of the upper limit of the concentration of nickel.

Through such a procedure, a quantitative value of each element can be calculated.

The distribution in STEM-EDX line analysis is different from the peak. The peak in STEM-EDX line analysis refers to the detection intensity in each element profile, the local maximum value of the concentration, or the maximum value of the characteristic X-ray of each element.

For example, in the EDX line analysis of the positive electrode active material 100 containing magnesium as the additive element, a peak of the concentration of magnesium in the surface portion is preferably observed in a region extending, toward the center of the positive electrode active material 100, from the surface thereof to a depth of 3 nm, further preferably 1 nm, still further preferably 0.5 nm. In addition, the concentration of magnesium preferably attenuates, at a depth of 1 nm from the point where the concentration reaches the peak, to less than or equal to 60% of the peak concentration. In addition, the concentration of magnesium preferably attenuates, at a depth of 2 nm from the point where the concentration reaches the peak, to less than or equal to 30% of the peak concentration. Note that due to the influence of spatial resolution in the EDX line analysis, the position where the peak of the concentration of magnesium exists may have a negative value when a depth from the surface, which is a reference, toward the inner portion has a positive value. The quantitative value of magnesium is preferably greater than 0 atomic %, further preferably greater than or equal to 0.3 atomic % and less than or equal to 7 atomic %, still further preferably greater than or equal to 0.3 atomic % and less than or equal to 5 atomic %. As described later in Example, the quantitative value may vary between crystal planes.

In the EDX line analysis, a peak of the concentration of fluorine in the surface portion is preferably observed in a region extending, toward the center of the positive electrode active material 100, from the surface thereof to a depth of 3 nm, further preferably 1 nm, still further preferably 0.5 nm. It is further preferable that a peak of the concentration of fluorine be exhibited slightly closer to the surface than a peak of the concentration of magnesium is, which increases resistance to hydrofluoric acid. For example, it is preferable that a peak of the concentration of fluorine be exhibited slightly closer to the surface than a peak of the concentration of magnesium is by 0.5 nm or more, further preferably 1.5 nm or more.

When the positive electrode active material 100 contains nickel as the additive element, a peak of the concentration of nickel in the surface portion is preferably observed in a region extending, toward the center of the positive electrode active material 100, from the surface thereof to a depth of 3 nm, further preferably 1 nm, still further preferably 0.5 nm. Alternatively, the peak is preferably observed within +1 nm from the surface. When the positive electrode active material 100 contains magnesium and nickel, the distribution of nickel preferably overlaps with the distribution of magnesium. For example, a difference in the depth direction between a peak of the concentration of nickel and a peak of the concentration of magnesium is preferably within 10 nm, further preferably within 3 nm, still further preferably within 1 nm. The quantitative value of nickel is preferably greater than 0 atomic %, further preferably greater than or equal to 0.3 atomic % and less than or equal to 3 atomic %, still further preferably greater than or equal to 0.3 atomic % and less than or equal to 2 atomic %. As described later in Example, the quantitative value may vary between crystal planes.

In the case where the positive electrode active material 100 contains aluminum as the additive element, the peak of the concentration of magnesium, nickel, or fluorine is preferably closer to the surface than the peak of the concentration of aluminum is in the surface portion in the EDX line analysis. For example, the peak of the concentration of aluminum is preferably observed in a region extending, toward the center of the positive electrode active material 100, from the surface thereof to a depth of greater than or equal to 0.5 nm and less than or equal to 50 nm, further preferably greater than or equal to 3 nm and less than or equal to 30 nm. The quantitative value of aluminum is preferably greater than 0 atomic %, further preferably greater than or equal to 0.1 atomic % and less than or equal to 3 atomic %, still further preferably greater than or equal to 0.1 atomic % and less than or equal to 2 atomic %. As described later in Example, the quantitative value may vary between crystal planes.

When the positive electrode active material 100 is subjected to EDX line analysis, area analysis, or point analysis, for example, the ratio of the atomic ratio of cobalt to the atomic ratio of magnesium (A_{Mg}/A_{Co}) at the peak position of magnesium is preferably greater than 0 in a region having an edge plane, and specifically, preferably greater than or equal to 0.8 and less than or equal to 1.4, further preferably greater than or equal to 0.9 and less than or equal to 1.3, still further preferably greater than or equal to 1.0 and less than or equal to 1.2. A region having a basal plane is considered to have a lower atomic ratio of Mg than the region having the edge plane. The ratio of the atomic ratio of cobalt to the atomic ratio of nickel (A_{Ni}/A_{Co}) at the peak position of nickel is preferably greater than 0 in the region having the edge plane, and preferably greater than 0, and preferably greater than or equal to 0.07 and less than or equal to 0.15, further preferably greater than or equal to 0.08 and less than or equal to 0.13, still further preferably greater than or equal to 0.09 and less than or equal to 0.11. The region having the basal plane is considered to have a lower atomic ratio of Mg than the region having the edge plane. The ratio of the atomic ratio of cobalt to the atomic ratio of fluorine (A_{F}/A_{Co}) is preferably greater than 0 in the region having the edge plane, and preferably greater than or equal to 0.5 and less than or equal to 1.0, further preferably greater than or equal to 0.6 and less than or equal to 0.9, still further preferably greater than or equal to 0.7 and less than or equal to 0.8. The ratio is preferably within the above range in a plurality of portions, e.g., three or more portions of the positive electrode active material 100.

When the line analysis or the area analysis is performed on the positive electrode active material 100 containing magnesium as the additive element, for example, the ratio of the atomic ratio of cobalt to the atomic ratio of magnesium (A_{Mg}/A_{Co}) in the vicinity of the crystal grain boundary is preferably greater than or equal to 0.020 and less than or equal to 0.50. It is further preferably greater than or equal to 0.025 and less than or equal to 0.30. It is further preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30. The ratio is preferably within the above range in a plurality of portions, e.g., three or more portions of the positive electrode active material 100.

### <Pretreatment for Analysis>

Before any of various kinds of analyses is performed, a sample such as a positive electrode active material or a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element is unlikely to be dissolved even in that case; thus, the quantitative value or the like of the additive element is not affected.

### <Nail Penetration Test>

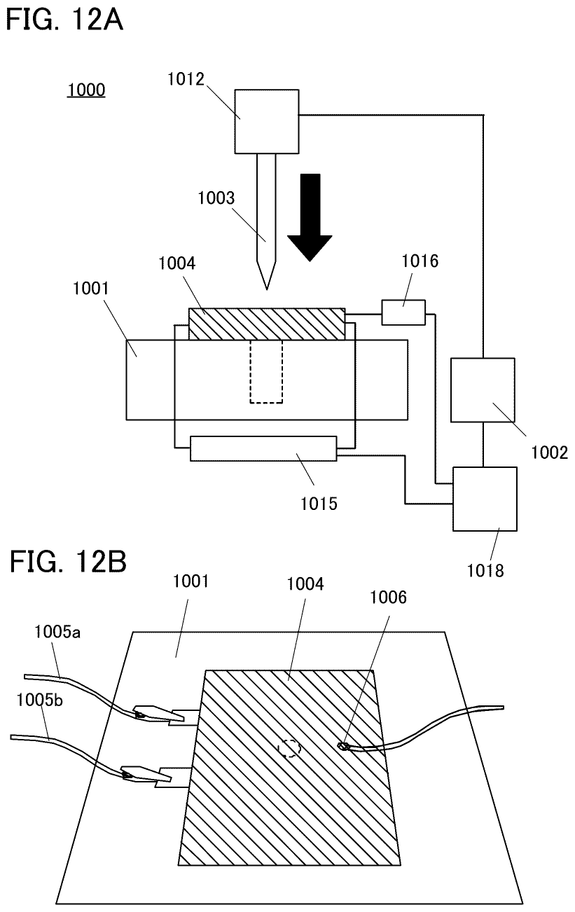

In a nail penetration test, a nail having a predetermined diameter in the range of 2 mm to 10 mm penetrates a secondary battery in a fully charged state at a predetermined speed. The nail penetrating speed can be, for example, greater than or equal to 1 mm/s and less than or equal to 20 mm/s. In this embodiment, first, a nail penetration test device will be described. FIG. 12A shows a side view of a nail penetration test device 1000, and FIG. 12B shows a perspective view of the nail penetration test device 1000.

The nail penetration test device 1000 illustrated in FIG. 12A includes a stage 1001, a driving portion 1002, a nail 1003, a voltage measuring device 1015, a temperature measuring device 1016, and a control portion 1018. The driving portion 1002 includes a driving mechanism 1012 for moving the nail 1003 in the arrow direction shown in the diagram. The driving mechanism 1012 operates so as to make the nail 1003 penetrate a secondary battery 1004 provided on the stage 1001. Here, the secondary battery 1004 is in a fully charged state (States Of Charge: SOC, the state where the secondary battery is 100%), and this operation is referred to as nail penetration operation. The dashed line in FIG. 12A indicates a depression of the stage 1001 for holding the nail 1003 that has penetrated the secondary battery in the nail penetration operation.

Data on the voltage of the secondary battery during the nail penetration operation is transmitted from the voltage measuring device 1015 to the control portion 1018. Data on the temperature during the nail penetration operation is transmitted from the temperature measuring device 1016 to the control portion 1018. To control operation conditions of the nail 1003, the control portion 1018 can transmit a control signal to the driving portion 1002.

FIG. 12B is a perspective view illustrating the upper side of the stage 1001 of the nail penetration test device 1000 and the vicinity of the upper side. The secondary battery 1004 provided on the stage 1001 is electrically connected to a wiring 1005a and a wiring 1005b. The wiring 1005a and the wiring 1005b belong to the voltage measuring device 1015, and the wiring 1005a and the wiring 1005b are electrically connected to a positive electrode side tab and a negative electrode side tab of the secondary battery 1004, so that the voltage of the secondary battery 1004 can be measured. In the case where a temperature sensor 1006 is used as the temperature measuring device 1016, the temperature sensor 1006 is provided to be in contact with a surface of an exterior body of the secondary battery 1004. Two or more temperature sensors may be provided. In the case where one temperature sensor cannot be used owing to expansion of the exterior body or the like, another of the temperature sensors is usable. In the case where two or more temperature sensors are provided, the nail penetration operation is preferably started after it is verified that the difference between the temperatures is less than or equal to ±5° C., preferably less than or equal to ±2° C. Note that the position indicated by the dashed ellipse in FIG. 12B represents a region where the nail 1003 penetrates the secondary battery 1004 in the nail penetration operation. The temperature sensor is provided preferably less than or equal to 5 cm away from the region where the nail 1003 passes through the secondary battery, further preferably less than or equal to 2 cm away from the region. In the case where two or more temperature sensors are provided, each of the temperature sensors is provided preferably less than or equal to 5 cm away from the region where the nail 1003 passes through the secondary battery, further preferably less than or equal to 2 cm away from the region.

### <Secondary Battery in Nail Penetration Test>

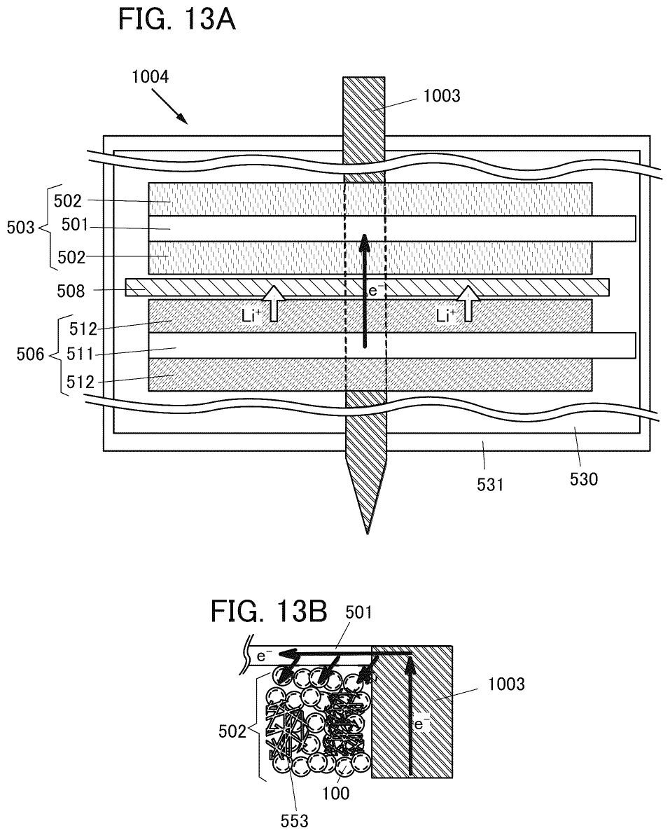

Next, the state of the secondary battery in the nail penetration test is described anew with reference to FIG. 13A, FIG. 13B, and the like. In the nail penetration test, the nail 1003 having a predetermined diameter in the range of 2 mm to 10 mm penetrates the secondary battery 1004 in a fully charged state at a predetermined speed. FIG. 13A shows a cross-sectional view illustrating the state where the nail 1003 penetrates the secondary battery 1004. The secondary battery 1004 has a structure in which a positive electrode 503, a separator 508, a negative electrode 506, and an electrolyte solution 530 are held in an exterior body 531. The positive electrode 503 includes a positive electrode current collector 501 and positive electrode active material layers 502 formed on both surfaces of the positive electrode current collector 501, and the negative electrode 506 includes a negative electrode current collector 511 and negative electrode active material layers 512 formed on both surfaces of the negative electrode current collector 511. FIG. 13B shows an enlarged view of the nail 1003 and the vicinity of the positive electrode current collector 501, and the positive electrode active material 100 and a conductive material 553 included in the positive electrode active material layer 502 are also illustrated. A carbon material is preferably used as the conductive material 553. The median diameter of the positive electrode active material 100 is less than or equal to 12 μm, preferably less than or equal to 10.5 μm, further preferably less than or equal to 8 μm; thus, it is considered that in the nail penetration test, the positive electrode active material 100 is unlikely to be cracked and the secondary battery is unlikely to ignite.

As shown in FIG. 13A and FIG. 13B, when the nail 1003 penetrates the secondary battery 1004, or specifically, when the nail 1003 passes through the positive electrode 503 and the negative electrode 506, an internal short circuit occurs. This makes the potential of the nail 1003 equal to the potential of the negative electrode 506, so that an electron (e⁻) flows to the positive electrode 503 through the nail 1003 and the like as indicated by the arrows, and Joule heat is generated in the portion of the internal short circuit and the vicinity thereof. Due to the internal short circuit, carrier ions extracted from the negative electrode 506, typically lithium ions (Li⁺), are released into the electrolyte solution as indicated by the white arrows. Here, in the case where anions are insufficient in the electrolyte solution 530, the electrical neutrality of the electrolyte solution 530 is not maintained when lithium ions are released from the negative electrode 506 into the electrolyte solution 530, so that the electrolyte solution 530 starts decomposing to maintain the electrical neutrality. This is one of electrochemical reactions and is referred to as a reduction reaction of an electrolyte solution by a negative electrode.

In the case where the Joule heat increases the temperature of the secondary battery 1004 and lithium cobalt oxide is used as the positive electrode active material, the lithium cobalt oxide sometimes undergoes a phase change (i.e., a structural change) to an H1-3 type crystal structure or an O1 type crystal structure to further generate heat. Note that H1-3 and O1 will be described later.

Then, as shown in FIG. 13A and FIG. 13B, the electron (e⁻) that flows to the positive electrode 503 reduces Co, which is tetravalent in the lithium cobalt oxide in the charged state, to trivalent or divalent Co, and oxygen is released from the lithium cobalt oxide by this reduction reaction. An oxidation reaction due to the oxygen decomposes the electrolyte solution 530. This is one of electrochemical reactions and is referred to as an oxidation reaction of an electrolyte solution by a positive electrode. The speed at which a current flows to the positive electrode active material 100 or the like slightly varies depending on the insulating property of the positive electrode active material, and it can also be deemed that the speed at which a current flows affects the above electrochemical reaction.

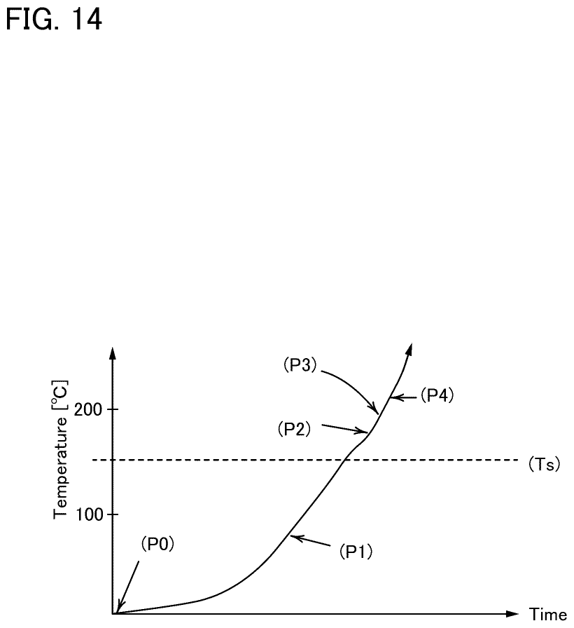

When an internal short circuit of a secondary battery occurs as described above, it is considered that the temperature changes as shown in the graph of FIG. 14. FIG. 14 is the graph cited from [FIG. 2-12] on page 70 of Non-Patent Document 1, which is partly retouched and is a graph of the temperature (specifically, the internal temperature) of a secondary battery with respect to time. When an internal short circuit at (P0) is caused, the temperature of the secondary battery increases over time. As shown at (P1), when heat generation due to Joule heat continues until the temperature of the secondary battery reaches the vicinity of 100° C., the temperature exceeds the reference temperature (Ts) of the secondary battery. Then, reduction of an electrolyte solution by a negative electrode (the negative electrode is CóLi when graphite is used) and heat generation are caused at (P2), oxidation of the electrolyte solution by a positive electrode and heat generation are caused at (P3), and heat generation due to thermal decomposition of the electrolyte solution is caused at (P4). Accordingly, the secondary battery enters thermal runaway, resulting in ignition, smoking, or the like.

To prevent smoking, heat generation, or the like in the nail penetration test, it is probably preferable that an increase in the temperature of the secondary battery be inhibited and the negative electrode, the positive electrode, and/or the electrolyte solution have stable characteristics at high temperatures. Specifically, the positive electrode active material 100 preferably has a stable structure from which no oxygen is released even when being exposed to high temperatures. Alternatively, the positive electrode active material 100 preferably has a structure in which a current flows to the positive electrode active material at a low speed. As described later, the positive electrode active material 100 of one embodiment of the present invention can have both the above stable structure and the above structure in which a current flows at a low speed.

### <Thermal Runaway of Secondary Battery>

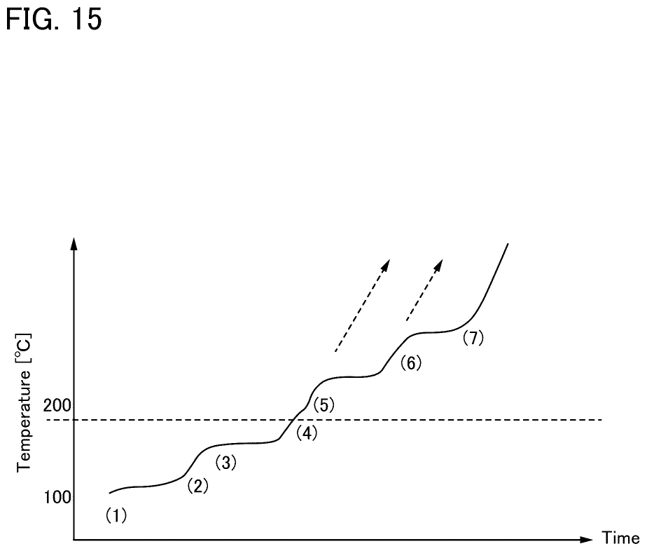

The mechanism of thermal runaway of a secondary battery is described with reference to FIG. 15 showing a graph cited from [FIG. 2-11] on page 69 of Non-Patent Document 1, which is partly retouched. A secondary battery as described above enters thermal runaway after passing through several states when the temperature (specifically, the internal temperature) increases during charging, for example. FIG. 15 is a graph showing the temperature of a secondary battery with respect to time. When the temperature of the secondary battery reaches 100° C. or the vicinity thereof, for example, (1) collapse of a SEI (Solid Electrolyte Interphase) of a negative electrode and heat generation are caused. When the temperature of the secondary battery exceeds 100° C., (2) reduction of an electrolyte solution by the negative electrode (the negative electrode is C₆Li when graphite is used) and heat generation are caused, and (3) oxidation of the electrolyte solution by a positive electrode and heat generation are caused. When the temperature of the secondary battery reaches 180° C. or the vicinity thereof, (4) thermal decomposition of the electrolyte solution is caused and (5) oxygen release from the positive electrode and thermal decomposition of the positive electrode (the thermal decomposition includes a structural change in a positive electrode active material) are caused. After that, when the temperature of the secondary battery exceeds 200° C., (6) decomposition of the negative electrode is caused, and finally, (7) the positive electrode and the negative electrode come into direct contact with each other. The secondary battery enters thermal runaway after passing through such states, specifically the state (5), the state (6), or the state (7).

To prevent thermal runaway, it is probably preferable that an increase in the temperature of the secondary battery be inhibited and the negative electrode, the positive electrode, and/or the electrolyte solution have stable characteristics at high temperatures.

The contents of this embodiment can be freely combined with the contents of the other embodiments.

### Embodiment 2

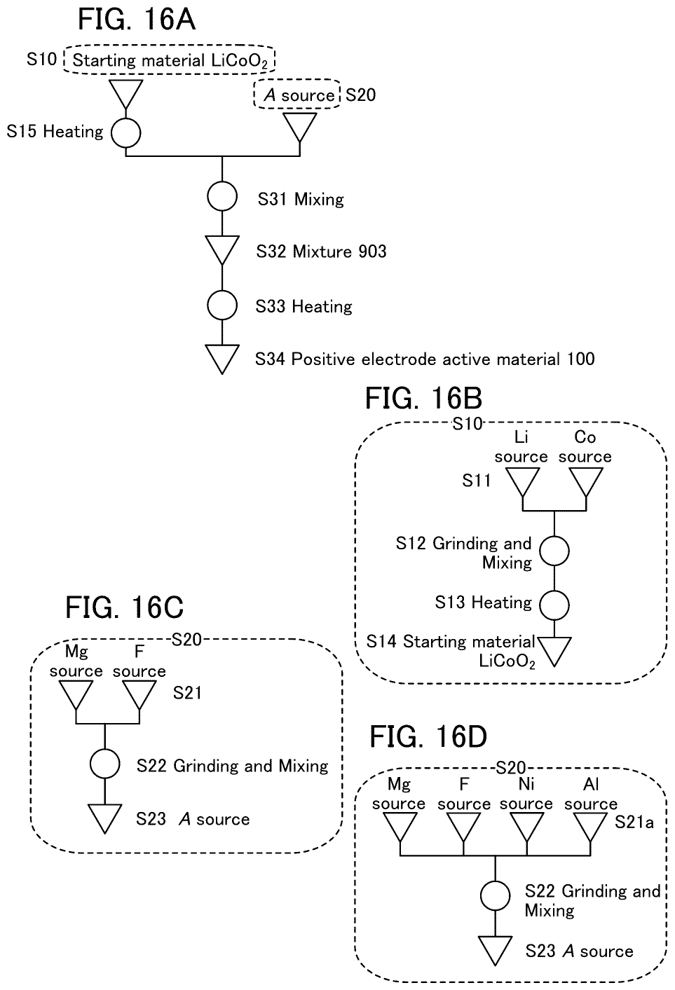

In this embodiment, a method for forming a positive electrode active material with a median diameter of less than or equal to 12 μm is described with reference to FIG. 16 to FIG. 18.

### <Example 1 of Method for Forming Positive Electrode Active Material>

An example of a method for forming the positive electrode active material that can be used as one embodiment of the present invention (Example 1 of method for forming positive electrode active material) will be described with reference to FIG. 16A to FIG. 16D. Note that in <Example 1 of method for forming positive electrode active material>, the additive elements described as an additive element X, an additive element Y, and an additive element Z in Embodiment 1 are collectively referred to as the additive element A.

### <Step S10>

First, lithium cobalt oxide is prepared as a starting material in Step S10. The median diameter of the lithium cobalt oxide is preferably less than or equal to 10 μm, further preferably less than or equal to 8 μm. As the lithium cobalt oxide with a median diameter of less than or equal to 10 μm, commercially available lithium cobalt oxide can be used. A typical example of the commercially available lithium cobalt oxide is lithium cobalt oxide produced by NIPPON CHEMICAL INDUSTRIAL CO., LTD. (product name: “CELLSEED C-5H”). Note that in this specification and the like, CELLSEED C-5H is simply referred to as “C-5H”. C-5H has a median diameter of approximately 7 μm.

As the lithium cobalt oxide with a median diameter of less than or equal to 10 μm, lithium cobalt oxide formed through Step S11 to Step S14 shown in FIG. 16B can be used. A formation method from Step S11 to Step S14 is described.

### <Step S11>

In Step S11 shown in FIG. 16B, a lithium source (denoted as Li source in the diagram) and a cobalt source (denoted as Co source in the diagram) are prepared as materials for lithium and a transition metal that are starting materials.

As the lithium source, a lithium-containing compound is preferably used and for example, lithium carbonate, lithium hydroxide, lithium nitrate, or lithium fluoride can be used. The lithium source preferably has a high purity and is preferably a material having a purity higher than or equal to 99.99%, for example.

As the cobalt source, a cobalt-containing compound is preferably used, and for example, tricobalt tetraoxide or cobalt hydroxide can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities in the positive electrode active material can be controlled by using a high-purity material. As a result, a secondary battery with an increased capacity and increased reliability can be obtained.

### <Step S12>

Next, in Step S12 shown in FIG. 16B, the lithium source and the cobalt source are ground and mixed to form a mixed material. The grinding and mixing can be performed by a dry method or a wet method. To obtain lithium cobalt oxide with a median diameter of less than or equal to 10 μm as a starting material, the grinding and mixing by a wet method are preferred because a material can be crushed into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the transition metal source be mixed into dehydrated acetone whose moisture content is less than or equal to 10 ppm and which has a purity of higher than or equal to 99.5% in the grinding and mixing. With the use of dehydrated acetone with the above-described purity, impurities that might be mixed can be reduced.

A ball mill, a bead mill, or the like can be used as a means for the grinding and mixing, for example. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the grinding medium.

### <Step S13>

Next, the materials mixed in the above manner are heated in Step S13 shown in FIG. 16B.

A temperature rising rate in a temperature rising step of the heat treatment is preferably higher than or equal to 80° C./h and lower than or equal to 250° C./h, although depending on the end-point temperature. In the case where the temperature of a temperature retaining step is 1000° C., for example, the temperature rising rate is preferably 200° C./h.

The temperature rising rate in a treatment chamber of a heat treatment apparatus preferably falls within the above range. Note that the temperature rising rate set for the heat treatment apparatus is not the same as the temperature rising rate in the treatment chamber in some cases. For example, the temperature rising rate in the treatment chamber is sometimes lower than the set temperature rising rate. The set temperature rising rate is adjusted such that the temperature rising rate in the treatment chamber falls within the above range. Note that in the case where the temperature in the treatment chamber cannot be measured, the temperature rising rate is set for the heat treatment apparatus to fall within the above range. In the case where the temperature of an object can be measured, it is further preferable that the temperature rising rate of the object fall within the above range.

The temperature of the temperature retaining step is preferably higher than or equal to 800° C. and lower than or equal to 1100° C., further preferably higher than or equal to 900° C. and lower than or equal to 1000° C., still further preferably approximately 950° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen vacancy or the like might be induced by a change of trivalent cobalt into divalent cobalt, for example.

The temperature in the treatment chamber of the heat treatment apparatus preferably falls within the above range. Note that the temperature set for the heat treatment apparatus is not the same as the temperature in the treatment chamber in some cases. For example, the temperature in the treatment chamber is sometimes lower than the set temperature. The set temperature is adjusted such that the temperature in the treatment chamber falls within the above range. Note that in the case where the temperature in the treatment chamber cannot be measured, the temperature is set for the heat treatment apparatus to fall within the above range. In the case where the temperature of an object can be measured, it is further preferable that the temperature of the object fall within the above range.

After the temperature rising step, a phenomenon in which the temperature in the treatment chamber becomes higher than the set temperature (also referred to as overshoot) sometimes occurs at the beginning of the temperature retaining step. Also in the case where the overshoot occurs, the temperature rising rate is preferably adjusted such that the temperature in the treatment chamber falls within the above temperature range of the temperature retaining step. A plurality of temperature rising steps at different temperature rising rates may be provided. For example, a first temperature rising step and a second temperature rising step after the first temperature rising step are provided, and the temperature rising rate in the second temperature rising step is set lower than the temperature rising rate in the first temperature rising step. This can inhibit occurrence of the overshoot. Note that in the case where the temperature temporarily deviates from the temperature range of the temperature retaining step because of the overshoot, the deviation period is preferably short.

When the time of the temperature retaining step is too short, lithium cobalt oxide is sometimes not synthesized, but when the time is too long, the productivity is lowered. For example, the time is preferably longer than or equal to 1 hour and shorter than or equal to 100 hours, further preferably longer than or equal to 2 hours and shorter than or equal to 20 hours.

Note that the temperature rising step, the temperature retaining step, and a cooling step do not need to be strictly distinguished from each other. In the heat treatment, the length of a period in which the temperature falls within the above temperature range is included in the above time range. Thus, in this specification and the like, the temperature of the temperature retaining step is sometimes referred to as a heat treatment temperature or a heating temperature, and the time of the temperature retaining step is sometimes referred to as a heat treatment time or a heating time.

The atmosphere of each of the temperature rising step and the temperature retaining step preferably contains oxygen. Examples of an oxygen-containing atmosphere include an oxygen atmosphere, a dry air atmosphere, an air atmosphere, and an atmosphere in which oxygen and another gas (e.g., one or more selected from nitrogen and noble gases) are mixed. Examples of a noble gas include argon. Moreover, nitrogen, a noble gas, or a mixture of two or more selected from nitrogen and noble gases may be used for the atmosphere.

The atmosphere of each of the temperature rising step and the temperature retaining step preferably contains little moisture. The dew point of the atmosphere is preferably lower than or equal to −50° C., further preferably lower than or equal to −80° C., for example. Dry air can be suitably used for the temperature rising step and the temperature retaining step. When the concentrations of impurities such as CH₄, CO, CO₂, and H₂ in the atmosphere are each lower than or equal to 5 ppb (parts per billion), entry of the impurities into a material can sometimes be inhibited.

A method in which a gas is continuously introduced into the treatment chamber used for the heat treatment can be employed. This method can be regarded as flowing a gas into the treatment chamber. In that case, the flow rate of the gas is, for example, higher than or equal to 0.1 L/min and lower than or equal to 0.7 L/min per liter of volume of the treatment chamber. In the case where the capacity of the treatment chamber is 40 L, the flow rate is preferably 10 L/min or in the neighborhood thereof. As the gas, for example, an oxygen gas, dry air, a nitrogen gas, a noble gas, or a mixed gas of two or more selected from these gases can be used.

A method may be employed in which after the atmosphere in the treatment chamber is replaced with a desired gas, the gas is prevented from entering and exiting from the treatment chamber. For example, the atmosphere in the treatment chamber can be replaced with an oxygen-containing gas and the gas can be prevented from entering and exiting from the treatment chamber. Alternatively, the gas may be introduced after the pressure in the treatment chamber is reduced. Specifically, the pressure in the treatment chamber is reduced to −970 hPa as measured by a differential pressure gauge, and then the gas is introduced until the pressure reaches 50 hPa, for example.

After the temperature retaining step, the object is cooled down in the cooling step. The time of the cooling step is longer than or equal to 15 minutes and shorter than or equal to 50 hours, for example. The cooling step may be performed by natural cooling. The temperature does not necessarily need to decrease to room temperature as long as it decreases to a temperature acceptable to the next step.

The atmosphere of the cooling step preferably contains oxygen. Examples of an oxygen-containing atmosphere include an oxygen atmosphere, a dry air atmosphere, an air atmosphere, and an atmosphere in which oxygen and another gas (e.g., one or more selected from nitrogen and noble gases) are mixed. Moreover, nitrogen, a noble gas, or a mixture of two or more selected from nitrogen and noble gases may be used for the atmosphere.

In the cooling step, a gas may be introduced into the treatment chamber. Alternatively, a gas may be continuously introduced into the treatment chamber in the cooling step. As the gas, an oxygen gas, dry air, a nitrogen gas, a noble gas, a mixed gas of two or more selected from these gases, or the like can be used.

In the cooling step, the temperature in the treatment chamber is controlled using a heater or the like so that the temperature can be gradually decreased from the temperature of the temperature retaining step. In the cooling step, heating may be performed to a temperature higher than room temperature and lower than the temperature of the temperature retaining step.

In the cooling step, cooling may be performed at room temperature instead of heating using a heater or the like.

The gas used in the cooling step may be heated to a temperature higher than room temperature. Alternatively, the gas used in the cooling step may be cooled down to a temperature lower than room temperature. Alternatively, one or both of the heat treatment apparatus and the treatment chamber may be cooled down using a cooling solvent such as cooling water. For example, cooling is performed by circulating cooling water around the perimeter of the treatment chamber.

In the heat treatment, the temperature rising step and the temperature retaining step may be performed in the same treatment chamber as the cooling step. Alternatively, the temperature rising step and the temperature retaining step may be performed in a different treatment chamber from the cooling step.

In the case where a rotary kiln is used for the heat treatment, the temperature rising step, the temperature retaining step, and the cooling step can be successively performed in the rotary kiln. Alternatively, the cooling step or part of the cooling step may be performed outside the rotary kiln.

The case of using a roller hearth kiln is described. The roller hearth kiln preferably includes at least three regions: a region where the temperature rising step is performed (hereinafter, a temperature rising zone), a region where the temperature retaining step is performed (hereinafter, a temperature retaining zone), and a region where the cooling step is performed (hereinafter, a cooling zone), for example. The mixed material prepared in Step S12 is put in a heat-resistant container such as a sagger, and is transferred sequentially to the temperature rising zone, the temperature retaining zone, and the cooling zone of the roller hearth kiln.

A container used at the time of the heating is preferably a crucible made of aluminum oxide or a sagger made of aluminum oxide. A crucible made of aluminum oxide has a material property that hardly allows the entry of impurities. In this embodiment, a sagger made of aluminum oxide with a purity of 99.9% is used. Note that the heating is preferably performed with the crucible or the sagger covered with a lid, in which case volatilization of a material can be prevented.

After the heating, the heated material is crushed as needed and then may be made to pass through a sieve. Before collection of the heated material, the material may be moved from the crucible to a mortar. As the mortar, a mortar made of zirconium oxide or agate is suitably used. Note that heating conditions equivalent to those in Step S13 can be employed in a later-described heating step other than Step S13.

### <Step S14>

Through the above steps, lithium cobalt oxide (LiCoO₂) can be synthesized as shown in Step S14 in FIG. 16B. The lithium cobalt oxide (LiCoO₂) shown in Step S14 can be referred to as a composite oxide. Note that the lithium cobalt oxide (LiCoO₂) shown in Step S14 may be obtained after particle size distribution is adjusted by performing a crushing step and a classification step after Step S13.

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S15>

Next, as Step S15 shown in FIG. 16A, the lithium cobalt oxide that is a starting material is heated. The heating in Step S15 is the first heating performed on the lithium cobalt oxide and thus is sometimes referred to as initial heating in this specification and the like. The heating is performed before Step S31 described below, and thus is sometimes referred to as preheating or pretreatment.

By the initial heating, a lithium compound or the like unintentionally remaining on the surface of the lithium cobalt oxide is extracted. In addition, an effect of increasing the crystallinity of the inner portion can be expected. Although the lithium source and/or the cobalt source prepared in Step S11 and the like might contain impurities, impurities in the lithium cobalt oxide that is a starting material can be reduced by the initial heating. Note that the effect of increasing the crystallinity of the inner portion is, for example, an effect of reducing distortion, a shift, or the like derived from differential shrinkage or the like of the lithium cobalt oxide formed in Step S14.

Through the initial heating, an effect of smoothing the surface of the lithium cobalt oxide is obtained. Furthermore, through the initial heating, an effect of reducing a crack, a crystal defect, or the like included in the lithium cobalt oxide is obtained.

For the initial heating, a lithium source, an additive element source, or a material functioning as a fusing agent is not necessarily separately prepared.

When the heating time in this step is too short, a sufficient effect is not obtained, but when the heating time is too long, the productivity is lowered. For example, as an appropriate range of the heating time, any of the heating conditions described for Step S13 can be selected to perform this step. The heating temperature in Step S15 is preferably lower than the temperature in Step S13 so that the crystal structure of the composite oxide is maintained. The heating time in Step S15 is preferably shorter than the time in Step S13 so that the crystal structure of the composite oxide is maintained. For example, the heating is preferably performed at higher than or equal to 700° C. and lower than or equal to 1000° C. (further preferably higher than or equal to 800° C. and lower than or equal to 900° C.) for longer than or equal to 1 hour and shorter than or equal to 20 hours (further preferably longer than or equal to 1 hour and shorter than or equal to 5 hours).

The heating in Step S13 might cause a temperature difference between the surface and the inner portion of the lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15; in other words, the distortion energy is probably equalized by the initial heating in Step S15. When the distortion energy is equalized, the distortion in the lithium cobalt oxide is relieved. Accordingly, the surface of the lithium cobalt oxide becomes smooth. It can also be said that surface improvement is achieved. In other words, Step S15 can reduce the differential shrinkage caused in the lithium cobalt oxide and make the surface of the composite oxide smooth.

Such differential shrinkage might cause a micro shift in the lithium cobalt oxide, such as a shift in a crystal. To reduce this shift, Step S15 is preferably performed. Performing Step S15 can distribute a shift uniformly in the composite oxide (reduce the shift in a crystal or the like which is caused in the composite oxide or align crystal grains). As a result, the surface of the composite oxide becomes smooth.

The use of lithium cobalt oxide with a smooth surface as a positive electrode active material can improve the safety of a secondary battery, suppress deterioration in charging and discharging, and prevent breakage in the positive electrode active material.

Note that Step S15 is not essential in one embodiment of the present invention; thus, an embodiment in which Step S15 is skipped is also included in one embodiment of the present invention.

### <Step S20>

Next, details of Step S20 of preparing the additive element A as an A source are described with reference to FIG. 16C and FIG. 16D.

### <Step S21>

Step S20 shown in FIG. 16C includes Step S21 to Step S23. In Step S21, the additive element A is prepared. As specific examples of the additive element A, one or more selected from magnesium, fluorine, nickel, aluminum, titanium, zirconium, vanadium, iron, manganese, chromium, niobium, arsenic, zinc, silicon, sulfur, phosphorus, and boron can be used. FIG. 16C shows an example of the case where a magnesium source (denoted as Mg source in the diagram) and a fluorine source (denoted as F source in the diagram) are prepared. Note that in Step S21, a lithium source may be separately prepared in addition to the additive element A.

When magnesium is selected as the additive element A, the additive element A source can be referred to as a magnesium source. As the magnesium source, magnesium fluoride (MgF₂), magnesium oxide (MgO), magnesium hydroxide (Mg(OH)₂), magnesium carbonate (MgCO₃), or the like can be used. Two or more of these magnesium sources may be used.

When fluorine is selected as the additive element A, the additive element A source can be referred to as a fluorine source. As the fluorine source, it is possible to use, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VFs), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), or sodium aluminum hexafluoride (Na₃AlF₆). In particular, lithium fluoride is preferable because it is easily melted in a later-described heating step owing to its relatively low melting point of 848° C. That is, lithium fluoride can function as a fusing agent (also referred to as a flux agent).

Magnesium fluoride can be used as both the fluorine source and the magnesium source. Lithium fluoride can also be used as the lithium source. Another example of the lithium source that can be used in Step S21 is lithium carbonate.

The fluorine source may be a gas; fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in the later-described heating step. Two or more of fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed such that LiF:MgF₂ is approximately 65:35 (molar ratio), the effect of lowering the melting point is maximized. When the proportion of lithium fluoride is too high, cycle performance might deteriorate because of an excessive amount of lithium. Therefore, the molar ratio of lithium fluoride to magnesium fluoride is preferably LiF:MgF₂=x:1 (0≤x≤1.9), further preferably LiF: MgF₂=x:1(0.1<x<0.5), still further preferably LiF:MgF₂=x:1(x=0.33 or an approximate value thereof). Note that in this specification and the like, the expression “an approximate value of a given value” means greater than 0.9 times and less than 1.1 times the given value, unless otherwise specified.

### <Step S22>

Next, in Step S22 shown in FIG. 16C, the magnesium source and the fluorine source are ground and mixed. Any of the conditions for grinding and mixing that are described for Step S12 can be selected to perform this step.

### <Step S23>

Subsequently, in Step S23 shown in FIG. 16C, the materials ground and mixed in the above step are collected to give the additive element A source (A source). Note that the additive element A source in Step S23 contains a plurality of starting materials and can also be referred to as a mixture.

As for the particle diameter of the mixture, the median diameter is preferably greater than or equal to 100 nm and less than or equal to 10 μm, further preferably greater than or equal to 300 nm and less than or equal to 5 μm. Also when one kind of material is used as the additive element A source, the median diameter is preferably greater than or equal to 100 nm and less than or equal to 10 μm, further preferably greater than or equal to 300 nm and less than or equal to 5 μm.

A mixture pulverized in Step S22 (which may contain only one kind of the additive element) is easily attached to the surface of the lithium cobalt oxide uniformly when mixed with the lithium cobalt oxide in a later step. The mixture is preferably attached uniformly to the surface of the lithium cobalt oxide, in which case the additive element is easily distributed or dispersed uniformly in the surface portion of the composite oxide after heating.

### <Step S21a>

A process different from that in FIG. 16C is described with reference to FIG. 16D. Step S20 shown in FIG. 16D includes Step S21a to Step S23.

In Step S21a shown in FIG. 16D, four kinds of additive element A sources to be added to the lithium cobalt oxide are prepared. In other words, FIG. 16D is different from FIG. 16C in the kinds of the additive element A sources. A lithium source may be separately prepared in addition to the additive element A sources.

As the four kinds of additive element A sources, a magnesium source (denoted as Mg source in the diagram), a fluorine source (denoted as F source in the diagram), a nickel source (denoted as Ni source in the diagram), and an aluminum source (denoted as Al source in the diagram) are prepared. The magnesium source and the fluorine source can be selected from the compounds and the like described with reference to FIG. 16C. As the nickel source, nickel oxide, nickel hydroxide, or the like can be used. As the aluminum source, aluminum oxide, aluminum hydroxide, or the like can be used.

### <Step S22> and <Step S23>

Next, Step S22 and Step S23 shown in FIG. 16D are similar to Step S22 and Step S23 described with reference to FIG. 16C.

### <Step S31>

Next, in Step S31 shown in FIG. 16A, the lithium cobalt oxide that has been subjected to Step S15 (initial heating) and the additive element A source (A source) are mixed. Here, the ratio of the atomic ratio of cobalt A_{Co} in the lithium cobalt oxide that has been subjected to Step S15 to the atomic ratio of magnesium A_{Mg} contained in the additive element A is preferably A_{Co}: A_{Mg}=100:y (0.1≤y≤6), further preferably A_{Co}: A_{Mg}=100:y (0.3≤y≤3). Since the lithium cobalt oxide that has been subjected to the initial heating has a smooth surface, the additive element A can be uniformly added. Thus, the initial heating (Step S15) is preferably performed not after the addition of the additive element A but before the addition of the additive element A.

When nickel is selected as the additive element A, the mixing in Step S31 is preferably performed such that the number of nickel atoms in the nickel source is greater than or equal to 0.05% and less than or equal to 4% of the number of cobalt atoms in the lithium cobalt oxide that has been subjected to Step S15. When aluminum is selected as the additive element A, the mixing in Step S31 is preferably performed such that the number of aluminum atoms in the aluminum source is greater than or equal to 0.05% and less than or equal to 4% of the number of cobalt atoms in the lithium cobalt oxide that has been subjected to Step S15.

The conditions of the mixing in Step S31 are preferably milder than those of the grinding and mixing in Step S12 not to damage the lithium cobalt oxide shape. For example, conditions with a smaller number of rotations or a shorter time than that of the mixing in Step S12 are preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### <Step S32>

Next, in Step S32 in FIG. 16A, the materials mixed in the above manner are collected, whereby a mixture 903 is obtained.

### <Step S33>

Then, in Step S33 shown in FIG. 16A, the mixture 903 is heated. The heating temperature in Step S33 is preferably higher than or equal to 800° C. and lower than or equal to 1100° C., further preferably higher than or equal to 800° C. and lower than or equal to 950° C., still further preferably higher than or equal to 850° C. and lower than or equal to 900° C. The heating time in Step S33 is longer than or equal to 1 hour and shorter than or equal to 100 hours and is preferably longer than or equal to 1 hour and shorter than or equal to 10 hours. The lower limit of the heating temperature in Step S33 needs to be higher than or equal to the temperature at which a reaction between the lithium cobalt oxide and the additive element A source proceeds. The temperature at which the reaction proceeds is the temperature at which interdiffusion of the elements contained in the lithium cobalt oxide and the additive element A source occurs, and may be lower than the melting temperatures of these materials. In the case where an oxide is described as an example, solid phase diffusion occurs at the temperature of 0.757 times the melting temperature Tₘ (Tammann temperature Ta); thus, the heating temperature in Step S33 is higher than or equal to 500° C.

For example, in the case where LiF and MgF₂ are included as the additive element A source, the lower limit of the heating temperature in Step S33 is preferably higher than or equal to 742° C. because the eutectic point of LiF and MgF₂ is around 742° C. as shown in FIG. 4. Note that the reaction proceeds more easily at a temperature higher than or equal to the temperature at which one or more selected from the starting materials of the mixture 903 are melted.

The mixture 903 obtained by mixing such that LiCoO₂: LiF: MgF_{2=100:0.33:1} (molar ratio) exhibits an endothermic peak at around 830° C. in DSC measurement as shown in FIG. 5. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature (the melting point: 1130° C.) of the lithium cobalt oxide. At a temperature around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In addition, at the time of heating the mixture 903, the partial pressure of fluorine or a fluoride originating from the fluorine source or the like is preferably controlled to fall within an appropriate range.

In the formation method described in this embodiment, some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and formation of the positive electrode active material having favorable characteristics.

Since LiF in a gas phase has a specific gravity less than that of oxygen, heating might volatilize LiF and in that case, LiF in the mixture 903 decreases. In this case, the function of a fusing agent deteriorates. Therefore, heating is preferably performed while volatilization of LiF is inhibited. Note that even when LiF is not used as the fluorine source or the like, Li at the surface of LiCoO₂ and F of the fluorine source might react to produce LiF, which might be volatilized. Thus, such inhibition of volatilization is needed also when a fluoride having a higher melting point than LiF is used.

In view of the above, the mixture 903 is preferably heated with a container in which the mixture 903 is put covered with a lid. Such heating can inhibit volatilization of LiF in the mixture 903.

The heating in this step is preferably performed such that the mixtures 903 are not adhered to each other. Adhesion of the mixtures 903 during the heating might decrease the area of contact with oxygen in the atmosphere and inhibit a diffusion path of the additive element (e.g., fluorine), thereby hindering distribution of the additive elements (e.g., magnesium and fluorine) in the surface portion.

Uniform distribution of the additive element (e.g., fluorine) in the surface portion leads to a smooth positive electrode active material with little unevenness. Thus, it is preferable that the mixtures 903 not be adhered to each other in order to allow the smooth surface obtained through the heating in Step S15 to be maintained or to be smoother in this step.

### <Step S34>

Next, in Step S34 shown in FIG. 16A, the heated material is collected and then crushed as needed to give the positive electrode active material 100 containing the additive element A. Here, the collected positive electrode active material 100 may be made to pass through a sieve. Through the above process, the positive electrode active material 100 with a median diameter of less than or equal to 12 μm (preferably less than or equal to 10.5 μm, further preferably less than or equal to 8 μm) can be formed.

### <Example 2 of Method for Forming Positive Electrode Active Material>

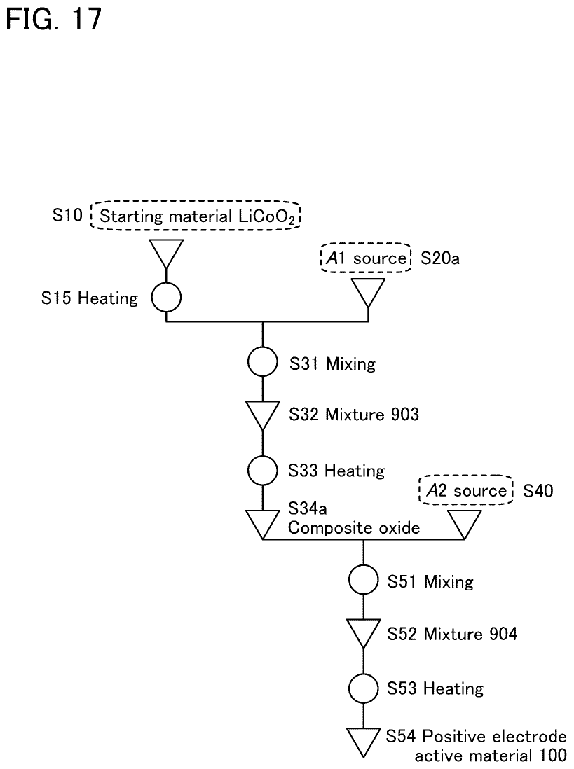

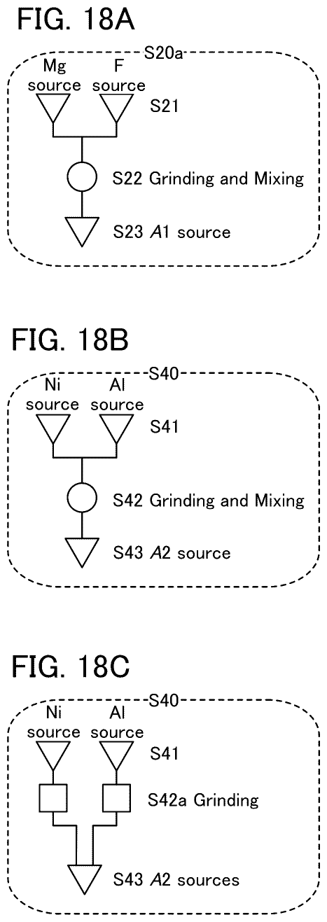

Another example of a method for forming the positive electrode active material (Example 2 of method for forming positive electrode active material) will be described with reference to FIG. 17 and FIG. 18. Although Example 2 of method for forming positive electrode active material is different from Example 1 of method for forming positive electrode active material described above in the number of times of adding the additive element and a mixing method, the description of Example 1 of method for forming positive electrode active material can be referred to for the description except for the above. Note that in <Example 2 of method for forming positive electrode active material>, the additive element X described in Embodiment 1 is referred to as an additive element A1. In addition, the additive element Y and the additive element Z described in Embodiment 1 are collectively referred to as an additive element A2.

### <Step S10> and <Step S15>

Step S10 and Step S15 in FIG. 17 are performed as in FIG. 16A to prepare lithium cobalt oxide that has been subjected to the initial heating. Note that Step S15 is not essential in one embodiment of the present invention; thus, an embodiment in which Step S15 is skipped is also included in one embodiment of the present invention.

### <Step S20a>

Next, as shown in Step S20a, a first additive element A1 source (denoted as A1 source in the diagram) is prepared. Step S20a is described in detail with reference to FIG. 18A.

### <Step S21>

In Step S21 shown in FIG. 18A, the first additive element A1 source (denoted as A1 source in the diagram) is prepared. The Al source can be selected from the additive elements A described for Step S21 shown in FIG. 16C. For example, one or more selected from magnesium, fluorine, and calcium can be used as the additive element A1. FIG. 18A shows an example of the case where a magnesium source (denoted as Mg source in the diagram) and a fluorine source (denoted as F source in the diagram) are used as the additive element A1.

Step S21 to Step S23 shown in FIG. 18A can be performed under conditions similar to those in Step S21 to Step S23 shown in FIG. 16C. As a result, the additive element A1 source (A1 source) can be obtained in Step S23.

Steps S31 to S33 shown in FIG. 17 can be performed under conditions similar to those in Steps S31 to S33 shown in FIG. 16A.

### <Step S34a>

Next, the material heated in Step S33 is collected to obtain lithium cobalt oxide containing the additive element A1. Here, the lithium cobalt oxide is also called a second composite oxide to be distinguished from the lithium cobalt oxide that has been subjected to Step S15 (first composite oxide).

### <Step S40>

In Step S40 shown in FIG. 17, a second additive element A2 source (denoted as A2 source in the diagram) is prepared. Step S40 is described with reference to also FIG. 18B and FIG. 18C.

### <Step S41>

In Step S40 shown in FIG. 18B, the second additive element A2 source (denoted as A2 source in the diagram) is prepared. The A2 source can be selected from the additive elements A described for Step S20 shown in FIG. 16C. For example, one or more selected from nickel, titanium, boron, zirconium, and aluminum can be suitably used as the additive element A2. FIG. 18B shows an example of the case where a nickel source and an aluminum source are used as the additive element A2.

Step S41 to Step S43 shown in FIG. 18B can be performed under conditions similar to those in Step S21 to Step S23 shown in FIG. 16C. As a result, the additive element A2 source (denoted as A2 source in the diagram) can be obtained in Step S43.

FIG. 18C showing Step S41 to Step S43 is a variation example of FIG. 18B. A nickel source (denoted as Ni source in the diagram) and an aluminum source (denoted as Al source in the diagram) are prepared in Step S41 shown in FIG. 18C and are separately ground in Step S42a.

Accordingly, a plurality of the second additive element A2 sources (denoted as A2 sources in the diagram) are prepared in Step S43. As described above, Step S40 in FIG. 18C is different from Step S40 in FIG. 18B in that the additive element sources are separately ground in Step S42a.

### <Step S51> to <Step S53>

Next, Step S51 to Step S53 shown in FIG. 17 can be performed under conditions similar to those in Step S31 to Step S34 shown in FIG. 16A. The heating in Step S53 is preferably performed under such condition as a lower temperature and/or a shorter time than those of the heating in Step S33 shown in FIG. 17. Specifically, the heating temperature is preferably higher than or equal to 800° C. and lower than or equal to 950° C., further preferably higher than or equal to 820° C. and lower than or equal to 870° C., still further preferably 850° C.±10° C. The heating time is preferably longer than or equal to 0.5 hours and shorter than or equal to 8 hours, further preferably longer than or equal to 1 hour and shorter than or equal to 5 hours.

When nickel is selected as the additive element A2, the mixing in Step S51 is preferably performed such that the number of nickel atoms in the nickel source is greater than or equal to 0.05% and less than or equal to 4% of the number of cobalt atoms in the lithium cobalt oxide that has been subjected to Step S15. When aluminum is selected as the additive element A2, the mixing in Step S51 is preferably performed such that the number of aluminum atoms in the aluminum source is greater than or equal to 0.05% and less than or equal to 4% of the number of cobalt atoms in the lithium cobalt oxide that has been subjected to Step S15.

### <Step S54>

Next, in Step S54 shown in FIG. 17, the heated material is collected, whereby the positive electrode active material 100 containing the additive element A1 and the additive element A2 is obtained. The collected material may be crushed as needed. Through the above process, the positive electrode active material 100 (composite oxide) with a median diameter of less than or equal to 12 μm (preferably less than or equal to 10.5 μm, further preferably less than or equal to 8 μm) can be formed.

In the example 2 of the formation method described above, introduction of the additive element to the lithium cobalt oxide is divided into introduction of the first additive element A1 and that of the second additive element A2 as shown in FIG. 17 and FIG. 18. When the additive elements are separately introduced, the additive element distribution in the depth direction can vary. For example, the first additive element can be distributed such that its concentration is higher in the surface portion than in the inner portion, and the second additive element can be distributed such that its concentration is higher in the inner portion than in the surface portion. The positive electrode active material 100 formed through the steps in FIG. 16A and FIG. 16D has an advantage of being formed at low cost since a plurality of kinds of additive element A sources are added at the same time. Meanwhile, although the formation cost of the positive electrode active material 100 formed through FIG. 17 and FIG. 18 is relatively high since a plurality of kinds of additive element A sources are added in a plurality of steps, the distribution of each of the additive elements A in the depth direction can be more accurately controlled, which is preferable.

### Embodiment 3

In this embodiment, components included in a secondary battery will be described anew.

### <Positive Electrode>

A positive electrode includes a positive electrode active material layer and a positive electrode current collector. The positive electrode active material layer includes a positive electrode active material and may further contain at least one of a conductive material and a binder. As the positive electrode active material, any of the positive electrode active materials described in Embodiment 1 can be used.

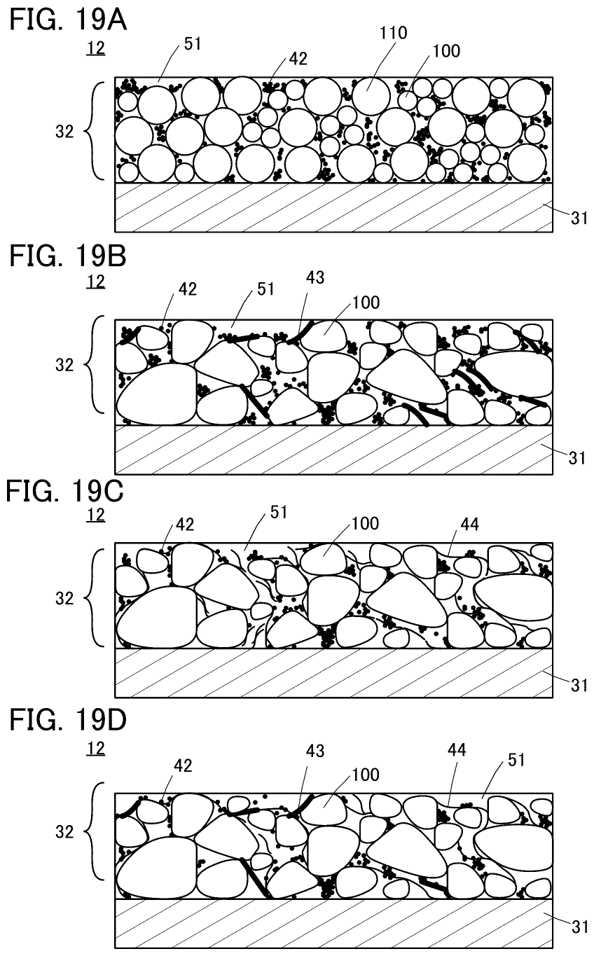

FIG. 19A shows an example of a schematic view of a cross section of the positive electrode 12.

Metal foil can be used as the positive electrode current collector 31, for example. Materials and the like that can be used for the positive electrode current collector 31 will be described later. The positive electrode can be formed by applying slurry onto the positive electrode current collector 31 and drying the slurry. Note that pressing may be performed after the drying. The positive electrode is obtained by forming the positive electrode active material layer 32 over the positive electrode current collector 31.

Slurry includes an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

For the positive electrode active material 100, any of the materials described in Embodiment 1 or Embodiment 2 can be used. Note that for the positive electrode active material 100, two or more kinds of materials having different particle diameters can be used as long as the materials show little deterioration due to discharging and charging even at a high charge voltage. Note that FIG. 19A shows an example in which the positive electrode active material 100 has a spherical shape.

In FIG. 19A, in addition to the positive electrode active material 100, the positive electrode active material 100 with a large median diameter is included. The median diameter of the positive electrode active material 100 is preferably greater than or equal to 1.2 times and less than or equal to 3 times, further preferably greater than or equal to 1.5 times and less than or equal to 2 times the median diameter of the positive electrode active material 100. The content of the positive electrode active material 100 with a large median diameter is preferably greater than or equal to 1 times and less than or equal to 9 times, further preferably greater than or equal to 6 times and less than or equal to 8 times the content of the positive electrode active material 100. Specific examples of a carbon material that can be used as a conductive material 42 are as described in Embodiment 1. FIG. 19A illustrates the case where AB is used as the conductive material 42.

The binder is mixed in the slurry for fixing the positive electrode current collector 31, the positive electrode active material 100, the positive electrode active material 100, and a conductive material 43. The binder is also referred to as a binding agent. Since the binder is a high molecular material, a large amount of the binder lowers the proportion of the active material in the positive electrode, thereby reducing the discharge capacity of the secondary battery. Therefore, the amount of the binder mixed is preferably reduced to a minimum. Thus, the binder is not illustrated in FIG. 19A. A material and the like that can be used for the binder will be described later.

The positive electrode active material layer 32 includes a space 51 filled with neither the positive electrode active material, the conductive material, nor the binder. The space 51 is filled with an electrolyte solution in some cases.

FIG. 19B to FIG. 19D show variation examples of the positive electrode active material layer illustrated in FIG. 19A. FIG. 19B to FIG. 19D show examples in which the positive electrode active material 100 has a polygon shape with rounded corners. Also in FIG. 19B to FIG. 19D, the space 51 may be included, and the space 51 may be filled with an electrolyte solution.

FIG. 19B shows an example of the positive electrode 12 including not only the conductive material 43 but also the conductive material 42 as conductive materials. Specific examples of a carbon material that can be used as each of the conductive material 42 and the conductive material 43 are as described in Embodiment 1. FIG. 19B illustrates the case where AB is used as the conductive material 42, and graphene or a graphene compound is used as the conductive material 43.

Note that in the step of obtaining the electrode slurry, the conductive material 42 and the conductive material 43 may be mixed, or the conductive material 43 may be added after the conductive material 42 and a dispersant are mixed. Before addition of the conductive material 43, the conductive material 43 and a dispersant may be mixed.

In the positive electrode 12, the weight of the conductive material 43 is preferably greater than or equal to 1.5 times and less than or equal to 20 times, further preferably greater than or equal to 2 times and less than or equal to 9.5 times the weight of the conductive material 42. In other words, the weight of the AB is preferably greater than or equal to 1.5 times and less than or equal to 20 times, further preferably greater than or equal to 2 times and less than or equal to 9.5 times the weight of graphene.

When the mixing ratio of the graphene to the AB is in the above range, the AB exhibits excellent dispersion stability and an aggregated portion is unlikely to be generated at the time of preparing slurry. Furthermore, when the graphene and the AB are mixed in the above range, the electrode density can be higher than that of a positive electrode using only AB as the conductive material. As the electrode density becomes higher, the capacity per unit weight can become higher. Specifically, the density of the positive electrode active material layer measured by gravimetry can be higher than or equal to 3.5 g/cc.

Although the electrode density is lower than that of a positive electrode using only graphene as the conductive material, the mixing ratio of graphene to AB in the above range enables a secondary battery to be charged rapidly. Thus, the use of such a mixture of conductive materials for in-vehicle secondary batteries is particularly effective.

FIG. 19C shows an example of the positive electrode 12 including a conductive material 44 instead of the conductive material 43. Specific examples of a carbon material that can be used as each of the conductive material 42 and the conductive material 44 are as described in Embodiment 1. FIG. 19C illustrates the case where AB is used as the conductive material 42, and carbon fiber is used as the conductive material 44. With the use of the carbon fiber, aggregation of the AB can be prevented and the dispersibility can be increased.

FIG. 19D shows an example of the positive electrode 12 including the conductive material 42, the conductive material 43, and the conductive material 44. Specific examples of a carbon material that can be used as each of the conductive material 42 to the conductive material 44 are as described in Embodiment 1. The example is shown in which AB is used as the conductive material 42, graphene or a graphene compound is used as the conductive material 43, and carbon fiber is used as the conductive material 44. With the use of both the graphene and the carbon fiber, aggregation of the AB can be prevented and the dispersibility can be further increased.

The positive electrode in any one of FIG. 19A to FIG. 19D is used, and a stack in which a separator is provided over the positive electrode and a negative electrode is provided over the separator is set in an exterior body or the like (a metal can may be used instead of the exterior body) and the exterior body is filled with an electrolyte solution, whereby a secondary battery can be fabricated.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, a water-soluble polymer is preferably used. As the water-soluble polymer, a polysaccharide can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is further preferable that such a water-soluble polymer be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

A plurality of the above-described materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose, or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to inhibit the decomposition of an electrolyte solution. Here, a “passivation film” refers to a film without electric conductivity or a film with extremely low electric conductivity; for example, a passivation film formed on the active material surface can inhibit the decomposition of an electrolyte solution at a battery reaction potential. It is further desirable that the passivation film can conduct lithium ions while inhibiting electrical conduction.

### <Positive Electrode Current Collector>

For the current collector, a material that has high conductivity, such as a metal like stainless steel, gold, platinum, aluminum, or titanium, or an alloy thereof can be used. It is preferable that a material used for the positive electrode current collector not be eluted at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

### <Negative Electrode>

The negative electrode includes a negative electrode active material layer and a negative electrode current collector. The negative electrode active material layer includes a negative electrode active material and may further include a conductive material and a binder.

### <Negative Electrode Active Material>

As the negative electrode active material, for example, an alloy-based material or a carbon material can be used.

For the negative electrode active material, an element that enables charge and discharge reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used for the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, “SiO” refers to silicon monoxide, for example. SiO can alternatively be expressed as SiOx. Here, it is preferable that x be 1 or an approximate value of 1. For example, x is preferably greater than or equal to 0.2 and less than or equal to 1.5, and preferably greater than or equal to 0.3 and less than or equal to 1.2.

As the carbon material, graphite, graphitizing carbon (soft carbon), non-graphitizing carbon (hard carbon), carbon fiber (a carbon nanotube), graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used here. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of lithium metal (higher than or equal to 0.05 V and lower than or equal to 0.3 V vs. Li/Li⁺) when lithium ions are inserted into graphite (while a lithium-graphite intercalation compound is formed). For this reason, a lithium ion battery using graphite can have a high operating voltage. In addition, graphite is preferred because of its advantages such as relatively high capacity per unit volume, relatively small volume expansion, low cost, and a higher level of safety than that of lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), or molybdenum dioxide (MoO₂) can be used.

Alternatively, as the negative electrode active material, Li₃₋ₓMₓN (M=Co, Ni, or Cu) with a Li₃N structure, which is a nitride of lithium and a transition metal, can be used. For example, Li_{2.6}Co_{0.4}N is preferable because of its high discharge capacity (900 mAh/g and 1890 mAh/cm³ per weight of the active material).

A nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that even in the case of using a material containing lithium ions as a positive electrode active material, a nitride of lithium and a transition metal can be used as the negative electrode active material by extracting the lithium ions contained in the positive electrode active material in advance.

A material that causes a conversion reaction can also be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

As another mode of the negative electrode, a negative electrode that does not contain a negative electrode active material after completion of the fabrication of the battery may be used. The negative electrode that does not contain a negative electrode active material can be, for example, a negative electrode which includes only a negative electrode current collector after completion of the fabrication of the battery and in which lithium ions extracted from the positive electrode active material due to charging of the battery are deposited as a lithium metal over the negative electrode current collector and form the negative electrode active material layer. A battery including such a negative electrode is referred to as a negative electrode-free (anode-free) battery, a negative electrodeless (anodeless) battery, or the like in some cases.

In the case of using the negative electrode that does not contain a negative electrode active material, a film for making lithium deposition uniform may be provided over the negative electrode current collector. For the film for making lithium deposition uniform, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over the negative electrode current collector relatively easily, and thus is suitable for the film for making lithium deposition uniform. Moreover, as the film for making lithium deposition uniform, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

In the case of using the negative electrode that does not contain a negative electrode active material, a negative electrode current collector having projections and depressions can be used. In the case of using the negative electrode current collector having projections and depressions, a depression of the negative electrode current collector becomes a cavity in which lithium contained in the negative electrode current collector is easily deposited, so that the lithium can be inhibited from having a dendrite-like shape when being deposited.

For the conductive material and the binder that can be included in the negative electrode active material layer, materials similar to those for the conductive material and the binder that can be included in the positive electrode active material layer can be used.

### <Negative Electrode Current Collector>

For the negative electrode current collector, copper or the like can also be used in addition to a material similar to that of the positive electrode current collector. Note that a material that does not alloy with carrier ions of lithium or the like is preferably used for the negative electrode current collector.

### <Electrolyte Solution>

As one mode, an electrolyte solution containing an organic solvent and lithium salt (also referred to as an electrolyte) dissolved in the organic solvent can be used. As the organic solvent of the electrolyte solution, an aprotic organic solvent is preferably used. For example, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination at an appropriate ratio.

Alternatively, the use of one or more ionic liquids (room temperature molten salts) which have features of non-flammability and non-volatility as the organic solvent can prevent explosion, ignition, and the like of a power storage device even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the lithium salt (electrolyte) dissolved in the above-described solvent, one of lithium salts such as LiPF₆, LiClO₄, LiAsF₆, LiBF₄, LiAlCl₄, LISCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate) borate (Li(C₂O₄)₂, LiBOB) can be used, or two or more of these lithium salts can be used in an appropriate combination at an appropriate ratio.

Furthermore, an additive agent such as vinylene carbonate, propane sultone (PS), tert-butylbenzene (TBB), fluoroethylene carbonate (FEC), lithium bis(oxalate) borate (LiBOB), or a dinitrile compound such as succinonitrile or adiponitrile may be added to the electrolyte solution. The concentration of such an additive agent in the solvent in which the electrolyte is dissolved is, for example, higher than or equal to 0.1 wt % and lower than or equal to 5 wt %.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used. For example, a polymer having a polyalkylene oxide structure, such as polyethylene oxide (PEO); PVDF; polyacrylonitrile; and a copolymer containing any of them can be used. For example, PVDF-HFP, which is a copolymer of PVDF and hexafluoropropylene (HFP), can be used. The formed polymer may be porous.

### <Separator>

When the electrolyte includes an electrolyte solution, a separator is positioned between the positive electrode and the negative electrode. As the separator, a fiber containing cellulose such as paper; nonwoven fabric; a glass fiber; ceramics; a synthetic fiber using nylon (polyamide), vinylon (polyvinyl alcohol-based fiber), polyester, acrylic, polyolefin, or polyurethane; or the like can be used. The separator is preferably processed into a bag-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, deterioration of the separator in charging at high voltage and discharging can be inhibited and thus the reliability of the secondary battery can be increased. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### <Exterior Body>

For an exterior body included in the secondary battery, a metal material such as aluminum and/or a resin material can be used, for example. A film-like exterior body can also be used. As the film, it is possible to use, for example, a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body. An aluminum-containing film having a three-layer structure is sometimes referred to as an aluminum laminate film.

### Embodiment 4

In this embodiment, the appearance of a secondary battery will be described. The appearance may also be referred to as the shape.

### <Coin-Type Secondary Battery>

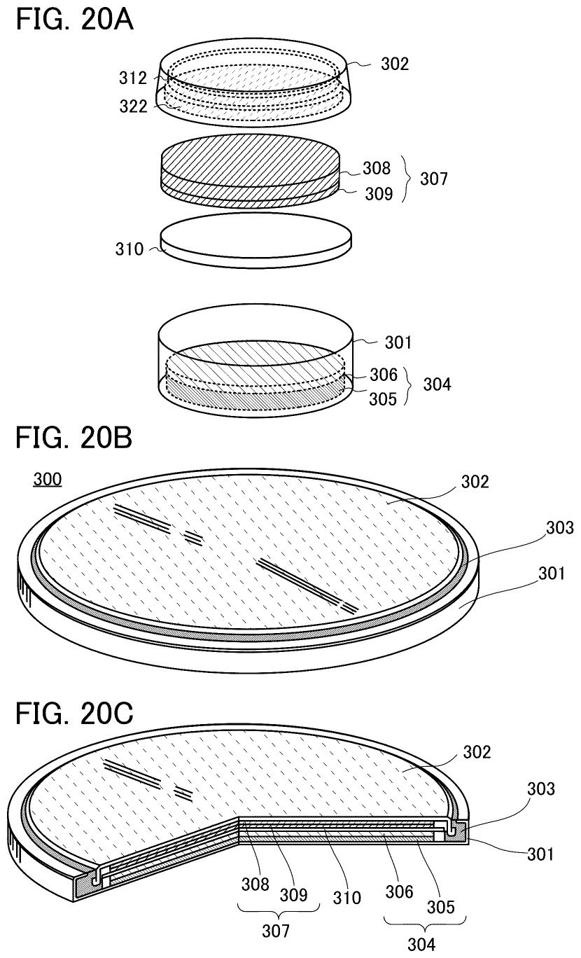

An example of a coin-type secondary battery is described. FIG. 20A is an exploded perspective view of a coin-type (single-layer flat type) secondary battery, FIG. 20B is an external view thereof, and FIG. 20C is a cross-sectional view thereof. Coin-type secondary batteries are mainly used in small electronic devices.

For easy understanding, FIG. 20A is a schematic view illustrating overlap (a vertical relation and a positional relation) between components. Thus, FIG. 20A and FIG. 20B do not completely correspond with each other.

In FIG. 20A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 20A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

FIG. 20B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte solution or the like. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 20C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

The coin-type secondary battery 300 including the above-described positive electrode 12 or the like can have high discharge capacity and improved safety.

### <Cylindrical Secondary Battery>

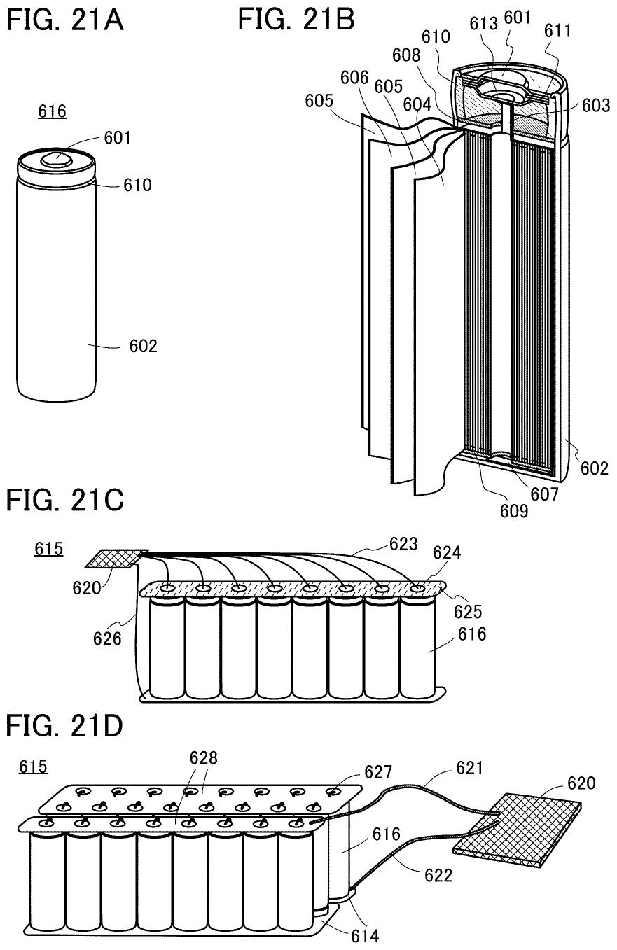

An example of a cylindrical secondary battery is described with reference to FIG. 21A. As illustrated in FIG. 21A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 21B is a diagram schematically illustrating a cross section of a cylindrical secondary battery. The cylindrical secondary battery illustrated in FIG. 21B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a central axis. One end of the battery can 602 is closed and the other end thereof is opened. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. Furthermore, an electrolyte solution (not illustrated) is injected inside the battery can 602 provided with the battery element. An electrolyte solution similar to that for the coin-type secondary battery can be used.

Since a positive electrode and a negative electrode that are used for a cylindrical storage battery are wound, active materials are preferably formed on both surfaces of a current collector.

The cylindrical secondary battery 616 including the above-described positive electrode 12 or the like can have high discharge capacity and improved safety.

A positive electrode terminal (positive electrode current collecting lead) 603 is connected to the positive electrode 604, and a negative electrode terminal (negative electrode current collecting lead) 607 is connected to the negative electrode 606. For the positive electrode terminal 603, a metal material such as aluminum can be used. For the negative electrode terminal 607, a metal material such as copper can be used. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramics or the like can be used for the PTC element.

FIG. 21C shows an example of a power storage system 615. The power storage system 615 includes a plurality of the secondary batteries 616. The positive electrodes of the secondary batteries are in contact with and electrically connected to conductors 624 isolated by an insulator 625. The conductors 624 are electrically connected to a control circuit 620 through wirings 623. The negative electrodes of the secondary batteries are electrically connected to the control circuit 620 through a wiring 626. As the control circuit 620, a charging and discharging control circuit for performing charging, discharging, and the like or a protection circuit for preventing overcharging and/or overdischarging can be used.

FIG. 21D shows an example of the power storage system 615. The power storage system 615 includes a plurality of the secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is unlikely to be influenced by the outside temperature.

In FIG. 21D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### <Other Structure Examples of Secondary Battery>

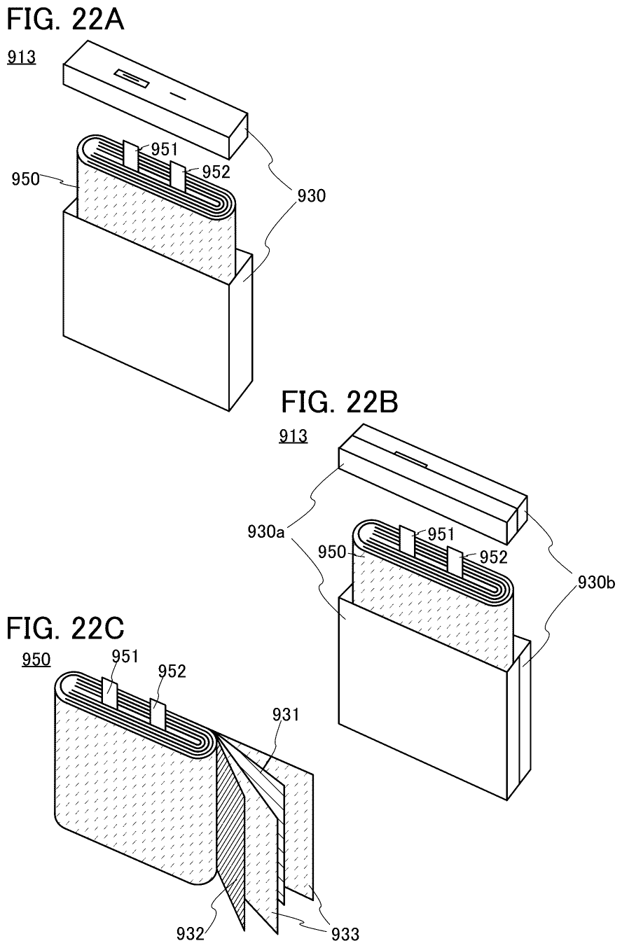

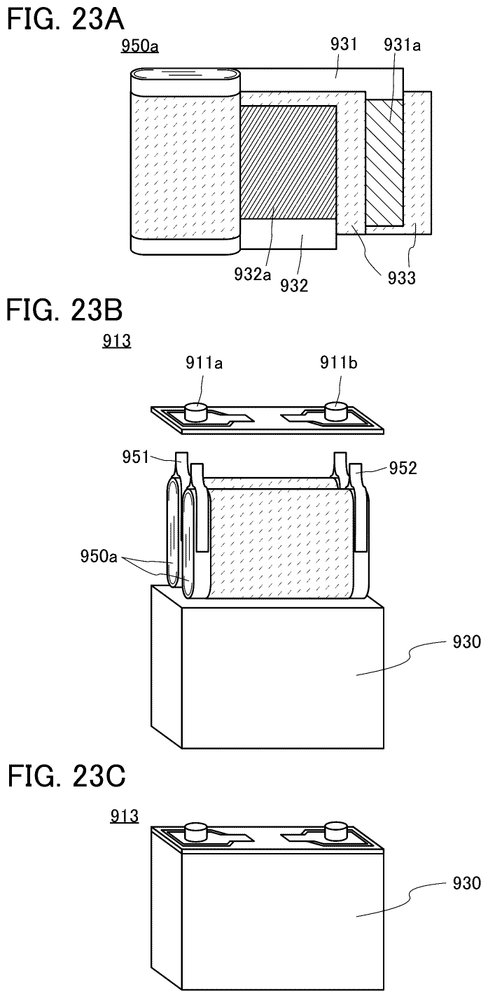

Structure examples of secondary batteries will be described with reference to FIG. 22 and FIG. 23.

A secondary battery 913 illustrated in FIG. 22A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 22A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a stack of a metal material and a resin material can be used.

Note that as illustrated in FIG. 22B, the housing 930 illustrated in FIG. 22A may be formed using a plurality of materials. For example, in the secondary battery 913 illustrated in FIG. 22B, a housing 930a and a housing 930b are attached to each other, and the wound body 950 is provided in a region surrounded by the housing 930a and the housing 930b.

For the housing 930a, a metal material (e.g., aluminum) or a stack of a metal material and a resin material can be used. As the resin material, an insulating material such as an organic resin can be used; thus, in particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material (e.g., aluminum) or a stack of a metal material and a resin material can be used.

FIG. 22C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

The wound body 950 including the above-described positive electrode 12 or the like enables high discharge capacity and improved safety.

The secondary battery 913 may include a wound body 950a illustrated in FIG. 23. The wound body 950a illustrated in FIG. 23A includes the negative electrode 931, the positive electrode 932, and the separators 933. The negative electrode 931 includes a negative electrode active material layer 931a. The positive electrode 932 includes a positive electrode active material layer 932a.

The wound body 950a including the above-described positive electrode 12 or the like enables high discharge capacity and improved safety.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 93 1a is preferably larger than that of the positive electrode active material layer 932a. The wound body 950a having such a shape is preferable because of its high level of safety and high productivity.

As illustrated in FIG. 23B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 23C, the wound body 950a and an electrolyte solution are covered with the housing 930, whereby the secondary battery 913 is completed. The housing 930 is preferably provided with a safety valve, an overcurrent protection element, and the like. The safety valve is a valve to be released when the internal pressure of the housing 930 reaches a predetermined pressure, in order to prevent the battery from exploding.

As illustrated in FIG. 23B, the secondary battery 913 may include a plurality of the wound bodies 950a. The use of the plurality of wound bodies 950a enables the secondary battery 913 to have higher discharge capacity. The description of the secondary battery 913 illustrated in FIG. 22A to FIG. 22C can be referred to for the other components of the secondary battery 913 illustrated in FIG. 23A and FIG. 23B.

### <Laminated Secondary Battery>

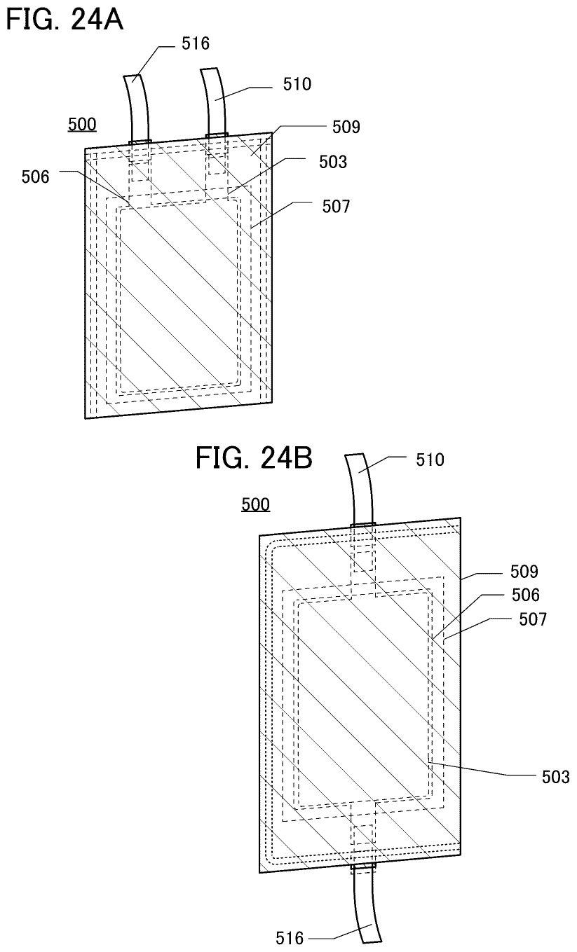

Next, examples of the appearance of a laminated secondary battery 500 are shown in FIG. 24A and FIG. 24B. FIG. 24A and FIG. 24B each illustrate the positive electrode 503, the negative electrode 506, a separator 507, an exterior body 509, a positive electrode lead electrode 510, and a negative electrode lead electrode 516.

FIG. 24A illustrates the appearance of the positive electrode 503 and the negative electrode 506. The positive electrode 503 includes the positive electrode current collector 501, and the positive electrode active material layer 502 is formed on the surface of the positive electrode current collector 501. The positive electrode 503 also includes a region where the positive electrode current collector 501 is partly exposed (hereinafter referred to as a tab region).

The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. Note that the areas or the shapes of the tab regions included in the positive electrode and the negative electrode are not limited to the examples shown in FIG. 24A.

The laminated secondary battery 500 including the above-described positive electrode 12 or the like can have high discharge capacity and improved safety.

### <Method for Fabricating Laminated Secondary Battery>

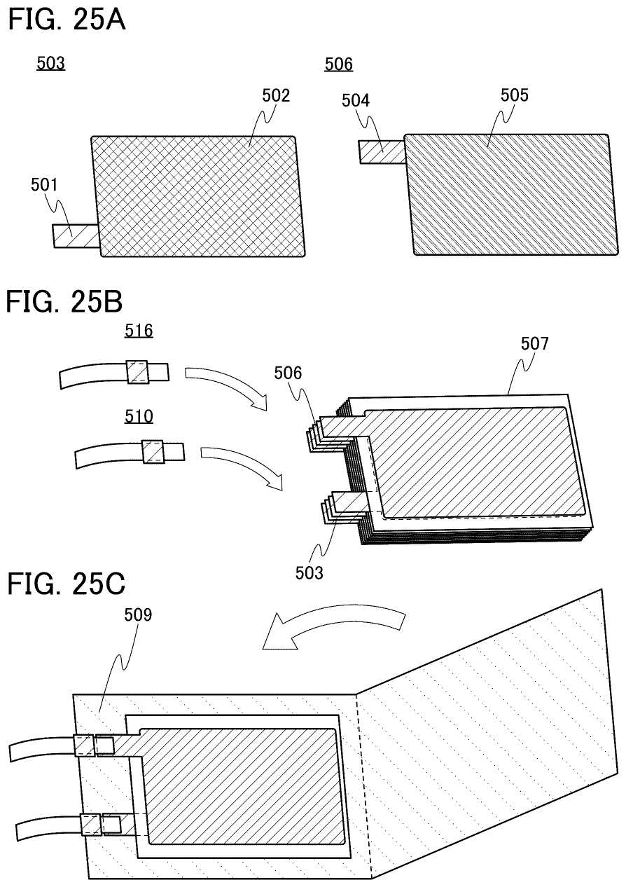

An example of a method for fabricating the laminated secondary battery having the appearance illustrated in FIG. 24A will be described with reference to FIG. 25A to FIG. 25C.

First, the negative electrode 506 and the positive electrode 503 are prepared as illustrated in FIG. 25A, and the negative electrode 506 and the positive electrode 503 are stacked with the separator 507 therebetween as illustrated in FIG. 25B. Here, an example in which five negative electrodes and four positive electrodes are used is shown. The component can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding is performed by ultrasonic welding, for example. In a similar manner, the tab regions of the negative electrodes 506 are bonded to each other, and the negative electrode lead electrode 516 is bonded to the tab region of the negative electrode on the outermost surface.

Next, the negative electrodes 506, the separators 507, and the positive electrodes 503 are placed over the exterior body 509.

Subsequently, the exterior body 509 is folded along a portion shown by a dashed line, as illustrated in FIG. 25C. Then, the outer edges of the exterior body 509 are bonded to each other.

The bonding is performed by thermocompression, for example. At this time, an unbonded region (hereinafter referred to as an inlet) is provided for part (or one side) of the exterior body 509 so that an electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be fabricated.

The positive electrode active material 100 is used for the positive electrode 503, whereby the secondary battery 500 can have high capacity, high discharge capacity, and excellent cycle performance.

### <Secondary Battery Pack>

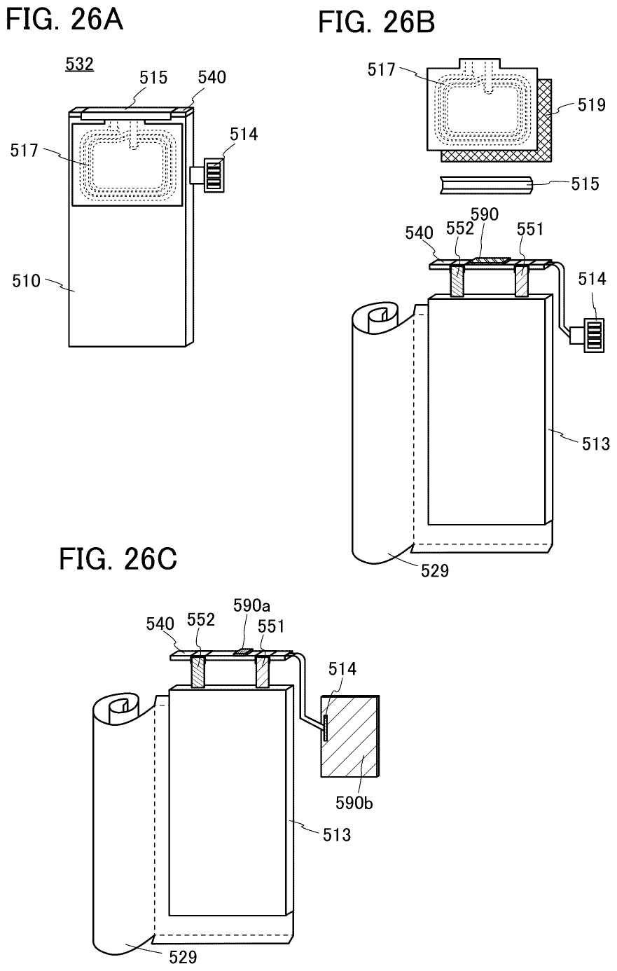

Examples of a secondary battery pack 532 that is capable of wireless charging using an antenna will be described with reference to FIG. 26. The secondary battery pack is preferably used for a mobile battery.

FIG. 26A is a diagram illustrating the appearance of the secondary battery pack 532 that has a rectangular solid shape with a small thickness (also referred to as a flat plate shape with a certain thickness). FIG. 26B is a diagram illustrating a structure of the secondary battery pack 532. The secondary battery pack 532 includes a circuit board 540 and a secondary battery 513. A label 529 is attached to the secondary battery 513. The circuit board 540 is fixed by a sealant 515. The secondary battery pack 532 also includes an antenna 517.

A wound body or a stack may be included inside the secondary battery 513.

In the secondary battery pack 532, a control circuit 590 is provided over the circuit board 540 as illustrated in FIG. 26B, for example. The circuit board 540 is electrically connected to a terminal 514. The circuit board 540 is electrically connected to the antenna 517, one 551 of a positive electrode lead and a negative electrode lead of the secondary battery 513, and the other 552 of the positive electrode lead and the negative electrode lead.

The secondary battery pack 532 includes a layer 519 between the antenna 517 and the secondary battery 513. The layer 519 has a function of blocking an electromagnetic field from the secondary battery 513, for example. For the layer 519, a magnetic material can be used, for example.

Note that the shape of the antenna 517 is not limited to a coil shape and may be a linear shape or a plate shape, for example. An antenna such as a planar antenna, an aperture antenna, a traveling-wave antenna, an EH antenna, a magnetic-field antenna, or a dielectric antenna may be used. Alternatively, the antenna 517 may be a flat-plate conductor. The flat-plate conductor can serve as one of conductors for electric field coupling. That is, the antenna 517 can function as one of two conductors of a capacitor. Thus, electric power can be transmitted and received not only by an electromagnetic field or a magnetic field but also by an electric field.

Alternatively, as illustrated in FIG. 26C, a circuit system 590a provided over the circuit board 540 and a circuit system 590b electrically connected to the circuit board 540 through the terminal 514 may be included.

The secondary battery 513 included in the secondary battery pack 532 can have high discharge capacity and improved safety by including the above-described positive electrode 12 or the like.

### Embodiment 5

In this embodiment, examples of vehicles each including the secondary battery of one embodiment of the present invention will be described.

A secondary battery can be used in vehicles, typically automobiles. Examples of automobiles include next-generation clean energy vehicles such as hybrid vehicles (HVs), electric vehicles (EVs), and plug-in hybrid vehicles (PHEVs or PHVs), and the secondary battery can be used as one of the power sources provided for the automobiles. Vehicles are not limited to automobiles. Other examples of vehicles include a train, a monorail train, a ship, a submarine (a deep-submergence vehicle and an unmanned submarine), a flying object (a helicopter, an unmanned aircraft (a drone), an airplane, a rocket, and an artificial satellite), an electric bicycle, and an electric motorcycle, and the secondary battery of one embodiment of the present invention can be used for such vehicles.

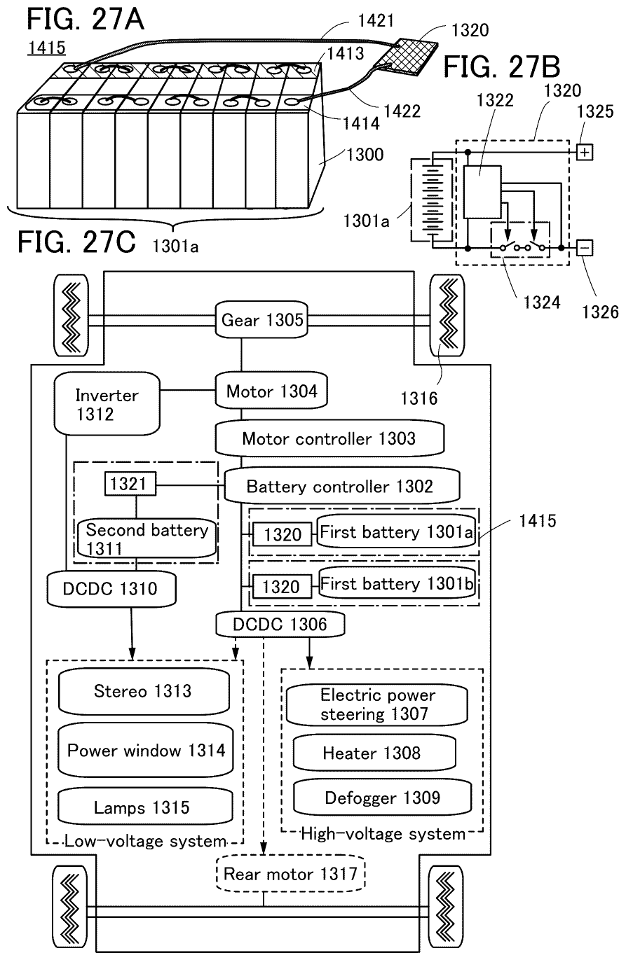

As illustrated in FIG. 27C, an electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than those of the first batteries 1301a and 1301b.

The internal structure of the first battery 1301a may be the wound structure or the stacked-layer structure. In addition, an all-solid-state battery may be used as the first battery 1301a. The use of the all-solid-state battery as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (e.g., an electric power steering 1307, a heater 1308, and a defogger 1309) through a DCDC circuit 1306. In the case where there is a rear motor 1317 for rear wheels, the first battery 1301a is used to rotate the rear motor 1317.

The second battery 1311 supplies electric power to in-vehicle parts for 14 V (e.g., a stereo 1313, a power window 1314, and lamps 1315) through a DCDC circuit 1310.

Next, the first battery 1301a is described with reference to FIG. 27A.

FIG. 27A shows an example in which nine rectangular secondary batteries 1300 form one battery pack 1415. The nine rectangular secondary batteries 1300 are connected in series; one electrode is fixed by a fixing portion 1413 made of an insulator, and the other electrode is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charging control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the metal oxide, a metal oxide such as an In-M-Zn oxide (an element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is preferably used. In particular, the In-M-Zn oxide that can be used as the metal oxide is preferably a CAAC-OS (C-Axis Aligned Crystal Oxide Semiconductor) or a CAC-OS (Cloud-Aligned Composite Oxide Semiconductor). An In—Ga oxide or an In—Zn oxide may be used as the metal oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement.

Note that the “CAC-OS” has a composition in which materials are separated into first regions and second regions to form a mosaic pattern, and the first regions are distributed in the film (this composition is hereinafter also referred to as a cloud-like composition). That is, the CAC-OS is a composite metal oxide having a composition in which the first regions and the second regions are mixed. Note that a clear boundary between the first region and the second region is difficult to observe in some cases.

For example, energy dispersive X-ray spectroscopy (EDX) is used to obtain EDX mapping, and according to the EDX mapping, the CAC-OS in the In—Ga—Zn oxide can be found to have a composition in which the regions containing In as its main component (the first regions) and the regions containing Ga as its main component (the second regions) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, a high on-state current (Ion), high field-effect mobility (u), and favorable switching operation can be achieved.

Oxide semiconductors have various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of single crystal Si, and thus shows a smaller change in characteristics than the single crystal even when the secondary battery is heated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion is used in combination with a secondary battery whose positive electrode includes the positive electrode active material 100 obtained in Embodiments 1, 2, and the like, the synergy on safety can be obtained. The secondary battery whose positive electrode includes the positive electrode active material 100 obtained in Embodiments 1, 2, and the like and the control circuit portion 1320 can contribute greatly to elimination of accidents due to secondary batteries, such as fires.

The control circuit portion 1320 that includes a memory circuit including a transistor using an oxide semiconductor can also function as an automatic control device for the secondary battery to resolve the ten items of causes of instability, such as a micro-short circuit. Examples of functions of resolving the ten items of the causes of instability of a secondary battery include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A “micro-short circuit” refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: charging and discharging performed a plurality of times cause uneven distribution of positive electrode active materials, which leads to local concentration of current in part of the positive electrode and part of the negative electrode, whereby part of a separator stops functioning or a by-product is generated by a side reaction, which is thought to generate a micro short circuit.

It can be said that the control circuit portion 1320 not only detects a micro-short circuit but also senses the terminal voltage of the secondary battery and controls the charge and discharge state of the secondary battery. For example, to prevent overcharging, an output transistor of a charge circuit and an interruption switch can be turned off substantially at the same time.

FIG. 27B shows an example of a block diagram of the battery pack 1415 illustrated in FIG. 27A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and/or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of n-channel transistors or p-channel transistors. The switch portion 1324 is not limited to a switch including a Si transistor using single crystal silicon; the switch portion 1324 may be formed using, for example, a power transistor including Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to the in-vehicle parts for 42 V (for a high-voltage system), and the second battery 1311 supplies electric power to the in-vehicle parts for 14 V (for a low-voltage system). Lead storage batteries are usually used for the second battery 1311 due to cost advantage. Lead storage batteries have disadvantages compared with lithium ion batteries in that they have a larger amount of self-discharging and are more likely to deteriorate owing to a phenomenon called sulfation. There is an advantage that the second battery 1311 can be maintenance-free when a lithium ion battery is used; however, in the case of long-term use, for example three years or more, anomaly that is difficult to determine at the time of fabrication might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium ion battery is used as both the first battery 1301a and the second battery 1311 is described. As the second battery 1311, a lead storage battery, an all-solid-state battery, or an electric double layer capacitor may be used. For example, the all-solid-state battery in Embodiment 6 may be used. The use of the all-solid-state battery in Embodiment 6 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b can desirably be charged rapidly. The battery controller 1302 can set the charge voltage, charge current, and the like of the first batteries 1301a and 1301b. The battery controller 1302 can set charging conditions in accordance with charge performance of a secondary battery used, so that rapid charging can be performed.

Although not illustrated, in the case of connecting an electric vehicle to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. The connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200 V outlet with 50 kW, for example. Furthermore, charging can be performed with electric power supplied from external charging equipment by a contactless power feeding method or the like.

For rapid charging, secondary batteries that can withstand high-voltage charging have been desired to perform charging in a short time.

Moreover, it is possible to achieve a secondary battery in which graphene is used as a conductive material, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Next, examples in which the secondary battery of one embodiment of the present invention is mounted on a vehicle, typically a transport vehicle, will be described.

Mounting the secondary battery on vehicles can achieve next-generation clean energy vehicles such as hybrid vehicles (HVs), electric vehicles (EVs), and plug-in hybrid vehicles (PHVs). The secondary battery can also be incorporated in agricultural machines, motorized bicycles including motor-assisted bicycles, motorcycles, electric wheelchairs, electric carts, boats and ships, submarines, aircraft, rockets, artificial satellites, space probes, planetary probes, or spacecraft. The secondary battery including the above-described positive electrode 12 or the like can have high discharge capacity and improved safety. Thus, the secondary battery of one embodiment of the present invention is suitable for reduction in size and reduction in weight and can be suitably used in transport vehicles.

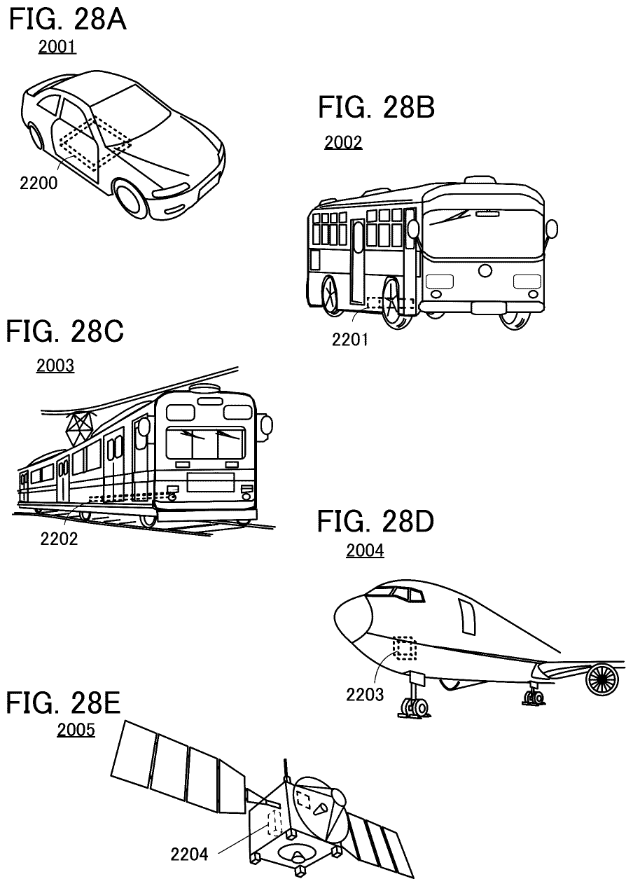

FIG. 28A to FIG. 28D show examples of transport vehicles using one embodiment of the present invention. An automobile 2001 illustrated in FIG. 28A is an electric vehicle that runs using an electric motor as a driving power source. Alternatively, the automobile 2001 is a hybrid vehicle capable of driving using either an electric motor or an engine as a driving power source. In the case where the secondary battery is mounted on the vehicle, the secondary battery shown as an example in Embodiment 4 is provided at one position or several positions. The automobile 2001 illustrated in FIG. 28A includes a battery pack 2200, and the battery pack includes a secondary battery module in which a plurality of secondary batteries are connected to each other. Moreover, the battery pack preferably includes a charging control device that is electrically connected to the secondary battery module.

The automobile 2001 can be charged when the secondary battery included in the automobile 2001 is supplied with electric power from external charging equipment by a plug-in system, a contactless power feeding system, or the like. In charging, a given method such as CHAdeMO (registered trademark) or Combined Charging System can be employed as a charging method, the standard of a connector, or the like as appropriate. Charging equipment may be a charging station provided in a commerce facility or a household power source. For example, with the use of the plug-in system, the power storage device mounted on the automobile 2001 can be charged by being supplied with electric power from the outside. Charging can be performed by converting AC power into DC power through a converter such as an ACDC converter.

Although not illustrated, the vehicle may be provided with a power receiving device so that it can be charged by being supplied with electric power from an above-ground power transmitting device in a contactless manner. For the contactless power feeding system, by fitting a power transmitting device in a road or an exterior wall, charging can be performed not only when the vehicle stops but also when moves. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 28B illustrates a large transporter 2002 having a motor controlled by electricity, as an example of a transport vehicle. A secondary battery module of the transporter 2002 has a cell unit of four secondary batteries with a nominal voltage of 3.0 V or higher and 5.0 V or lower, and 48 cells are connected in series to have 170 V as the maximum voltage, for example. A battery pack 2201 has the same function as the battery pack in FIG. 28A except, for example, the number of secondary batteries included in the secondary battery module; thus, the description is omitted.

FIG. 28C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. Thus, the secondary batteries are required to have a small variation in performance. By employing the positive electrode active material 100 described in Embodiments 1, 2, and the like for the positive electrode, a secondary battery having stable battery performance can be manufactured and mass production at low cost is possible in light of the yield.

FIG. 28D illustrates an aircraft 2004 having a combustion engine as an example. The aircraft 2004 illustrated in FIG. 28D can be regarded as a kind of transport vehicles since it is provided with wheels for takeoff and landing, and includes a battery pack 2203 that includes a charging control device and a secondary battery module configured by connecting a plurality of secondary batteries.

The secondary battery module of the aircraft 2004 has eight 4 V secondary batteries connected in series and has 32 V as the maximum voltage, for example. The battery pack 2203 has a function similar to that in FIG. 28A except, for example, the number of secondary batteries included in the secondary battery module; thus, the description is omitted.

FIG. 28E illustrates an artificial satellite 2005 including a secondary battery 2204 as an example. The artificial satellite 2005 is used in an ultra-low-temperature cosmic space, and thus is preferably provided with the secondary battery 2204 of one embodiment of the present invention.

It is further preferable that the secondary battery 2204 be mounted inside the artificial satellite 2005 while being covered with a heat-retaining member.

### Embodiment 6

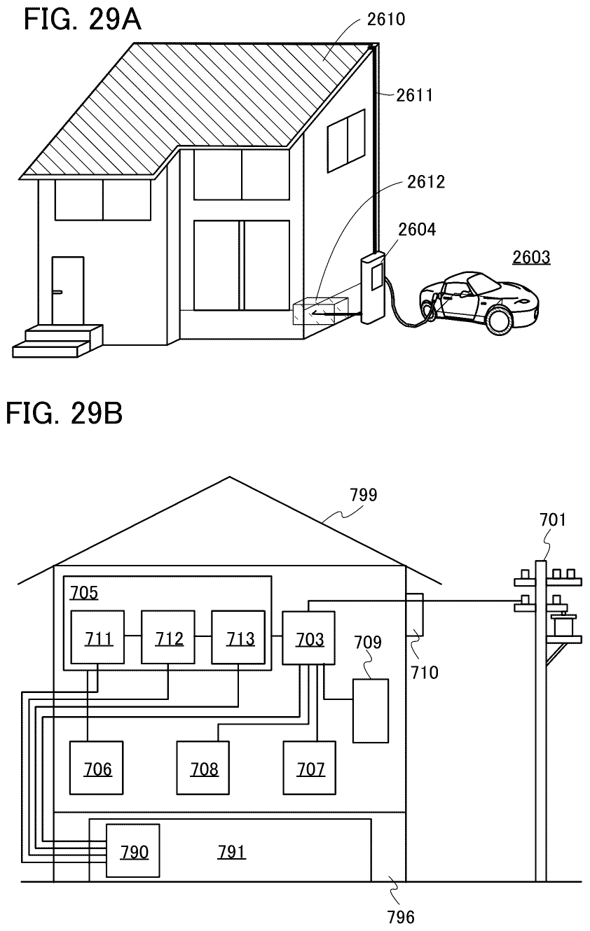

In this embodiment, examples in which the secondary battery of one embodiment of the present invention is mounted on a building will be described with reference to FIG. 29A and FIG. 29B.

A house illustrated in FIG. 29A includes a power storage device 2612 including the secondary battery of one embodiment of the present invention and a solar panel 2610. The secondary battery including the above-described positive electrode 12 or the like can have high discharge capacity and improved safety. The power storage device 2612 is electrically connected to the solar panel 2610 through a wiring 2611 or the like. The power storage device 2612 may be electrically connected to ground-based charging equipment 2604. The power storage device 2612 can be charged with electric power generated by the solar panel 2610. A secondary battery included in a vehicle 2603 can be charged with the electric power stored in the power storage device 2612 through the charging equipment 2604. The power storage device 2612 is preferably provided in an underfloor space. When the power storage device 2612 is provided in the underfloor space, the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source owing to power failure or the like.

FIG. 29B shows an example of a power storage device of one embodiment of the present invention. As illustrated in FIG. 29B, a power storage device 791 of one embodiment of the present invention is provided in an underfloor space 796 of a building 799. The power storage device 791 may be provided with the control circuit described in Embodiment 4, and when a secondary battery whose positive electrode includes the positive electrode active material 100 obtained in Embodiments 1, 2, and the like is used for the power storage device 791, the synergy on safety can be obtained. The secondary battery including the control circuit described in Embodiment 7 and a positive electrode including the positive electrode active material 100 described in Embodiments 1, 2, and the like can contribute greatly to elimination of accidents due to the power storage device 791 including secondary batteries, such as fires.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electronic device such as a TV or a personal computer. The power storage load 708 is, for example, an electronic device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power to be consumed by the general load 707 and the power storage load 708 during the next day. The planning portion 713 has a function of making a charging and discharging plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can also be checked with an electronic device such as a TV or a personal computer through the router 709. Furthermore, it can be checked with a portable electronic terminal such as a smartphone or a tablet through the router 709. With the indicator 706, the electronic device, or the portable electronic terminal, the demand for electric power depending on a time period (or per hour) that is predicted by the predicting portion 712 can be checked.

### Embodiment 7

In this embodiment, a motorcycle and a bicycle will be described as examples of vehicles in each of which a secondary battery is mounted. The secondary battery including the above-described positive electrode 12 or the like can have high discharge capacity and improved safety.

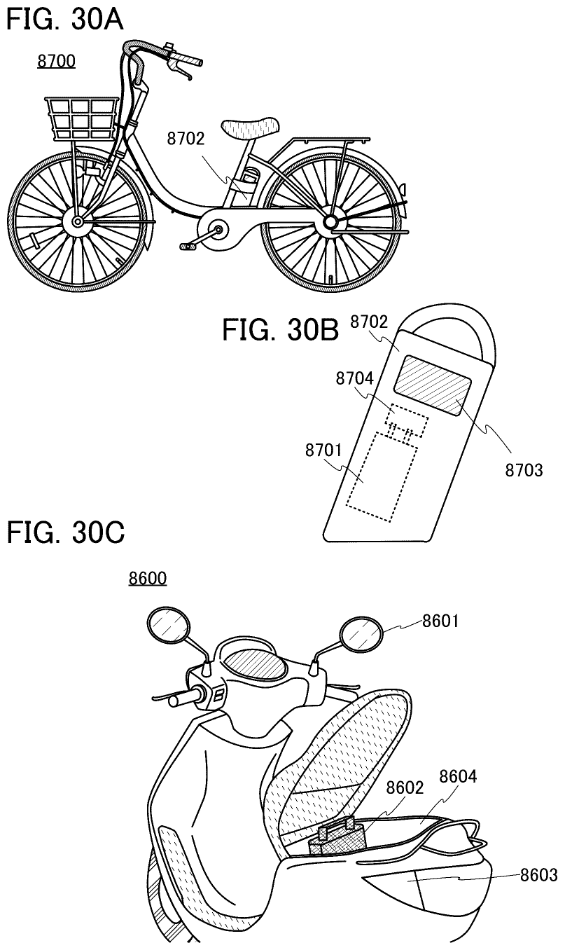

FIG. 30A shows an example of an electric bicycle in which the secondary battery of one embodiment of the present invention is mounted. The power storage device of one embodiment of the present invention can be used for an electric bicycle 8700 illustrated in FIG. 26A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 30B illustrates the state where the power storage device 8702 is detached from the bicycle. A plurality of secondary batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charging control or anomaly detection for the secondary battery. The control circuit 8704 is electrically connected to a positive electrode and a negative electrode of the secondary battery 8701. When the control circuit 8704 is used in combination with a secondary battery whose positive electrode includes the positive electrode active material 100, the synergy on safety can be obtained.

FIG. 30C shows an example of a motorcycle using the power storage device of one embodiment of the present invention. A motor scooter 8600 illustrated in FIG. 30C includes a power storage device 8602, side mirrors 8601, and indicator lights 8603. The power storage device 8602 can supply electricity to the indicator lights 8603.

In the motor scooter 8600 illustrated in FIG. 30C, the power storage device 8602 can be stored in an under-seat storage unit 8604. The power storage device 8602 can be stored in the under-seat storage unit 8604 even when the under-seat storage unit 8604 is small.

### Embodiment 8

In this embodiment, examples of electronic devices each including the secondary battery of one embodiment of the present invention will be described. The secondary battery including the above-described positive electrode active material or the like can have high discharge capacity and improved safety.

Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

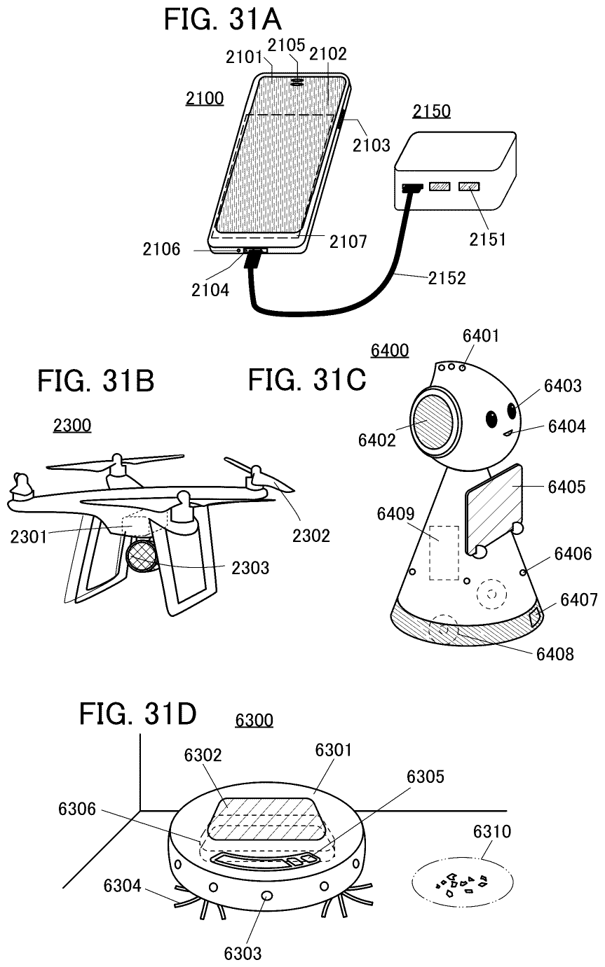

FIG. 31A shows an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a secondary battery 2107. The use of the secondary battery 2107 whose positive electrode includes the positive electrode active material 100 described in the above embodiment achieves high capacity and a structure that accommodates space saving due to a reduction in size of the housing.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

The mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

The mobile phone 2100 may be provided with an external battery 2150. The external battery 2150 includes a secondary battery and a plurality of terminals 2151. Through a cable 2152 or the like, the mobile phone 2100 or the like can be charged with electricity from the external battery 2150. When the positive electrode active material of one embodiment of the present invention is used for the secondary battery included in the external battery 2150, the external battery 2150 can have high performance. Furthermore, even when the capacity of the secondary battery 2107 included in the mobile phone 2100 itself is low, the mobile phone 2100 can be used for a long time by being charged with electricity from the external battery 2150. Thus, the mobile phone 2100 itself can be small and/or lightweight and can have improved safety.

FIG. 31B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna.

FIG. 31C shows an example of a robot. A robot 6400 illustrated in FIG. 31C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user by using the microphone 6402 and the speaker 6404.

The display portion 6405 has a function of displaying various kinds of information. The robot 6400 can display information desired by the user on the display portion 6405. The display portion 6405 may be provided with a touch panel. Alternatively, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes, in its inner region, the secondary battery 6409 of one embodiment of the present invention and a semiconductor device or an electronic component.

FIG. 31D shows an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

The cleaning robot 6300 can determine whether there is an obstacle such as a wall, furniture, or a step by analyzing images taken by the cameras 6303. In the case where the cleaning robot 6300 detects an object that is likely to be caught in the brush 6304, such as a wire, by image analysis, the rotation of the brush 6304 can be stopped. The cleaning robot 6300 includes, in its inner region, the secondary battery 6306 of one embodiment of the present invention and a semiconductor device or an electronic component.

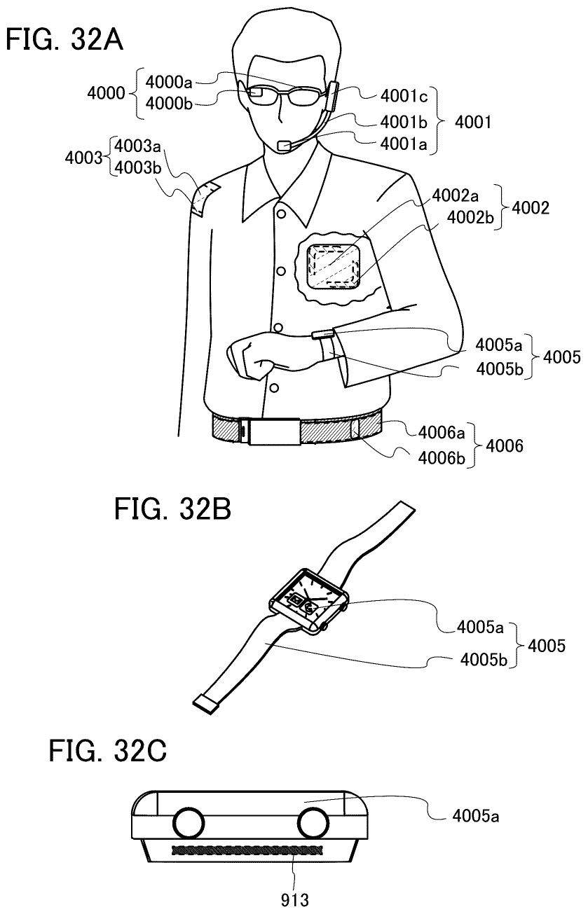

FIG. 32A shows examples of wearable devices. A secondary battery is used as a power source of a wearable device. To have improved splash resistance, water resistance, or dust resistance in daily use or outdoor use by a user, a wearable device is desirably capable of being charged wirelessly as well as being charged with a wire whose connector portion for connection is exposed.

For example, the secondary battery of one embodiment of the present invention can be provided in a glasses-type device 4000 illustrated in FIG. 32A. The glasses-type device 4000 includes a frame 4000a and a display portion 4000b. The secondary battery is provided in a temple portion of the frame 4000a having a curved shape, whereby the glasses-type device 4000 can be lightweight, have a well-balanced weight, and be used continuously for a long time.

The secondary battery of one embodiment of the present invention can be provided in a headset-type device 4001. The headset-type device 4001 includes at least a microphone portion 4001a, a flexible pipe 4001b, and an earphone portion 4001c. The secondary battery can be provided in the flexible pipe 4001b or the earphone portion 4001c.

The secondary battery of one embodiment of the present invention can be provided in a device 4002 that can be attached directly to a body. A secondary battery 4002b can be provided in a thin housing 4002a of the device 4002.

The secondary battery of one embodiment of the present invention can be provided in a device 4003 that can be attached to clothes. A secondary battery 4003b can be provided in a thin housing 4003a of the device 4003.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b.

The display portion 4005a can display various kinds of information such as time and reception information of an e-mail or an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 32B shows a perspective view of the watch-type device 4005 that is detached from an arm.

FIG. 32C shows a side view. FIG. 32C illustrates a state where the secondary battery 913 is incorporated in the inner region. The secondary battery 913 is provided at a position overlapping with the display portion 4005a.

### EXAMPLE

### <Fabrication Method of Sample 1>

In this example, the positive electrode active material 100 with a median diameter of less than or equal to 12 μm was formed on the basis of FIG. 17, FIG. 18, and the like, and was used as Sample 1. A method for forming the positive electrode active material 100 is described.

As lithium cobalt oxide (LiCoO₂) that was a starting material shown in Step S10 in FIG. 17, commercially available lithium cobalt oxide not containing any additive element (CELLSEED C-5H produced by NIPPON CHEMICAL INDUSTRIAL CO., LTD.) was prepared. The median diameter of C-5H is approximately 7.0 μm, which satisfies the condition where the median diameter is less than or equal to 12 μm.

Next, the heating in Step S15 in FIG. 17 was performed on C-5H, which was put in a saggar (container) covered with a lid, in a muffle furnace at 850° C. for 2 hours. After the muffle furnace was filled with an oxygen atmosphere, an oxygen gas was prevented from entering and exiting from a treatment chamber.

Next, in accordance with Step S20a in FIG. 18A, the additive element A1 source was formed. First, lithium fluoride (LiF) was prepared as the F source, and magnesium fluoride (MgF₂) was prepared as the Mg source. LiF and MgF₂ were weighed such that LiF: MgF₂ was 1:3 (molar ratio). Then, LiF and MgF₂ were mixed in dehydrated acetone and the mixture was stirred at a rotating speed of 500 rpm for 20 hours. In grinding and mixing, a ball mill was used and a grinding medium was zirconium oxide balls. After the mixing, the mixture was made to pass through a sieve with an aperture of 300 μm, whereby the additive element A1 was obtained.

Next, in accordance with Step S31 in FIG. 17, the lithium cobalt oxide (lithium cobalt oxide subjected to the initial heating) obtained by the heating in Step S15 and the additive element A1 source obtained in Step S20a were mixed. Specifically, the materials were weighed so that MgF₂ was 1 mol % of the lithium cobalt oxide subjected to the initial heating, and then the materials were mixed by a dry method. At this time, stirring was performed at a rotating speed of 150 rpm for 1 hour. After that, the mixture was made to pass through a sieve with an aperture of 300 μm, whereby the mixture 903 was obtained (Step S32).

Next, in Step S33 in FIG. 17, the mixture 903 was heated. The heating conditions were 900° C. and 5 hours. During the heating, the mixture 903 was in a saggar covered with a lid. The saggar was filled with an atmosphere containing oxygen, and an oxygen gas was prevented from entering and exiting from the treatment chamber. By the heating, lithium cobalt oxide containing Mg and F (a composite oxide in Step S34a) was obtained.

Next, in accordance with Step S40 in FIG. 18C, the additive element A2 source was formed. First, nickel hydroxide (Ni(OH)₂) was prepared as the Ni source, and aluminum hydroxide (Al(OH)₃) was prepared as the Al source. Next, the nickel hydroxide and the aluminum hydroxide were separately stirred in dehydrated acetone at a rotating speed of 500 rpm for 20 hours. In grinding, a ball mill was used and a grinding medium was zirconium oxide balls. Then, each of the nickel hydroxide and the aluminum hydroxide was made to pass through a sieve with an aperture of 300 μm, whereby the additive element A2 source in Step S43 was obtained.

Next, in Step S51 in FIG. 17, the lithium cobalt oxide containing Mg and F and the additive element A2 source were mixed by a dry method. Specifically, the mixing was performed by 1-hour stirring at a rotating speed of 150 rpm. The mixing ratio was set so that each of the nickel hydroxide and the aluminum hydroxide was 0.5 mol % with respect to the LICoO₂. In the mixing, a ball mill was used and a grinding medium was zirconium oxide balls. Finally, the mixture was made to pass through a sieve with an aperture of 300 μm, whereby the mixture 904 was obtained (Step S52).

Next, in Step S53 in FIG. 17, the mixture 904 was heated. The heating conditions were 850° C. and 2 hours. During the heating, the mixture 904 was in a saggar covered with a lid and heated in a muffle furnace. After the muffle furnace was filled with an oxygen atmosphere, an oxygen gas was prevented from entering and exiting from the treatment chamber. By the heating, lithium cobalt oxide containing Mg, F, Ni, and Al (the positive electrode active material 100 in Step S54) was obtained. In this manner, the positive electrode active material used as Sample 1 was obtained.

### <Particle Size Distribution Measurement>

The particle size distribution of Sample 1 was measured.

For the particle size distribution measurement, a laser diffraction particle size distribution measurement apparatus SALD-2200 produced by Shimadzu Corporation was used. First, approximately 0.4 g of Sample 1, a surface-active agent, and 1 mL or more and 2 mL or less of distilled water were mixed in a beaker, ultrasonic treatment was performed, and sufficient stirring was performed, whereby a dispersion liquid was obtained. After that, the dispersion liquid was injected into a stirring tank, and luminous intensity distribution was measured 64 times at intervals of two seconds to analyze particle size distribution data.

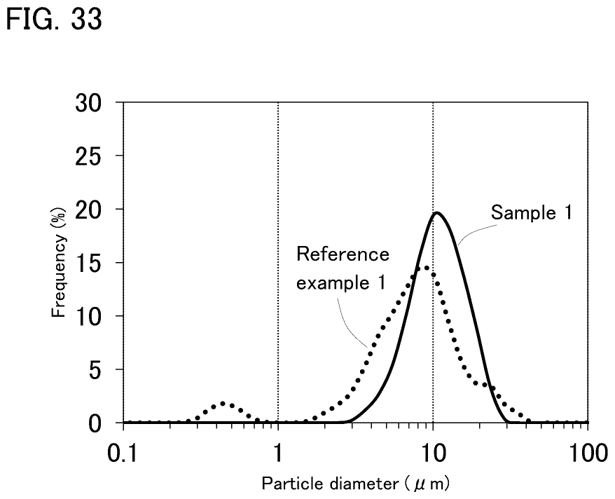

FIG. 33 shows the results of measuring the particle size distribution of Sample 1 by a solid line. FIG. 33 is a graph showing the frequency (%) with respect to the particle diameter (μm). Note that as Reference example 1, a dotted line in FIG. 33 indicates the particle size distribution of the commercially available lithium cobalt oxide containing no additive element (C-5H produced by NIPPON CHEMICAL INDUSTRIAL CO., LTD.), which was used as a starting material in this example.

The median diameter of Sample 1 was approximately 9.7 μm. D90 of Sample 1 was 15.5 μm. As a result, it was found that the median diameter of Sample 1 was less than or equal to 12 μm. The median diameter of C-5H, which was Reference example 1, was approximately 7.0 μm.

It was considered that Sample 1 had the wider particle size distribution than C-5H because of an appropriate distribution of the additive elements in a surface portion. A secondary battery with Sample 1 described above is considered to be unlikely to ignite in a nail penetration test, so that a secondary battery with a high level of safety can be provided.

### <Powder Resistivity Measurement>

The volume resistivity of the powder of Sample 1 was measured.

The volume resistivity of the powder was measured by the method described in <<Powder resistivity measurement>> in Embodiment 1. As a measurement apparatus, MCP-PD51 produced by Mitsubishi Chemical Analytech Co., Ltd. was used. As a resistance meter, Hiresta-UP was selected in accordance with the resistivity. The measurement was performed in a dry room environment (i.e., an environment at a temperature higher than or equal to 15° C. and lower than or equal to 30° C.).

The powder of Sample 1 was set in a measurement unit, and the volume resistivity of the powder was obtained by measuring the resistance of the powder and the thickness of the powder under pressures of 13 MPa, 25 MPa, 38 MPa, 51 MPa, and 64 MPa. Note that the volume resistivity was calculated from resistance x area=thickness. In a table below, the volume resistivity and the like of C-5H, which was Reference example 1, are also shown. As a resistance meter, Loresta-GP was selected in accordance with the resistivity of Reference example 1. The results of the volume resistivities and the conductivities are shown in the table below.

TABLE 1

| | Sample 1 | | Reference example 1 | |
|---|---|---|---|---|
| Pressure | Volume resistivity | Conductivity | Volume resistivity | Conductivity |
| (MPa) | (Ω · cm) | (S/cm) | (Ω · cm) | (S/cm) |
| 13 | 2.68 × 10¹⁰ | 3.74 × 10⁻¹¹ | 6.10 × 10³ | 1.64 × 10⁴ |
| 25 | 1.06 × 10¹⁰ | 9.47 × 10⁻¹¹ | 4.79 × 10³ | 2.09 × 10⁴ |
| 38 | 6.09 × 10⁹ | 1.64 × 10⁻¹⁰ | 4.38 × 10⁵ | 2.29 × 10⁴ |
| 51 | 3.87 × 10⁹ | 2.59 × 10⁻¹⁰ | 4.23 × 10³ | 2.37 × 10⁴ |
| 64 | 2.67 × 10⁹ | 3.74 × 10⁻¹⁰ | 4.15 × 10³ | 2.41 × 10⁴ |

As shown in Table 1, Sample 1 was found to have a higher volume resistivity than Reference example 1. Specifically, the volume resistivity of the powder of Sample 1 was found to be 2.67×10⁹Ω·cm under a pressure of 64 MPa. This value was larger than that of Reference example 1. That is, Sample 1 was found to exhibit a volume resistivity higher than or equal to 1.0×10³Ω·cm, preferably higher than or equal to 4.0×10³Ω·cm under a pressure of 64 MPa. It is presumable that in Sample 1, magnesium and the like positioned in the first region increased the powder resistivity of the positive electrode active material. A secondary battery with Sample 1 described above is considered to be unlikely to ignite in a nail penetration test, so that a secondary battery with a high level of safety can be provided. In a secondary battery with Sample 1 described above, the speed of a current flowing into a positive electrode can be low if an internal short circuit occurs, so that a secondary battery with a high level of safety can be provided.

The volume resistivity tends to be higher under the condition with a lower pressure than under the condition with a higher pressure. Thus, the volume resistivity of the powder of Sample 1 was found to be higher than or equal to 1.5×10⁸Ω·cm under a pressure of 64 MPa, and higher than or equal to 2.1×10⁹Ω·cm under a pressure of 13 MPa. In such a manner, the values of the volume resistivities in the above table can be combined with each other.

### <XPS Analysis>

Sample 1 and Reference example 1 were subjected to XPS analysis. The XPS measurement conditions are shown below.
Measurement apparatus: Quantera II produced by PHI, Inc.
X-ray source: monochromatic Al Kα (1486.6 eV)
Detection area: 100 μmo
Detection depth: approximately 4 to 5 nm (extraction angle) 45° Measurement spectrum: wide scanning, narrow scanning of each detected element

The results of the above XPS measurement were analyzed, whereby the XPS analysis results shown in a table below were obtained.

TABLE 2

| | Li | Co | Ni | Al | O | Mg | F |
|---|---|---|---|---|---|---|---|
| Sample 1 | 9.3 | 13.1 | 1.3 | 0.5 | 44.2 | 14.3 | 10.4 |
| Reference | 16.9 | 20.5 | 0 | 0 | 50.9 | 0 | 0.3 |
| example 1 | | | | | | | |

| | C | Ca | Na | S | Cl | Ti | Total |
|---|---|---|---|---|---|---|---|
| Sample 1 | 3.2 | 0.5 | 1.9 | 1 | 0.4 | 0 | 100.0 |
| Reference | 9.6 | 0.4 | 1.4 | 0 | 0 | 0 | 99.9 |
| example 1 | | | | | | | |

Table 2 shows the atomic ratio (atomic %) of each element when the total number of atoms of Li, Co, Ni, Al, O, Mg, F, C, Ca, Na, S, Cl, and Ti is 100%. Note that the total amount shown in Table 2 is sometimes 99.9% because the values are rounded off to be shown in the table; however, the total number of atoms is 100.0% in the XPS analysis.

According to comparison between Sample 1 and Reference example 1, large amounts of Ni, Mg, and F are detected and small amounts of Li and Co are detected in Sample 1. This result probably suggests that the first region described in Embodiment 1 is formed in Sample 1.

On the basis of the XPS analysis results shown in Table 2, the ratio of the atomic ratio of Ni to the atomic ratio of Co (A_{Ni}/A_{Co}), the ratio of the atomic ratio of Mg to the atomic ratio of Co (A_{Mg}/A_{co}), and the ratio of the atomic ratio of F to the atomic ratio of Co (A_{F}/A_{Co}) were calculated, and are shown in a table below.

TABLE 3

| | A_{Ni}/A_{Co} | A_{Mg}/A_{Co} | A_{F}/A_{Co} |
|---|---|---|---|
| Sample 1 | 0.099 | 1.092 | 0.794 |
| Reference | 0.000 | 0.000 | 0.015 |
| example 1 | | | |

In the XPS analysis of Sample 1, the ratio of the atomic ratio of Ni to the atomic ratio of Co (A_{Ni}/A_{Co}) was greater than or equal to 0.09, the ratio of the atomic ratio of Mg to the atomic ratio of Co (A_{Mg}/A_{Co}) was greater than or equal to 1.00, and the ratio of the atomic ratio of F to the atomic ratio of Co (A_{F}/A_{Co}) was greater than or equal to 0.70.

From the above results, it can be said that the ratio of the atomic ratio of Ni to the atomic ratio of Co (A_{Ni}/A_{Co}) is preferably greater than or equal to 0.07, further preferably greater than or equal to 0.08, still further preferably greater than or equal to 0.09. It can also be said that A_{Ni}/A_{co} is preferably less than or equal to 0.15, preferably less than or equal to 0.13, and preferably less than or equal to 0.11.

In addition, it can be said that the ratio of the atomic ratio of Mg to the atomic ratio of Co (A_{Mg}/A_{co}) is preferably greater than or equal to 0.8, further preferably greater than or equal to 0.9, still further preferably greater than or equal to 1.0. It can also be said that A_{Mg}/A_{co} is preferably less than or equal to 1.4, further preferably less than or equal to 1.3, still further preferably less than or equal to 1.2.

In addition, it can be said that the ratio of the atomic ratio of F to the atomic ratio of Co (A_{F}/A_{Co}) is preferably greater than or equal to 0.5, further preferably greater than or equal to 0.6, still further preferably greater than or equal to 0.7. It can also be said that A_{F}/A_{co} is preferably less than or equal to 1.0, preferably less than or equal to 0.9, and preferably less than or equal to 0.8.

A secondary battery with Sample 1 described above is considered to be unlikely to ignite in a nail penetration test, so that a secondary battery with a high level of safety can be provided.

### <STEM-EDX Analysis>

Sample 1 was subjected to STEM-EDX line analysis. As a STEM apparatus, HD-2700 produced by Hitachi High-Tech Corporation was used, and an acceleration voltage was 200 kV. As an EDX detector, Octane T Ultra W (a detection element area of 100 mm²×2) produced by AMETEK Co., Ltd. was used. As EDX software, TEAM produced by AMETEK Co., Ltd. was used. The EDX analysis measurement conditions were as follows: the beam diameter was 0.2 nmo, the beam dwell time was 50 msec, the number of frames was 20, the step pitch was 0.2 nm, and the number of data steps was 850 (width: 42 nm).

As pretreatment before the analysis, a protective film was deposited by evaporation over the surface of Sample 1. Next, cross-sectional observation samples were fabricated using an FIB-SEM apparatus. Specifically, carbon serving as a protective film was deposited by evaporation on an observation portion of the sample with a carbon coating unit of an ion sputtering apparatus (MC1000 produced by Hitachi High-Tech Corporation), the surrounding portions of the observation portion were removed with the FIB-SEM apparatus (XVision 200TBS produced by Hitachi High-Tech Corporation), and then a bottom portion of the observation portion was cut and thinning was performed until the observation portion had a thickness of approximately 60 nm. Here, picking up was performed by an MPS (micro probing system), and as an example of the conditions of the finishing processing, an acceleration voltage was 10 kV. As cross-sectional observation samples of Sample 1, two kinds of samples were prepared by the above-described thinning method: Sample 1Basal including a region having a surface parallel to a basal plane, and Sample 1Edge including a region having a surface (edge plane) parallel to a plane intersecting with a basal plane.

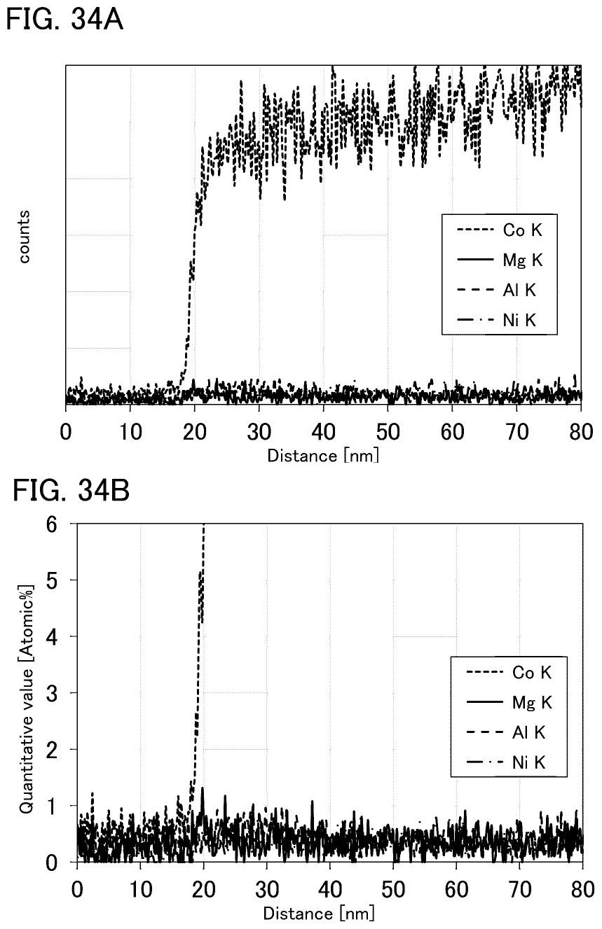

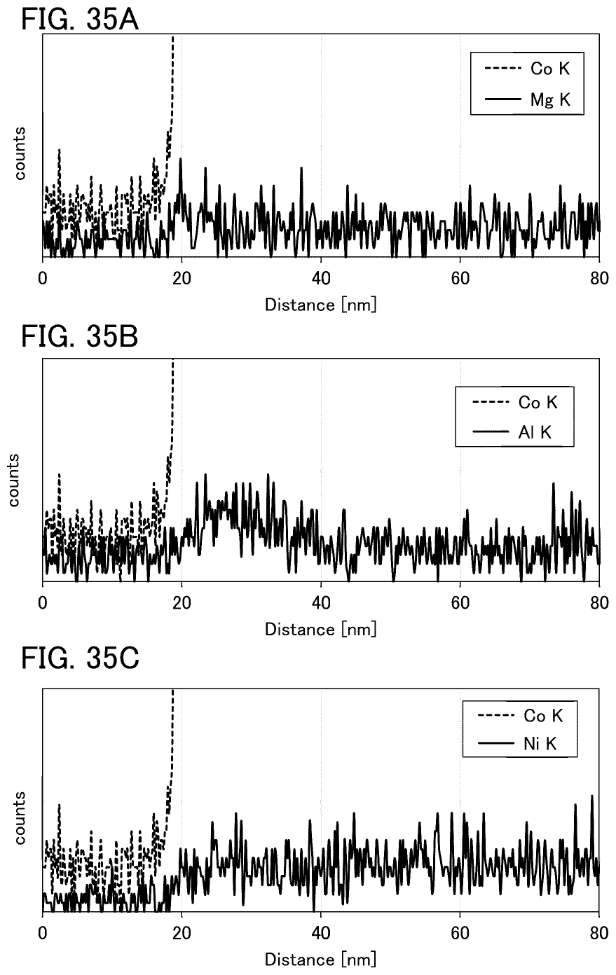

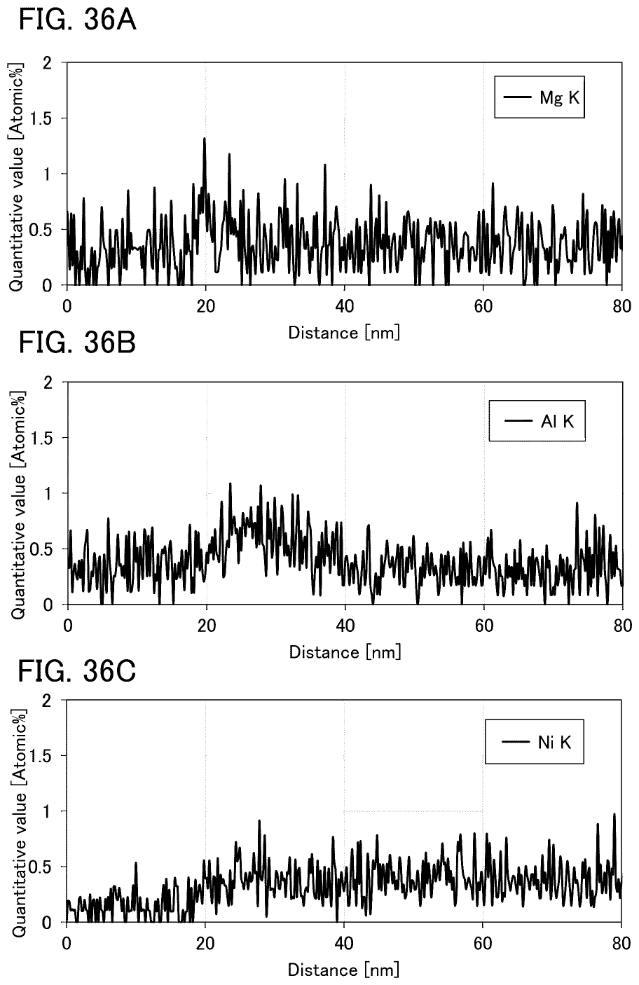

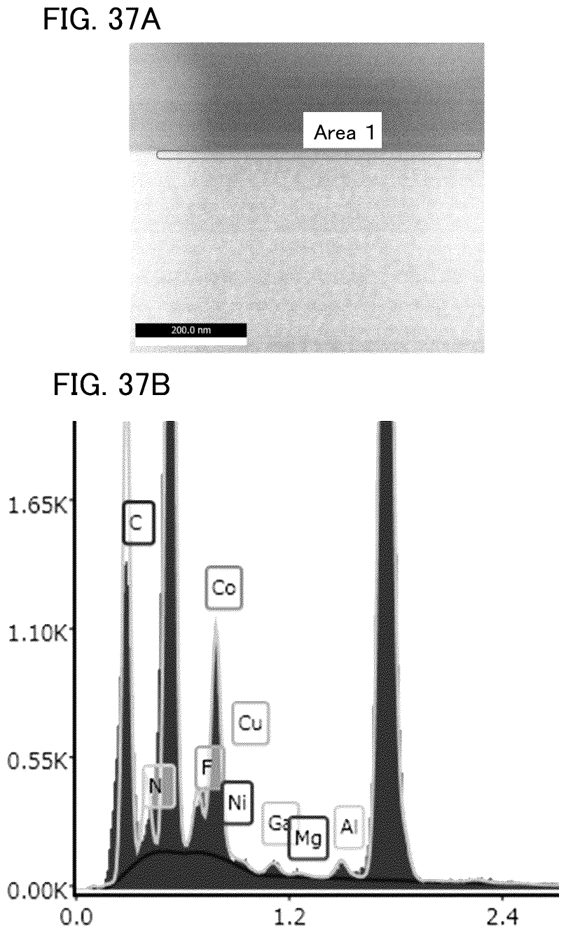

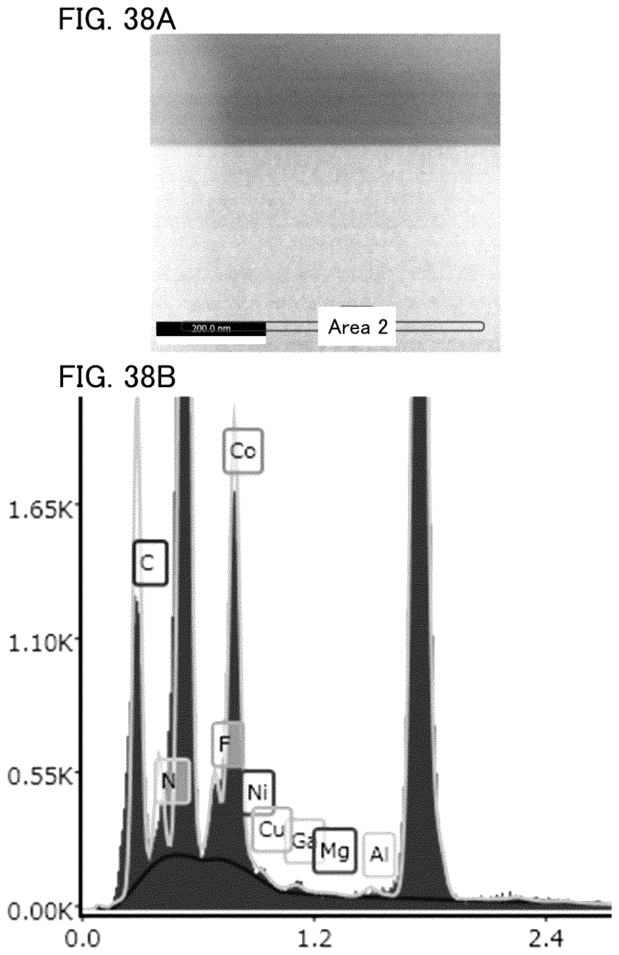

FIG. 34A shows profiles (Counts) of STEM-EDX line analysis in the region of Sample 1 having the surface parallel to the basal plane. FIG. 34B shows quantitative values (atomic %) of the STEM-EDX line analysis in the region of Sample 1 having the surface parallel to the basal plane. FIG. 35A, FIG. 35B, and FIG. 35C respectively show Co and Mg, Co and Al, and Co and Ni that are extracted from the profiles (Counts) of the STEM-EDX line analysis in FIG. 34A. FIG. 36A, FIG. 36B, and FIG. 36C respectively show only Mg, only Al, and only Ni that are extracted from the quantitative values (atomic %) of the STEM-EDX line analysis in FIG. 34B. FIG. 37A shows a STEM image including Area 1, which was a target in STEM-EDX point analysis on the region of Sample 1 having the surface parallel to the basal plane. Area 1 is a portion corresponding to the surface portion of Sample 1. FIG. 37B is a graph in which part of energy spectra in Area 1 is enlarged. The horizontal axis of the energy spectra represents characteristic X-ray energy, and the vertical axis represents X-ray intensity. The unit of X-ray intensity is cps (Count Per Second). FIG. 38A shows a STEM image including Area 2, which was a target in the STEM-EDX point analysis on the region of Sample 1 having the surface parallel to the basal plane. Area 2 is a portion corresponding to an inner portion of Sample 1. FIG. 38B is a graph in which part of energy spectra in Area 2 is enlarged.

The point of 50% of the sum of the average value MAVE of the detection intensity of cobalt in the inner portion and the average value MBG of cobalt of the background was obtained from the profiles in FIG. 34A, and was superimposed on the position at a distance of 20 nm in FIG. 34A. For easy comparison, the reference point in each graph was set at a distance of 20 nm.

In FIG. 35A, FIG. 35B, and FIG. 35C, the inward direction in the particle from the position at a distance of 20 nm (the half value of Co) is a positive direction. The position showing the maximum value of the detection intensity is referred to as the peak position of the additive element, and the peak position of Al was at 3.4 nm (the position at a distance of 23.4 nm). In addition, the peak positions of Mg and Ni were not able to be specified. The distribution of Al was broad.

In FIG. 36A, the inward direction in the particle from the position at a distance of 20 nm (the half value of Co) is a positive direction. The quantitative value of magnesium was the maximum value, i.e., 1.32 atomic %, at −0.2 nm (a distance of 19.8 nm), 0.35 atomic % at 10 nm (a distance of 30 nm), 0.42 atomic % at 20 nm (a distance of 40 nm), and 0.71 atomic % at 50 nm (a distance of 70 nm). That is, magnesium had the maximum quantitative value in the surface portion in the region of Sample 1 having the surface parallel to the basal plane, and was distributed at a concentration within the range of 0.3 atomic % to 1.4 atomic % from the surface portion to the inner portion. Note that as shown in FIG. 37A and FIG. 38B, an energy spectrum peak derived from the characteristic X-ray of magnesium was not observed in Area 1 or Area 2. Thus, in the region of Sample 1 having the surface parallel to the basal plane, magnesium had a concentration greater than 0 and less than or equal to 1.4 atomic %.

In FIG. 36B, the inward direction in the particle from the position at a distance of 20 nm (the half value of Co) is a positive direction. The quantitative value of aluminum was the maximum value, i.e., 1.09 atomic %, at 3.4 nm (a distance of 23.4 nm), 0.89 atomic % at 10 nm (a distance of 30 nm), 0.45 atomic % at 20 nm (a distance of 40 nm), and 0.10 atomic % at 50 nm (a distance of 70 nm). That is, aluminum had the maximum quantitative value in the surface portion in the region of Sample 1 having the surface parallel to the basal plane, and was distributed at a concentration within the range of 0.1 atomic % to 1.1 atomic % from the surface portion to the inner portion. As shown in FIG. 37A and FIG. 38B, an energy spectrum peak derived from the characteristic X-ray of aluminum was observed in Area 1 or Area 2.

In FIG. 36C, the inward direction in the particle from the position at a distance of 20 nm (the half value of Co) is a positive direction. The quantitative value of aluminum was the maximum value, i.e., 0.97 atomic %, at 59 nm (a distance of 79 nm), 0.44 atomic % at 10 nm (a distance of 30 nm), 0.47 atomic % at 20 nm (a distance of 40 nm), and 0.70 atomic % at 50 nm (a distance of 70 nm). That is, nickel had the maximum quantitative value in the inner portion in the region of Sample 1 having the surface parallel to the basal plane, and was distributed at a concentration within the range of 0.4 atomic % to 1.0 atomic % from the surface portion to the inner portion. Note that as shown in FIG. 37A and FIG. 38B, an energy spectrum peak derived from the characteristic X-ray of nickel was not observed in Area 1 or Area 2. Thus, in the region of Sample 1 having the surface parallel to the basal plane, nickel had a concentration greater than 0 and less than or equal to 1.0 atomic %.

Since Mg, Al, and Ni that are the additive elements are easily distributed utilizing a diffusion path of lithium ions, Mg, Al, and Ni are probably unlikely to be diffused in the region having the surface parallel to the basal plane where the diffusion path is not exposed, leading to the relatively small quantitative values.

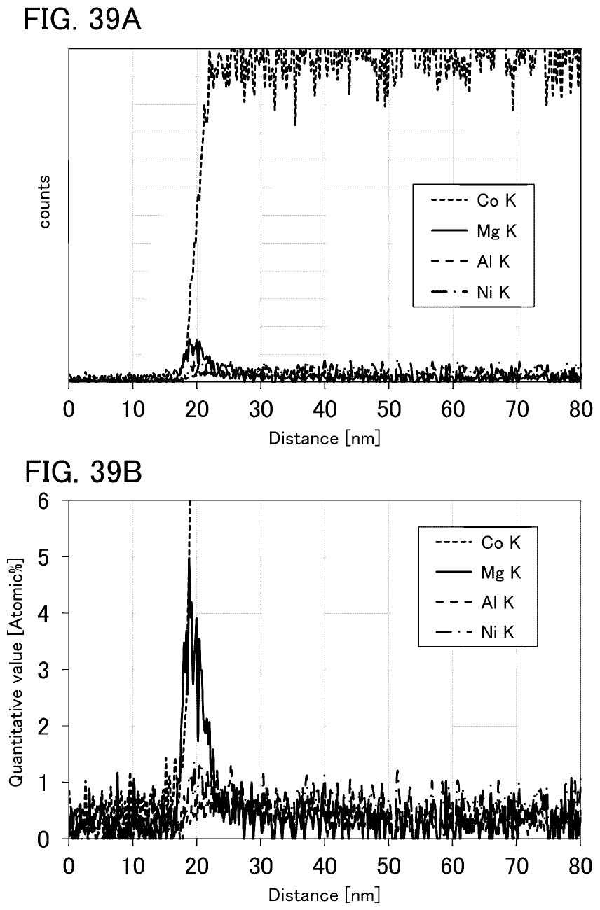

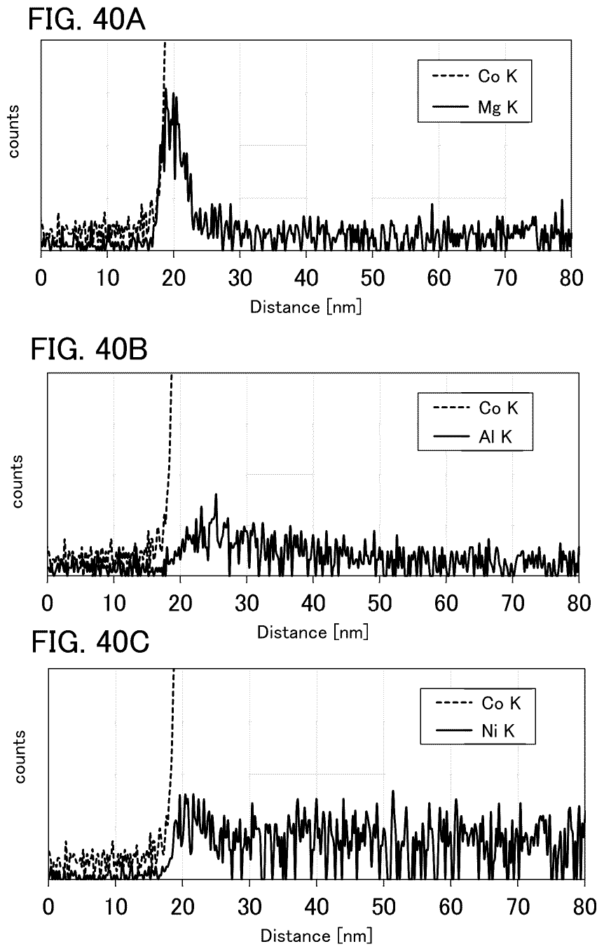

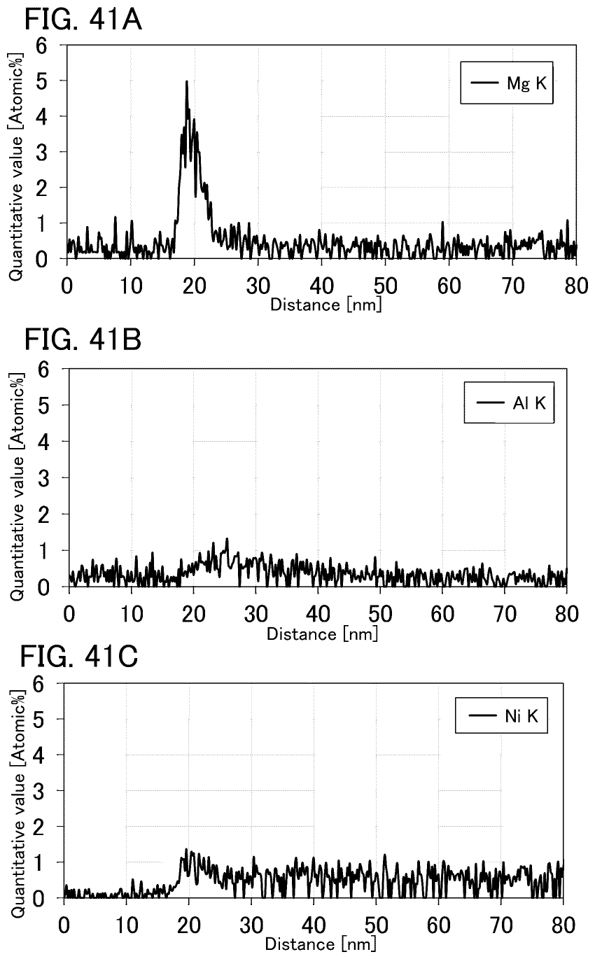

FIG. 39A shows profiles (Counts) of STEM-EDX line analysis in the region of Sample 1 having the surface parallel to the edge plane. FIG. 39B shows quantitative values (atomic %) of the STEM-EDX line analysis in the region of Sample 1 having the surface parallel to the edge plane. FIG. 40A, FIG. 40B, and FIG. 40C respectively show Co and Mg, Co and Al, and Co and Ni that are extracted from the profiles (Counts) of the STEM-EDX line analysis in FIG. 39A. FIG. 41A, FIG. 41B, and FIG. 41C respectively show only Mg, only Al, and only Ni that are extracted from the quantitative values (atomic %) of the STEM-EDX line analysis in FIG. 39B.

The point of 50% of the sum of the average value MAVE of the detection intensity of cobalt in the inner portion and the average value MBG of cobalt of the background was obtained from the profiles in FIG. 39A, and was superimposed on the position at a distance of 20 nm in FIG. 39A.

In FIG. 40A, FIG. 40B, and FIG. 40C, the inward direction in the particle from the position at a distance of 20 nm (the half value of Co) is a positive direction. The peak positions of the additive elements, i.e., Mg, Al, and Ni, were at 0 nm (a distance of 20 nm), at 4.9 nm (a distance of 25.4 nm), and at 0.4 nm (a distance of 20.4 nm), respectively. The distribution of Mg was narrow. The distribution of Al was broad. The distribution of Ni partly overlapped with the distribution of Mg.

In FIG. 41A, the inward direction in the particle from the position at a distance of 20 nm (the half value of Co) is a positive direction. The quantitative value of magnesium was the maximum value, i.e., 4.90 atomic %, at −1.2 nm (a distance of 18.8 nm), 0.30 atomic % at 10 nm (a distance of 30 nm), 0.70 atomic % at 20 nm (a distance of 40 nm), and 0.30 atomic % at 50 nm (a distance of 70 nm). The maximum value of magnesium indicates its sufficient amount and thus, magnesium was regarded as not being an element with a slight amount, and the energy spectrum of magnesium was not obtained. That is, magnesium had the maximum quantitative value in the surface portion in the region of Sample 1 having the surface parallel to the edge plane, and was distributed at a concentration within the range of 0.3 atomic % to 4.9 atomic % from the surface portion to the inner portion.

In FIG. 41B, the inward direction in the particle from the position at a distance of 20 nm (the half value of Co) is a positive direction. The quantitative value of aluminum was the maximum value, i.e., 1.30 atomic %, at 5.4 nm (a distance of 25.4 nm), 0.80 atomic % at 10 nm (a distance of 30 nm), 0.70 atomic % at 20 nm (a distance of 40 nm), and 0.20 atomic % at 50 nm (a distance of 70 nm). The maximum value of aluminum indicates its sufficient amount and thus, aluminum was regarded as not being an element with a slight amount, and the energy spectrum of aluminum was not obtained. That is, aluminum had the maximum quantitative value in the surface portion in the region of Sample 1 having the surface parallel to the edge plane, and was distributed at a concentration within the range of 0.2 atomic % to 1.3 atomic % from the surface portion to the inner portion.

In FIG. 41C, the inward direction in the particle from the position at a distance of 20 nm (the half value of Co) is a positive direction. The quantitative value of nickel was the maximum value, i.e., 1.30 atomic %, at 0.6 nm (a distance of 20.6 nm), 0.50 atomic % at 10 nm (a distance of 30 nm), 0.90 atomic % at 20 nm (a distance of 40 nm), and 1.00 atomic % at 50 nm (a distance of 70 nm). The maximum value of nickel indicates its sufficient amount and thus, nickel was regarded as not being an element with a slight amount, and the energy spectrum of nickel was not obtained. That is, nickel had the maximum quantitative value in the surface portion in the region of Sample 1 having the surface parallel to the edge plane, and was distributed at a concentration within the range of 0.5 atomic % to 1.3 atomic % from the surface portion to the inner portion.

As described above, it was confirmed that in the region of Sample 1 having the surface parallel to the edge plane, magnesium was distributed with the peak position closer to the surface of the positive electrode active material than the peak position of aluminum was. It was also confirmed that in the region having the surface parallel to the edge plane, the peak position of magnesium and the peak position of nickel were close to each other, and the distribution of magnesium partly overlapped with the distribution of nickel.

A secondary battery with Sample 1 described above in which the additive elements are appropriately distributed is considered to be unlikely to ignite in a nail penetration test, so that a secondary battery with a high level of safety can be provided.

### <Half Cell Fabrication 1>

In this example, coin-type half cells each including Sample 1, which was fabricated in Example 1, as a positive electrode active material were fabricated.

Sample 1 was prepared as a positive electrode active material, and a carbon nanotube (ZEONANO SG101 produced by Zeon Corporation, hereinafter simply referred to as CNT) was prepared as a conductive material. The CNT had a specific surface area greater than or equal to 800 m²/g, a fiber length of an aggregate greater than or equal to 100 μm and less than or equal to 600 μm, and an average diameter greater than or equal to 3 nm and less than or equal to 5 nm. Mixture A was prepared in advance by mixing the CNT at 0.25 wt % into N-methyl-2-pyrrolidone (NMP). To disperse the CNT surely, Mixture A was subjected to ultrasonic dispersion.

Poly(vinylidene fluoride) (PVDF) was prepared as a binding agent for the half cell. Mixture B was prepared in advance by dissolving the PVDF at a weight ratio of 5% in NMP. Next, Mixture A was added to Mixture B, and additional mixing was performed using a planetary centrifugal mixer.

Next, slurry was formed by performing mixing at the positive electrode active material: CNT: PVDF=98-x: x: 2 (weight ratio). As a solvent of the slurry, NMP was used. Half cell 1-1 used the slurry with x satisfying 0.1, Half cell 1-2 used the slurry with x satisfying 0.3, Half cell 1-3 used the slurry with x satisfying 0.5, Half cell 1-4 used the slurry with x satisfying 1, and Half cell 1-5 used the slurry with x satisfying 1.5. A table below lists the sample names and the values of x.

TABLE 4

| | Values of x |
|---|---|
| Half cell 1-1 | 0.1 |
| Half cell 1-2 | 0.3 |
| Half cell 1-3 | 0.5 |
| Half cell 1-4 | 1.0 |
| Half cell 1-5 | 1.5 |

Each slurry was applied on a positive electrode current collector of aluminum and then drying was performed at 80° C. to volatilize the solvent, whereby a positive electrode active material layer was formed over the positive electrode current collector.

After that, pressing treatment was performed with a roller press machine to increase the density of the positive electrode active material layer over the positive electrode current collector. As a pressing treatment condition, a linear pressure was 210 kN/m. Note that the temperature of each of an upper roll and a lower roll of the roller press machine was 120° C.

Through the above process, a positive electrode of each half cell was obtained. In the positive electrode, the loading amount of the active material was approximately 7 mg/cm².

As an electrolyte solution of the half cell, a solution which is obtained by adding vinylene carbonate (VC) at 2 wt % as an additive agent to a mixture of ethylene carbonate (EC) and diethyl carbonate (DEC) at EC: DEC=3:7 (volume ratio) was used. As an electrolyte contained in the electrolyte solution, 1 mol/L lithium hexafluorophosphate (LiPF₆) was used.

As a separator, a polypropylene porous film was used. For a negative electrode (counter electrode), a lithium metal was used.

Through the above process, Half cell 1-1 to Half cell 1-5 each including Sample 1 were fabricated.

<SEM image>

A SEM image of the positive electrode of Half cell 1-3 was observed. An SU8030 scanning electron microscope apparatus produced by Hitachi High-Tech Corporation was used for the observation of a surface SEM image. The conditions were an acceleration voltage of 5 kV and a magnification of 50000 times (denoted as 50k in the diagram). Other measurement conditions are as follows: a working distance was 5.0 mm, an emission current was higher than or equal to 9 μA and lower than or equal to 10.5 μA, an extraction voltage was 5.8 kV, an SE (U) mode (Upper secondary electron detector) was employed, and observation was performed in an autofocus mode. An S4800 scanning electron microscope apparatus produced by Hitachi High-Tech Corporation was used for the observation of a cross-sectional SEM image. The conditions were an acceleration voltage of 1 kV and a magnification of 50000 times (denoted as 50k in the diagram).

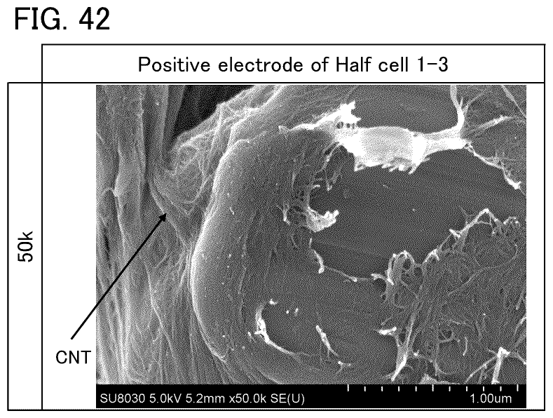

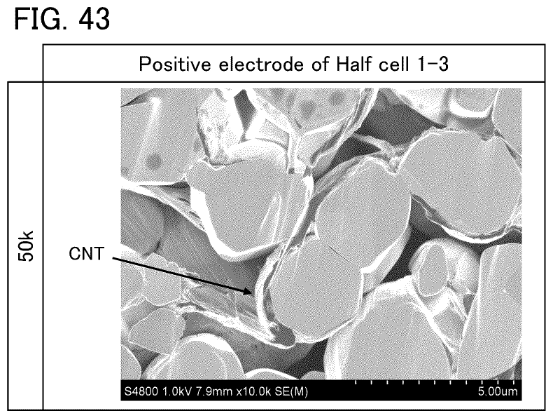

FIG. 42 shows a surface SEM image of the positive electrode of Half cell 1-3. FIG. 43 shows a cross-sectional SEM image of the positive electrode of Half cell 1-3. In each of FIG. 42 and FIG. 43, the positive electrode active material, the CNT, the PVDF, a space, and the like were observed. The CNT was in a tangled state and in contact with the positive electrode active material. The CNT was in a state of wrapping the positive electrode active material. Alternatively, the CNT was in a state of binding the positive electrode active material. The CNT was partly in contact with the positive electrode active material together with the binding agent. In Half cell 1-3, the positive electrode active material had few cracks.

### <Charge and Discharge Cycle Performance>126

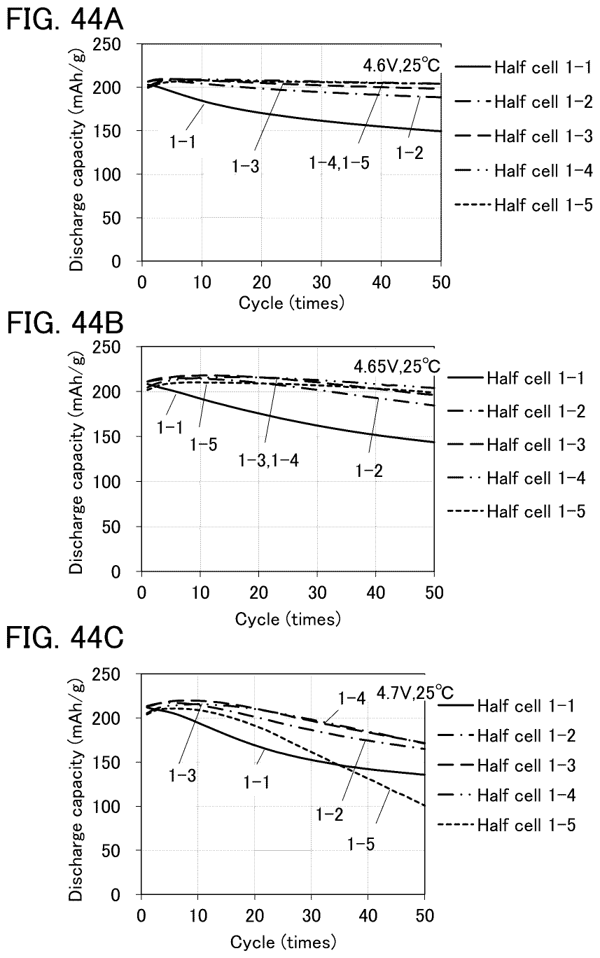

FIG. 44A to FIG. 44C show charge and discharge cycle performance of Half cell 1-1 to Half cell 1-5. Under Condition 1, as charging conditions, constant current charging was performed at 0.5 C until the voltage reached 4.60 V, and then constant voltage charging was performed until the current value reached 0.05 C. As discharging conditions, constant current discharging was performed at 0.5 C until the voltage reached a cutoff voltage of 2.5 V. The charging and discharging were repeated 50 times. FIG. 44A shows the results. Under Condition 2, as charging conditions, constant current charging was performed at 0.5 C until the voltage reached 4.65 V, and the other conditions were the same as those of Condition 1. FIG. 44B shows the results. Under Condition 3, as charging conditions, constant current charging was performed at 0.5 C until the voltage reached 4.7 V, and the other conditions were the same as those of Condition 1. FIG. 44C shows the results. Note that in this example, 1 C was 200 mA/g (per weight of the positive electrode active material). The temperature in a thermostatic chamber was 25° C.

As shown in FIG. 44A, Half cell 1-2 to Half cell 1-5 were each confirmed to exhibit favorable charge and discharge cycle performance. In particular, Half cell 1-4 and Half cell 1-5 each exhibited favorable performance. As shown in FIG. 44B, Half cell 1-2 to Half cell 1-5 were each confirmed to exhibit favorable charge and discharge cycle performance. In particular, Half cell 1-4 exhibited favorable performance. As shown in FIG. 44C, Half cell 1-2 to Half cell 1-4 were each confirmed to exhibit favorable charge and discharge cycle performance. In particular, Half cell 1-4 exhibited favorable performance.

A table below lists the maximum discharge capacities (mAh/g, per weight of the positive electrode active material, the same shall apply hereafter) of Half cell 1-1 to Half cell 1-5. The maximum discharge capacities of Half cell 1-2 to Half cell 1-4 were each found to be higher than or equal to 200 mAh/g, preferably higher than or equal to 210 mAh/g, further preferably higher than or equal to 215 mAh/g.

TABLE 5
Maximum discharge capacity (mAh/g)

| | 4.6 V, 25° C. | 4.65 V, 25° C. | 4.7 V, 25° C. |
|---|---|---|---|
| Half cell 1-1 | 202.9 | 208.3 | 211.9 |
| Half cell 1-2 | 208.1 | 214.7 | 217.3 |
| Half cell 1-3 | 209.6 | 217.9 | 219.7 |
| Half cell 1-4 | 209.1 | 216.0 | 215.5 |
| Half cell 1-5 | 207.6 | 210.1 | 210.6 |

A table below lists the discharge capacity retention rates (%) of Half cell 1-1 to Half cell 1-5 after 50 cycles. The discharge capacity retention rates of Half cell 1-2 to Half cell 1-4 were each found to be higher than or equal to 75%, preferably higher than or equal to 90%, further preferably higher than or equal to 94%.

TABLE 6
Discharge capacity retention rate (%) after 50 cycles

| | 4.6 V, 25° C. | 4.65 V, 25° C. | 4.7 V, 25° C. |
|---|---|---|---|
| Half cell 1-1 | 73.7 | 69.0 | 64.0 |
| Half cell 1-2 | 90.5 | 85.9 | 75.9 |
| Half cell 1-3 | 94.6 | 90.0 | 78.1 |
| Half cell 1-4 | 97.6 | 94.4 | 79.4 |
| Half cell 1-5 | 98.2 | 94.7 | 47.8 |

Half cell 1-2 to Half cell 1-4 were each confirmed to exhibit favorable charge and discharge cycle performance at 25° C. at charge voltages of 4.6 V, 4.65 V, and 4.7 V. That is, it was found that in order to obtain favorable charge and discharge cycle performance, 0.3<x≤ 1 is preferably satisfied in the positive electrode active material: CNT: PVDF=98-x: x:2 (weight ratio).

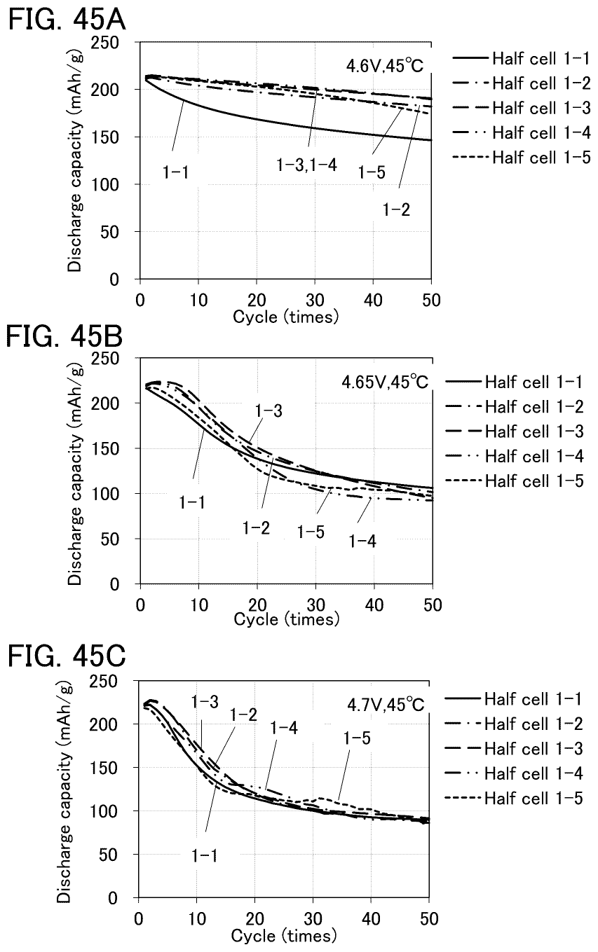

Next, the temperature in the thermostatic chamber was set to 45° C., and charge and discharge cycle performance of Half cell 1-1 to Half cell 1-5 was obtained under Condition 1 to Condition 3. FIG. 45A to FIG. 45C show the results.

As shown in FIG. 45A, Half cell 1-2 to Half cell 1-5 were each confirmed to exhibit favorable charge and discharge cycle performance. In particular, Half cell 1-3 and Half cell 1-4 each exhibited favorable performance. As shown in FIG. 45B, Half cell 1-1 to Half cell 1-5 were each confirmed to exhibit substantially favorable charge and discharge cycle performance. As shown in FIG. 45C, Half cell 1-1 to Half cell 1-5 were each confirmed to exhibit substantially favorable charge and discharge cycle performance.

A table below lists the maximum discharge capacities (mAh/g) of Half cell 1-1 to Half cell 1-5. The maximum discharge capacities of Half cell 1-3 and Half cell 1-4 were each found to be higher than or equal to 210 mAh/g, preferably higher than or equal to 220 mAh/g, further preferably higher than or equal to 222 mAh/g.

TABLE 7
Maximum discharge capacity (mAh/g)

| | 4.6 V, 45° C. | 4.65 V, 45° C. | 4.7 V, 45° C. |
|---|---|---|---|
| Half cell 1-1 | 209.6 | 216.4 | 223.3 |
| Half cell 1-2 | 212.6 | 222.7 | 227.7 |
| Half cell 1-3 | 214.8 | 223.5 | 226.8 |
| Half cell 1-4 | 213.9 | 221.7 | 222.2 |
| Half cell 1-5 | 213.3 | 217.5 | 218.4 |

A table below collectively lists the discharge capacity retention rates (%) of Half cell 1-1 to Half cell 1-5 after 50 cycles. The discharge capacity retention rates of Half cell 1-3 and Half cell 1-5 were each found to be higher than or equal to 40%, preferably higher than or equal to 80%.

TABLE 8
Discharge capacity retention rate (%) after 50 cycles

| | 4.6 V, 45° C. | 4.65 V, 45° C. | 4.7 V, 45° C. |
|---|---|---|---|
| Half cell 1-1 | 69.9 | 49.0 | 40.1 |
| Half cell 1-2 | 85.6 | 45.6 | 38.5 |
| Half cell 1-3 | 88.7 | 42.5 | 40.3 |
| Half cell 1-4 | 88.6 | 41.6 | 38.7 |
| Half cell 1-5 | 81.6 | 44.7 | 40.1 |

### <Discharge Capacity Measurement at Each Rate>

First, Half cell 1-1 to Half cell 1-5 were subjected to aging treatment. As charging conditions of the aging treatment, constant current charging was performed at 0.1 C until the voltage reached 4.60 V, and then constant voltage charging was performed until the current value reached 0.01 C. As discharging conditions, constant current discharging was performed at 0.1 C until the voltage reached a cutoff voltage of 2.5 V. Two cycles of the aging treatment were performed.

Next, discharge capacities of Half cell 1-1 to Half cell 1-5 were measured at each rate.

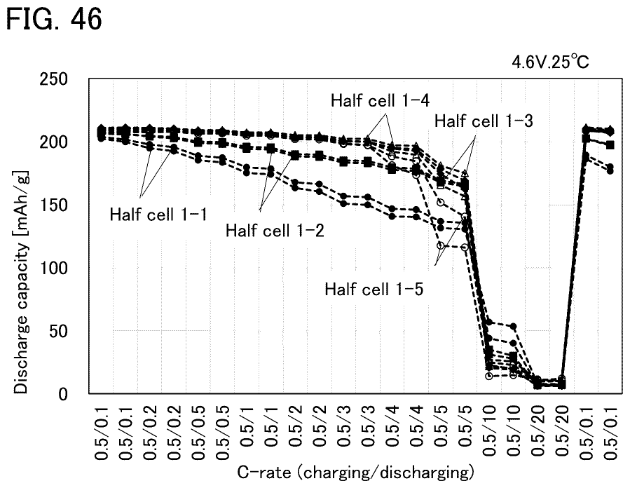

Fixed charging conditions that are the same as those for the above charge and discharge cycle test were employed, and as discharging conditions, the rate before the voltage reached a cutoff voltage of 2.5 V was changed between 0.1 C, 0.2 C, 0.5 C, 1 C, 2 C, 3 C, 4 C, 5 C, 10 C, and 20 C. The temperature was 25° C. FIG. 46 shows the results. Half cell 1-4 and Half cell 1-3 were each found to exhibit favorable discharge capacity at each rate.

### <Half Cell Fabrication 2>

In this example, coin-type half cells each including Sample 1, which was fabricated in Example 1, as a positive electrode active material were newly fabricated.

Sample 1, acetylene black, and poly(vinylidene fluoride) (PVDF) were prepared as a positive electrode active material, a conductive material, and a binding agent, respectively. The PVDF prepared in advance was one dissolved in N-methyl-2-pyrrolidone (NMP) at a weight ratio of 5%. Slurry was formed by performing mixing at the positive electrode active material: AB: PVDF=95:3:2 (weight ratio), and the slurry was applied on a positive electrode current collector of aluminum. As a solvent of the slurry, NMP was used.

Next, after the application of the slurry on the positive electrode current collector, the solvent was volatilized, whereby a positive electrode active material layer was formed over the positive electrode current collector.

After that, pressing treatment was performed with a roller press machine to increase the density of the positive electrode active material layer over the positive electrode current collector. As a pressing treatment condition, a linear pressure was 210 kN/m. Note that the temperature of each of an upper roll and a lower roll of the roller press machine was 120° C.

Through the above process, a positive electrode was obtained. In the positive electrode, the loading amount of the active material was approximately 7 mg/cm².

As an electrolyte solution, a solution which is obtained by adding vinylene carbonate (VC) at 2 wt % as an additive agent to a mixture of ethylene carbonate (EC) and diethyl carbonate (DEC) at EC: DEC=3:7 (volume ratio) was used. As an electrolyte contained in the electrolyte solution, 1 mol/L lithium hexafluorophosphate (LiPF₆) was used.

As a separator, a polypropylene porous film was used. For a negative electrode (counter electrode), a lithium metal was used.

With the use of these components, Half cell 2 including Sample 1 as the positive electrode active material was fabricated.

A comparative cell including Reference example 1 as the positive electrode active material was fabricated by a fabrication method similar to that of Half cell 2.

### <Charge and Discharge Cycle Performance>

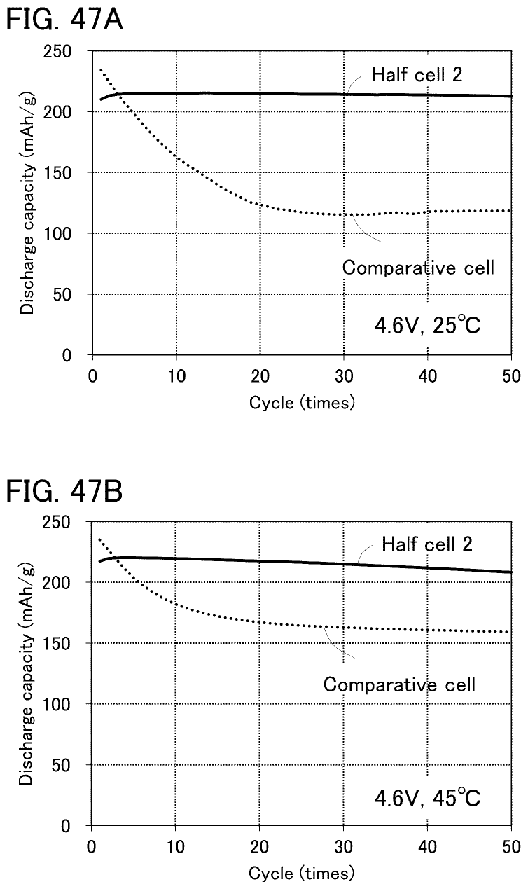

FIG. 47A and FIG. 47B show charge and discharge cycle performance of Half cell 2 and the comparative cell. As charging, constant current charging was performed at 0.5 C until the voltage reached 4.60 V, and then constant voltage charging was performed until the current value reached 0.05 C. As discharging, constant current discharging was performed at 0.5 C until the voltage reached 2.5 V. Note that here, 1 C was 200 mA/g (per weight of the positive electrode active material). Two conditions were set to the temperature: 25° C. and 45° C. In the above manner, charging and discharging were repeated 50 times. FIG. 47A shows the results of the charge and discharge cycle test in an environment of 25° C., and FIG. 47B shows the results of the charge and discharge cycle test in an environment of 45° C.

As shown in FIG. 47A and FIG. 47B, Half cell 2 was confirmed to exhibit more favorable charge and discharge cycle performance than the comparative cell under a high voltage condition of 4.6 V at 25° C. and 45° C. A table below shows the maximum discharge capacity (mAh/g) of Half cell 2. The maximum discharge capacity (mAh/g) of Half cell 2 was found to be higher than or equal to 210 mAh/g, preferably higher than or equal to 220 mAh/g.

TABLE 9
Maximum discharge capacity (mAh/g)

| | 4.6 V, 25° C. | 4.6 V, 45° C. |
|---|---|---|
| Half cell 2 | 215.3 | 220.3 |

A table below shows the discharge capacity retention rate (%) of Half cell 2 after 50 cycles. The discharge capacity retention rate of Half cell 2 after 50 cycles was found to be higher than or equal to 90%, preferably higher than or equal to 95%.

TABLE 10
Discharge capacity retention rate (%) after 50 cycles

| | 4.6 V, 25° C. | 4.6 V, 45° C. |
|---|---|---|
| Half cell 2 | 98.7 | 94.6 |

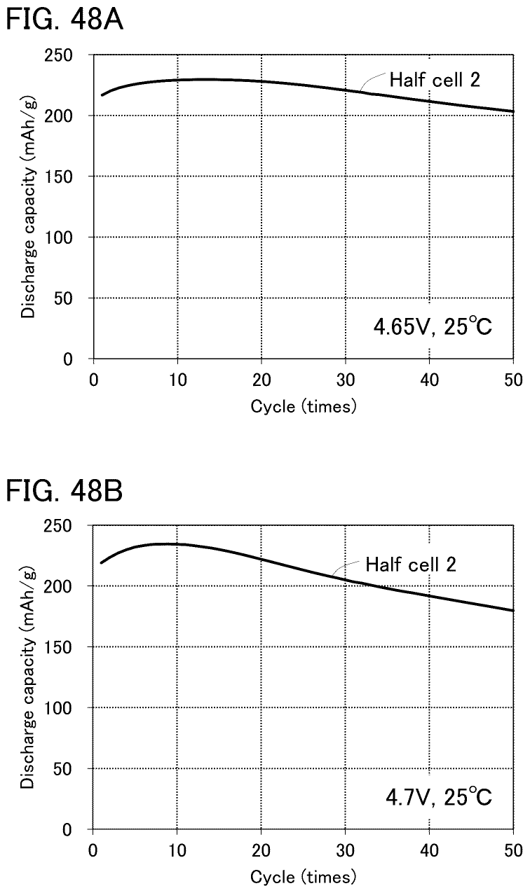

FIG. 48A and FIG. 48B show charge and discharge cycle performance of Half cell 2 at a higher voltage. As charging, constant current charging was performed at 0.5 C until the voltage reached 4.65 V or 4.70 V, and then constant voltage charging was performed until the current value reached 0.05 C. As discharging, constant current discharging was performed at 0.5° C. until the voltage reached 2.5 V. Note that here, 1 C was 200 mA/g. The temperature was 25° C. In the above manner, charging and discharging were repeated 50 times. FIG. 48A shows the results of the charge and discharge cycle test under the condition where charging to 4.65 V was performed, and FIG. 48B shows the results of the charge and discharge cycle test under the condition where charging to 4.70 V was performed.

As shown in FIG. 48A and FIG. 48B, Half cell 2 exhibited favorable charge and discharge cycle performance. A table below shows the maximum discharge capacity (mAh/g) of Half cell 2. The maximum discharge capacity (mAh/g) of Half cell 2 was found to be higher than or equal to 220 mAh/g, preferably higher than or equal to 230 mAh/g.

TABLE 11
Maximum discharge capacity (mAh/g)

| | 4.65 V, 25° C. | 4.7 V, 25° C. |
|---|---|---|
| Half cell 2 | 229.6 | 234.5 |

A table below shows the discharge capacity retention rate (%) of Half cell 2 after 50 cycles. The discharge capacity retention rate of Half cell 2 after 50 cycles was found to be higher than or equal to 75%, preferably higher than or equal to 85%.

TABLE 12
Discharge capacity retention rate (%) after 50 cycles

| | 4.65 V, 25° C. | 4.7 V, 25° C. |
|---|---|---|
| Half cell 2 | 88.6 | 76.6 |

### <XRD Analysis in High-Voltage Charged State>

In this example, XRD analysis in a high-voltage charged state was performed to examine the factors of the favorable charge and discharge cycle performance of Sample 1, particularly the favorable charge and discharge cycle performance of Sample 1.

First, charging and discharging were performed using Half cell 2 (a half cell different from the one subjected to the charge and discharge cycle test). As charging, constant current charging was performed at 0.2 C until the voltage reached 4.50 V, and then constant voltage charging was performed until the current value reached 0.05 C. As discharging, constant current discharging was performed at 0.2 C until the voltage reached 3.0 V. Note that as in the other tests, 1 C was 200 mA/g (per weight of the positive electrode active material).

Next, charging before the XRD analysis in a high-voltage charged state was performed. As charging, constant current charging was performed at 0.2 C until the voltage reached 4.60 V, and then constant voltage charging was performed until the current value reached 0.02 C.

Then, Half cell 2 was disassembled within 1 hour after termination of the above charging. In order that a positive electrode including Sample 1 might be taken out while being kept in a high-voltage charged state, the disassembly was performed carefully using an insulating tool so as not to cause a short circuit. Note that for the disassembly, an argon-filled glove box in which the dew point and the oxygen concentration were controlled was used. Note that the dew point of the glove box is preferably lower than or equal to −70° C., and the oxygen concentration is preferably lower than or equal to 5 ppm. Since the crystal structure of the positive electrode active material might change due to self-discharging after a long time has passed from the above charging, disassembly and analysis are preferably performed as early as possible.

Sample 1 obtained by disassembling Half cell 2 was set on an XRD measurement stage that can be hermetically sealed in the glove box, whereby Sample 1 on the XRD measurement stage hermetically sealed together with argon was obtained.

After that, XRD measurement was started within 15 minutes. The XRD apparatus and conditions are as follows.
XRD apparatus: D8 ADVANCE produced by Bruker AXS
X-ray source: CuKαi radiation
Output: 40 kV, 40 mA
Angle of divergence: Div. Slit, 0.5° Detector: LynxEye
Scanning method: 20/0 continuous scanning
Measurement range (20): from 15° to 75° Step width (20): 0.01° counting time: 1 second/step
Rotation of sample stage: 15 rpm

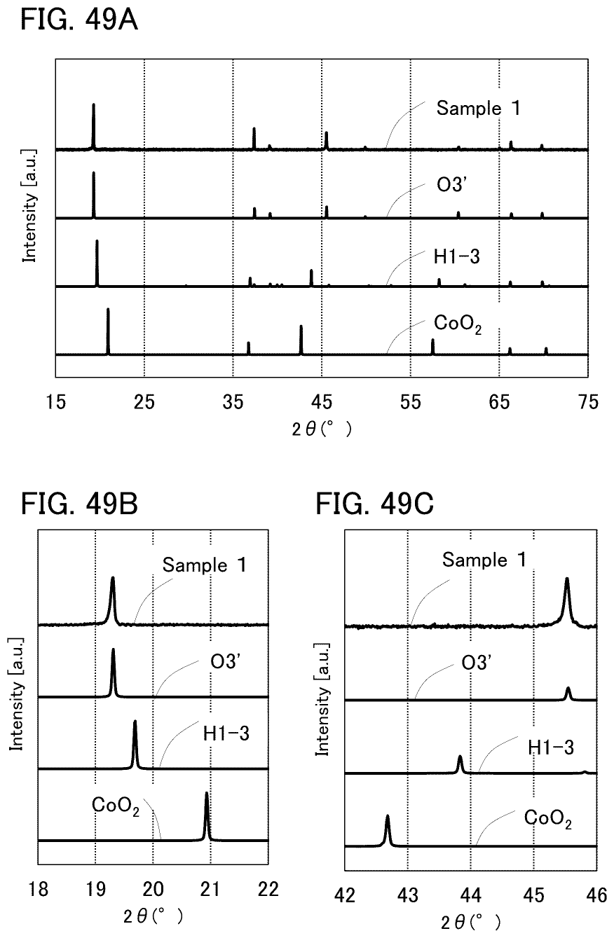

FIG. 49A to FIG. 49C show the XRD measurement data of Sample 1 in a high-voltage charged state obtained in the above manner. FIG. 49A to FIG. 49C also show a reference profile (O3′) of the O3′ structure, a reference profile (H1-3) of the H1-3 structure, and a reference profile (CoO₂) of CoO₂.

FIG. 49A shows the range where 20 is greater than or equal to 15° and less than or equal to 75° C. in the XRD measurement. FIG. 49B and FIG. 49C each show an enlarged part of FIG. 49A with a partly different magnification rate of the vertical axis of the measurement data of Sample 1.

As a result of the XRD analysis in a high-voltage charged state shown in FIG. 49A to FIG. 49C, Sample 1 charged under a high voltage condition of 4.6 V (the above description is referred to for the other charging conditions) had a diffraction peak at 2θ=19.30° within the range of 2θ=19.25±0.12° (greater than or equal to 19.13° and less than or equal to) 19.37° and a diffraction peak at 2θ=45.52° within the range of 2θ=45.47±0.10° (greater than or equal to 45.37° and less than or equal to 45.57°). That is, it was confirmed that the O3′ structure was included. Thus, Sample 1 in a high-voltage charged state having the O3′ structure can be considered to be a major factor of favorable cycle performance at 4.60 V, favorable cycle performance at 4.65 V, and favorable cycle performance at 4.70 V of Half cell 2 including Sample 1.

### REFERENCE NUMERALS

10: secondary battery, 11: negative electrode, 12: positive electrode, 13: separator, 21: negative electrode current collector, 22: negative electrode active material layer, 31: positive electrode current collector, 32: positive electrode active material layer, 41a: conductive material, 41b: conductive material, 41: conductive material, 42: conductive material, 43: conductive material, 44: conductive material, 51: space, 100a: positive electrode active material, 100b: inner portion, 100s: first region, 100: positive electrode active material, active material, 101: SG, 102: crack, 300: secondary battery, 301: positive electrode can, 302: negative electrode can, 303: gasket, 304: positive electrode, 305: positive electrode current collector, 306: positive electrode active material layer, 307: negative electrode, 308: negative electrode current collector, 309: negative electrode active material layer, 310: separator, 312: washer, 322: spacer, 500: secondary battery, 501: positive electrode current collector, 502: positive electrode active material layer, 503: positive electrode, 504: negative electrode current collector, 505: negative electrode active material layer, 506: negative electrode, 507: separator, 508: separator, 509: exterior body, 510: positive electrode lead electrode, 511: negative electrode current collector, 512: negative electrode active material layer, 513: secondary battery, 514: terminal, 515: sealant, 516: negative electrode lead electrode, 517: antenna, 519: layer, 529: label, 530: electrolyte solution, 531: exterior body, 532: secondary battery pack, 540: circuit board, 552: other, 553: conductive material, 590a: circuit system, 590b: circuit system, 590: control circuit, 601: positive electrode cap, 602: battery can, 603: positive electrode terminal, 604: positive electrode, 605: separator, 606: negative electrode, 607: negative electrode terminal, 608: insulating plate, 609: insulating plate, 611: PTC element, 613: safety valve mechanism, 614: conductive plate, 615: power storage system, 616: secondary battery, 620: control circuit, 621: wiring, 622: wiring, 623: wiring, 624: conductor, 625: insulator, 626: wiring, 627: wiring, 628: conductive plate, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 903: mixture, 904: mixture, 911a: terminal, 911b: terminal, 913: secondary battery, 930a: housing, 930b: housing, 930: housing, 931a: negative electrode active material layer, 931: negative electrode, 932a: positive electrode active material layer, 932: positive electrode, 933: separator, 950a: wound body, 950: wound body, 951: terminal, 952: terminal, 1000: nail penetration test device, 1001: stage, 1002: driving portion, 1003: nail, 1004: secondary battery, 1005a: wiring, 1005b: wiring, 1006: temperature sensor, 1012: driving mechanism, 1015: voltage measuring device, 1016: temperature measuring device, 1018: control portion, 1300: rectangular secondary battery, 1301a: first battery, 1301b: first battery, 1302: battery controller, 1303: motor controller, 1304: motor, 1305: gear, 1306: DCDC circuit, 1307: electric power steering, 1308: heater, 1309: defogger, 1310: DCDC circuit, 1311: second battery, 1312: inverter, 1313: stereo, 1314: power window, 1315: lamps, 1316: tire, 1317: rear motor, 1320: control circuit portion, 1321: control circuit portion, 1322: control circuit, 1324: switch portion, 1413: fixing portion, 1414: fixing portion, 1415: battery pack, 1421: wiring, 1422: wiring, 2001: automobile, 2002: transporter, 2003: transport vehicle, 2004: aircraft, 2005: artificial satellite, 2100: mobile phone, 2101: housing, 2102: display portion, 2103: operation button, 2104: external connection port, 2105: speaker, 2106: microphone, 2107: secondary battery, 2150: external battery, 2151: terminal, 2152: cable, 2200: battery pack, 2201: battery pack, 2203: battery pack, 2204: secondary battery, 2300: unmanned aircraft, 2301: secondary battery, 2302: rotor, 2303: camera, 2603: vehicle, 2604: charging equipment, 2610: solar panel, 2611: wiring, 2612: power storage device, 4000a: frame, 4000b: display portion, 4000: glasses-type device, 4001a: microphone portion, 4001b: flexible pipe, 4001c: earphone portion, 4001: headset-type device, 4002a: housing, 4002b: secondary battery, 4002: device, 4003a: housing, 4003b: secondary battery, 4003: device, 4005a: display portion, 4005b: belt portion, 4005: watch-type device, 4006a: belt portion, 4006b: wireless power feeding and receiving portion, 4006: belt-type device, 6300: cleaning robot, 6301: housing, 6302: display portion, 6303: camera, 6304: brush, 6305: operation button, 6306: secondary battery, 6310: dust, 6400: robot, 6401: illuminance sensor, 6402: microphone, 6403: upper camera, 6404: speaker, 6405: display portion, 6406: lower camera, 6407: obstacle sensor, 6408: moving mechanism, 6409: secondary battery, 8600: motor scooter, 8601: side mirror, 8602: power storage device, 8603: indicator light, 8604: under-seat storage unit, 8700: electric bicycle, 8701: secondary battery, 8702: power storage device, 8703: display portion, 8704: control circuit

1. A battery comprising:
a positive electrode comprising a positive electrode active material and a conductive material,
wherein the positive electrode active material comprises cobalt, oxygen, magnesium, and nickel,
wherein a median diameter of the positive electrode active material is greater than or equal to 1 μm and less than or equal to 12 μm,
wherein in EDX line analysis in a depth direction on a region of the positive electrode active material comprising a plane other than a (001) plane, a distribution of the magnesium at least partly overlaps with a distribution of the nickel, and
wherein the conductive material adheres to part of the plane other than the (001) plane of the positive electrode active material.

2. A battery comprising:
a positive electrode comprising a positive electrode active material and a conductive material,
wherein the positive electrode active material comprises cobalt, oxygen, magnesium, and nickel,
wherein a median diameter of the positive electrode active material is greater than or equal to 1 μm and less than or equal to 12 μm,
wherein in EDX line analysis in a depth direction on a region of the positive electrode active material comprising a plane other than a (001) plane, a concentration of the magnesium is higher than or equal to 0.3 atomic % and lower than or equal to 7 atomic %, and
wherein the conductive material adheres to part of the plane other than the (001) plane of the positive electrode active material.

3. A battery comprising:
a positive electrode comprising a positive electrode active material and a conductive material,
wherein the positive electrode active material comprises cobalt, oxygen, magnesium, nickel, and aluminum,
wherein a median diameter of the positive electrode active material is greater than or equal to 1 μm and less than or equal to 12 μm,
wherein in EDX line analysis in a depth direction on a region of the positive electrode active material comprising a plane other than a (001) plane, a distribution of the magnesium at least partly overlaps with a distribution of the nickel and a peak of a concentration of the magnesium is located closer to a surface of the positive electrode active material than a peak of a concentration of the aluminum is, and
wherein the conductive material adheres to part of the plane other than the (001) plane of the positive electrode active material.

4. A battery comprising:
a positive electrode comprising a positive electrode active material and a conductive material,
wherein the positive electrode active material comprises cobalt, oxygen, magnesium, nickel, and aluminum,
wherein a median diameter of the positive electrode active material is greater than or equal to 1 μm and less than or equal to 12 μm,
wherein in EDX line analysis in a depth direction on a region of the positive electrode active material comprising a plane other than a (001) plane, a concentration of the magnesium is higher than or equal to 0.3 atomic % and lower than or equal to 7 atomic % and a concentration of the aluminum is higher than or equal to 0.1 atomic % and lower than or equal to 3 atomic %, and
wherein the conductive material adheres to part of the plane other than the (001) plane of the positive electrode active material.

5. The battery according to claim 1,
wherein a volume resistivity of a powder of the positive electrode active material is higher than or equal to 1.5×10⁸Ω·cm under a pressure of 64 MPa.

6. The battery according to claim 1,
wherein the conductive material comprises carbon fiber, graphene, or a graphene compound.

7. The battery according to claim 6, wherein the carbon fiber comprises a carbon nanotube.

8. The battery according to claim 7, wherein the carbon nanotube is in a tangled state.

9. An electronic device comprising the battery according to claim 1.

10. A vehicle comprising the battery according to claim 1.

11. The battery according to claim 2,
wherein a volume resistivity of a powder of the positive electrode active material is higher than or equal to 1.5×10⁸Ω·cm under a pressure of 64 MPa.

12. The battery according to claim 2,
wherein the conductive material comprises carbon fiber, graphene, or a graphene compound.

13. The battery according to claim 12, wherein the carbon fiber comprises a carbon nanotube.

14. The battery according to claim 13, wherein the carbon nanotube is in a tangled state.

15. The battery according to claim 3,
wherein a volume resistivity of a powder of the positive electrode active material is higher than or equal to 1.5×10⁸Ω·cm under a pressure of 64 MPa.

16. The battery according to claim 3,
wherein the conductive material comprises carbon fiber, graphene, or a graphene compound.

17. The battery according to claim 16, wherein the carbon fiber comprises a carbon nanotube.

18. The battery according to claim 17, wherein the carbon nanotube is in a tangled state.

19. The battery according to claim 4,
wherein a volume resistivity of a powder of the positive electrode active material is higher than or equal to 1.5×10⁸Ω·cm under a pressure of 64 MPa.

20. The battery according to claim 4,
wherein the conductive material comprises carbon fiber, graphene, or a graphene compound.

21. The battery according to claim 20, wherein the carbon fiber comprises a carbon nanotube.

22. The battery according to claim 21, wherein the carbon nanotube is in a tangled state.
